(19) United States
(12) Patent Application Publication
(10) Pub. No.: US 2025/0106714 A1
(43) Pub. Date: Mar. 27, 2025

(54) TRIGGERED CELL SWITCH FOR INTER-CELL BEAM MANAGEMENT

(71) Applicant: Samsung Electronics Co., Ltd., Suwon-si (KR)

(72) Inventors: Emad Nader Farag, Flanders, NJ (US); Eko Onggosanusi, Coppell, TX (US); Dalin Zhu, Allen, TX (US)

(21) Appl. No.: 18/885,408

(22) Filed: Sep. 13, 2024

Related U.S. Application Data
(60) Provisional application No. 63/540,845, filed on Sep. 27, 2023.
(60) Provisional application No. 63/545,689, filed on Oct. 25, 2023.
(60) Provisional application No. 63/547,086, filed on Nov. 2, 2023.

(51) Int. Cl. H04W 36/06; H04W 36/00

(52) U.S. Cl. CPC H04W 36/06; H04W 36/0072

(57) ABSTRACT

Methods and apparatuses for inter-cell beam management triggered cell switch. A method of operating a user equipment (UE) includes receiving first information for first sets of downlink (DL) or joint candidate cell transmission configuration indicator (TCI) states corresponding to one or more candidate cells, receiving second information for second sets of uplink (UL) candidate cell TCI states corresponding to the one or more candidate cells, receiving a first medium access control-channel element (MAC-CE) for activating a subset of candidate cell TCI states from the first or second sets, and receiving a second MAC CE including a cell switch command. The cell switch command indicates a candidate cell and at least one candidate cell TCI state from the first sets or the second sets corresponding to the candidate cell. The method further includes deactivating the subset of activated candidate cell TCI states excluding the at least one candidate cell TCI state.

### CROSS-REFERENCE TO RELATED AND CLAIM OF PRIORITY

The present application claims priority under 35 U.S.C. § 119 (e) to U.S. Provisional Patent Application No. 63/540,845 filed on Sep. 27, 2023; U.S. Provisional Patent Application No. 63/545,689 filed on Oct. 25, 2023; and U.S. Provisional Patent Application No. 63/547,086 filed on Nov. 2, 2023, which are hereby incorporated by reference in their entirety.

### TECHNICAL FIELD

The present disclosure relates generally to wireless communication systems and, more specifically, the present disclosure relates to methods and apparatuses for triggered cell switch for inter-cell beam management.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to triggered cell switch for inter-cell beam management.

In one embodiment, a user equipment (UE) is provided. The UE includes a transceiver configured to receive first information for first sets of downlink (DL) or joint candidate cell transmission configuration indicator (TCI) states corresponding to one or more candidate cells, receive second information for second sets of uplink (UL) candidate cell TCI states corresponding to the one or more candidate cells, receive a first medium access control-channel element (MAC-CE) for activating a subset of candidate cell TCI states from the first sets or the second sets, and receive a second MAC CE including a cell switch command. The cell switch command indicates a candidate cell and at least one candidate cell TCI state, from the first sets or the second sets, corresponding to the candidate cell. The at least one candidate cell TCI state is indicated when the at least one candidate cell TCI state is activated by the first MAC-CE. The UE further includes a processor operably coupled to the transceiver. The processor is configured to deactivate the subset of activated candidate cell TCI states excluding the at least one candidate cell TCI state.

In another embodiment, a base station (BS) is provided. The BS includes a transceiver configured to transmit first information for first sets of DL or joint candidate cell TCI states corresponding to one or more candidate cells, transmit second information for second sets of UL candidate cell TCI states corresponding to the one or more candidate cells, transmit a first MAC-CE for activating a subset of candidate cell TCI states from the first sets or the second sets, and transmit a second MAC CE including a cell switch command. The cell switch command indicates a candidate cell and at least one candidate cell TCI state, from the first sets or the second sets, corresponding to the candidate cell. The at least one candidate cell TCI state is indicated when the at least one candidate cell TCI state is activated by the first MAC-CE. The BS further includes a processor operably coupled to the transceiver. The processor is configured to deactivate the subset of activated candidate cell TCI states excluding the at least one candidate cell TCI state.

In yet another embodiment, a method of operating a UE is provided. The method includes receiving first information for first sets of DL or joint candidate cell TCI states corresponding to one or more candidate cells, receiving second information for second sets of UL candidate cell TCI states corresponding to the one or more candidate cells, receiving a first MAC-CE for activating a subset of candidate cell TCI states from the first sets or the second sets, and receiving a second MAC CE including a cell switch command. The cell switch command indicates a candidate cell and at least one candidate cell TCI state from the first sets or the second sets corresponding to the candidate cell. The at least one candidate cell TCI state is indicated when the at least one candidate cell TCI state is activated by the first MAC-CE. The method further includes deactivating the subset of activated candidate cell TCI states excluding the at least one candidate cell TCI state.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example architecture for inter-cell beam management according to embodiments of the present disclosure;

FIG. 8 illustrates a diagram of example higher level signaling according to embodiments of the present disclosure;

FIG. 9 illustrates an example of a timeline for inter-cell switching according to embodiments of the present disclosure;

FIG. 10 illustrates an example of a timeline for inter-cell switching according to embodiments of the present disclosure;

FIG. 11 illustrates a diagram of example transmission configuration indication (TCI) states/TCI state codepoints for serving/candidate cell(s) according to embodiments of the present disclosure;

FIG. 12 illustrates a diagram of example TCI states/TCI state codepoints for serving/candidate cell(s) according to embodiments of the present disclosure;

FIG. 13 illustrates a diagram of example TCI states/TCI state codepoints for serving/candidate cell(s) according to embodiments of the present disclosure;

FIG. 14 illustrates a diagram of example TCI states/TCI state codepoints for serving/candidate cell(s) according to embodiments of the present disclosure;

FIG. 15 illustrates a diagram of example TCI states/TCI state codepoints for serving/candidate cell(s) according to embodiments of the present disclosure;

FIG. 16 illustrates a diagram of an example MAC CE configuration for TCI state(s) of candidate cell according to embodiments of the present disclosure;

FIG. 17 illustrates a diagram of an example list of non-zero power (NZP) channel state information reference signal (CSI-RS) resources according to embodiments of the present disclosure;

FIG. 18 illustrates a diagram of example lists of NZP CSI-RS resources according to embodiments of the present disclosure;

FIG. 19 illustrates a diagram of an example orthogonal frequency-division multiplexing (OFDM) waveform according to embodiments of the present disclosure;

FIG. 20 illustrates a diagram of example Fast Fourier Transform (FFT) windows according to embodiments of the present disclosure;

FIG. 21 illustrates a diagram of an example medium access control (MAC) random access procedure (RAR) for Type 1 random access procedure according to embodiments of the present disclosure;

FIG. 22 illustrates a diagram of an example MAC RAR for Type 2 random access procedure according to embodiments of the present disclosure;

FIG. 23 illustrates a diagram of an example timing advance command MAC CE according to embodiments of the present disclosure;

FIG. 24 illustrates a diagram of example absolute timing advance command MAC CE according to embodiments of the present disclosure;

FIG. 25 illustrates flow diagrams of random access procedures according to embodiments of the present disclosure;

FIG. 26 illustrates flow diagrams of example 2-step random access procedures according to embodiments of the present disclosure;

FIG. 27 illustrates a procedure for an example RAR according to embodiments of the present disclosure;

FIG. 28 illustrates a procedure for an example RAR according to embodiments of the present disclosure;

FIG. 29 illustrates a procedure for an example RAR according to embodiments of the present disclosure;

FIG. 30 illustrates a procedure for an example RAR according to embodiments of the present disclosure;

FIG. 31 illustrates a procedure for an example RAR according to embodiments of the present disclosure;

FIG. 32 illustrates a procedure for an example RAR according to embodiments of the present disclosure; and

FIG. 33 illustrates a procedure for an example RAR according to embodiments of the present disclosure.

### DETAILED DESCRIPTION

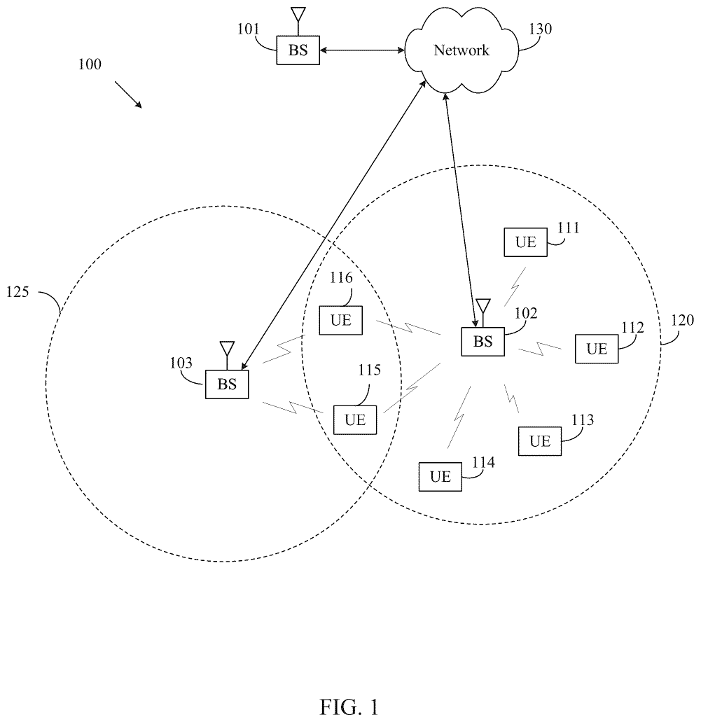

FIGS. 1-33, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.8.0, “NR; Physical channels and modulation;” [2] 3GPP TS 38.212 v17.9.0, “NR; Multiplexing and Channel coding;” [3] 3GPP TS 38.213 v17.10.0, “NR; Physical Layer Procedures for Control;” [4] 3GPP TS 38.214 v17.10.0, “NR; Physical Layer Procedures for Data;” [5] 3GPP TS 38.321 v17.9.0, “NR; Medium Access Control (MAC) protocol specification;” [6] 3GPP TS 38.331 v17.9.0, “NR; Radio Resource Control (RRC) Protocol Specification;” [7] 3GPP RP-213565, “Further NR Mobility Enhancements;” and [8] 3GPP RP-213598, “MIMO Evolution for Downlink and Uplink.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing triggered cell switch for inter-cell beam management. In certain embodiments, one or more of the BSs 101-103 include circuitry, programing, or a combination thereof to support triggered cell switch for inter-cell beam management.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

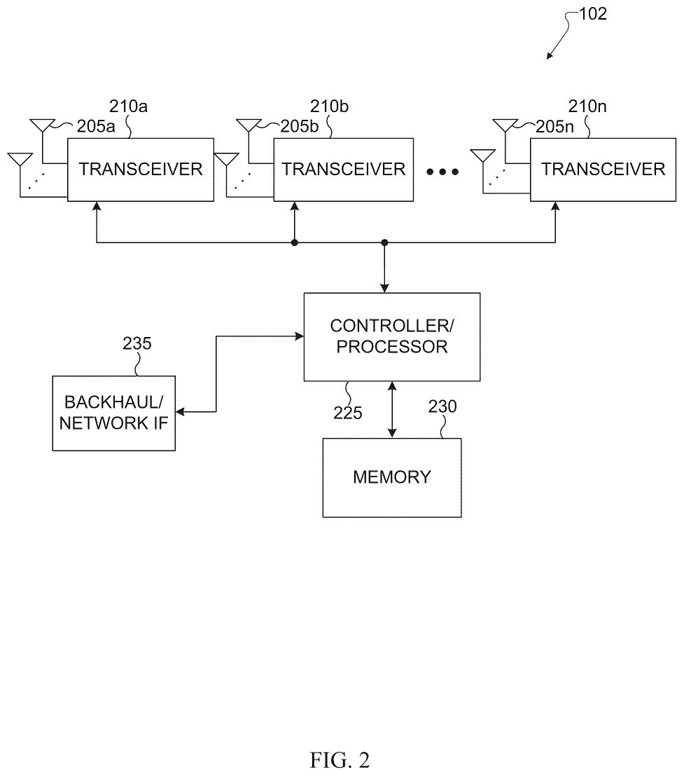

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting triggered cell switch for inter-cell beam management. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

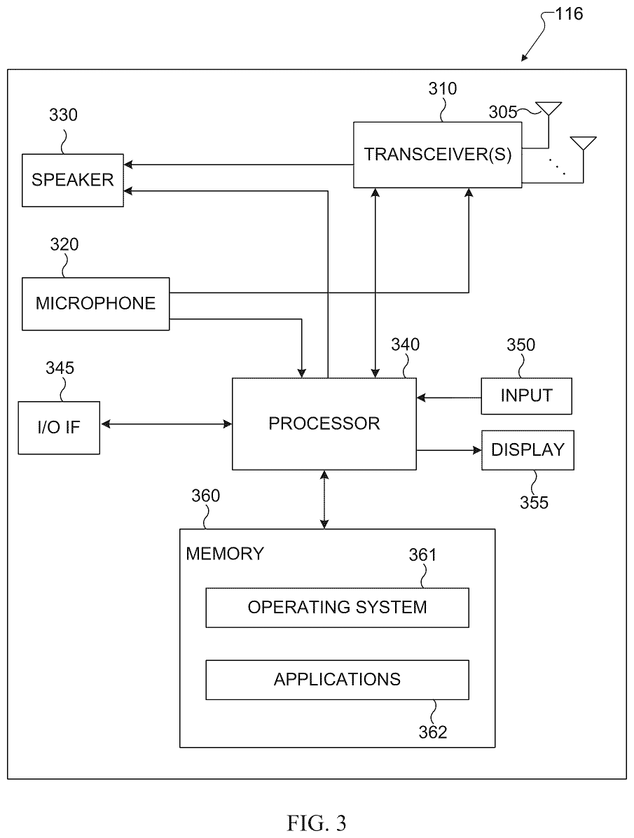

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify triggered cell switch for inter-cell beam management as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

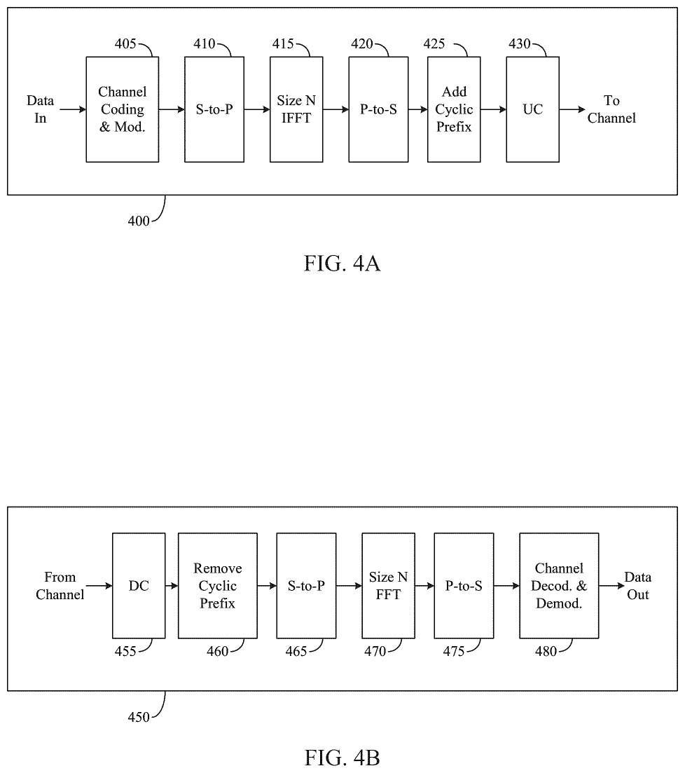

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support triggered cell switch for inter-cell beam management as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

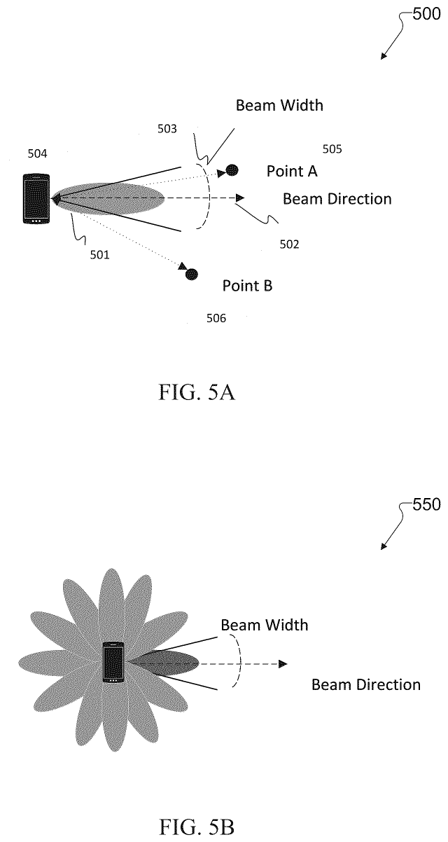

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

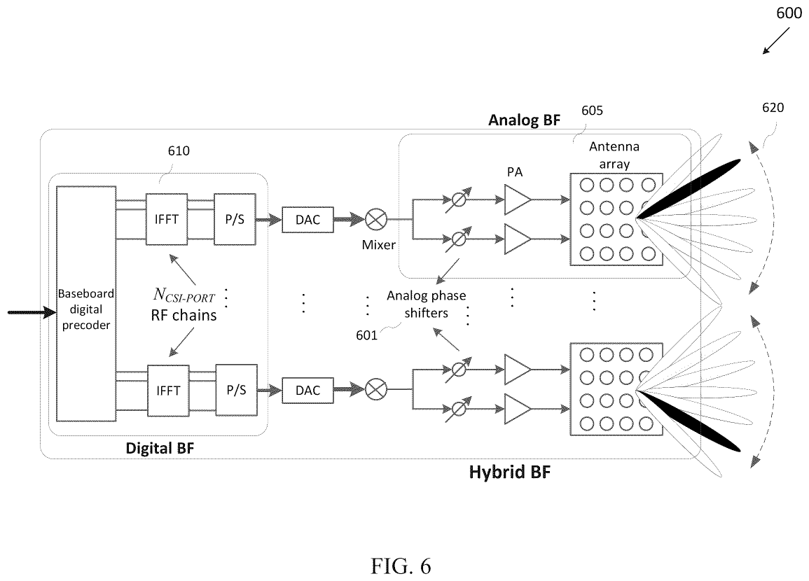

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication reference signal (CSI-RS) antenna ports which enable an eNB or a gNB to be equipped with a large number of antenna elements (such as 64 or 128). A plurality of antenna elements can then be mapped onto one CSI-RS port. For mm Wave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

In this disclosure, a beam is determined by either of,
A TCI state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE; or a spatial Tx filter for transmission of downlink channels from the gNB or a spatial Rx filter for reception of uplink channels at the gNB.

Rel-17 introduced the unified TCI framework, where a unified or master or main or indicated TCI state is signaled to the UE. The unified or master or main TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell). In Rel-17, UE-dedicated channels can be received and/or transmitted using a TCI state associated with a cell having a PCI different from the PCI of the serving cell. While the common channels can be received and/or transmitted using a TCI state associated with the serving cell (e.g., not associated with a cell having a PCI different from the PCI of the serving cell). Common channels can include:
Channels carrying system information (e.g. SIB) with a DL assignment carried by a downlink control information (DCI) in PDCCH having a cyclic redundancy check (CRC) scrambled by system information radio network temporary identifier (SI-RNTI) and transmitted in Type0-PDCCH common search space (CSS) set.
Channels carrying other system information with a DL assignment carried by a DCI in PDCCH having a CRC scrambled by SI-RNTI and transmitted in Type0A-PDCCH CSS set.
Channels carrying paging or short messages with a DL assignment carried by a DCI in PDCCH having a CRC scrambled by paging RNTI (P-RNTI) and transmitted in Type2-PDCCH CSS set.
Channels carrying RACH related channels with a DL assignment or UL grant carried by a DCI in PDCCH having a CRC scrambled by random access RNTI (RA-RNTI) or temporary cell RNTI (TC-RNTI) and transmitted in Type1-PDCCH CSS set

Quasi-co-location (QCL) relation, can be quasi-location with respect to one or more of the following relations [38.214 [REF4]—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main) TCI state applies at least to UE dedicated DL and UL channels. The unified (master or main) TCI can also apply to other DL and/or UL channels and/or signals e.g. non-UE dedicated channel and sounding reference signal (SRS).

In Rel-18, a work item [7] has been agreed to further enhance mobility in NR. “When the UE moves from the coverage area of one cell to another cell, at some point a serving cell change needs to be performed. Currently serving cell change is triggered by L3 measurements and is done by RRC signaling triggered Reconfiguration with Synchronization for change of primary cell (PCell) and primary secondary cell group cell (PSCell), as well as release add for SCells when applicable. Embodiments of the present disclosure recognize that each cases involve complete L2 (and L1) resets, leading to longer latency, larger overhead, and longer interruption time than beam switch mobility. The goal of L1/L2 mobility enhancements is to enable a serving cell change via L1/L2 signalling, in order to reduce the latency, overhead and interruption time” [7]. Allowing, the serving cell to be changed seamlessly using L1/L2 mechanisms reduces handover latency, and leads to more robust operation (less dropped calls). In this disclosure, various embodiments look at mechanisms for activating and indicating and deactivating TCI states of the serving cell and the candidate cells before, during and after cell switch.

FIG. 7 illustrates a diagram of an example architecture 700 for inter-cell beam management according to embodiments of the present disclosure. For example, architecture 700 for inter-cell beam management can be utilized by the UE 112 and BS 102 within the network 100 of FIG. 1. This example is for illustration only and other embodiments can be used without departing from the scope of the present disclosure.

In Rel-17, a unified TCI state framework has been introduced to streamline the beam management procedures by reducing latency and overhead associated with beam change. Rel-17 also introduced inter-cell beam management, wherein at least UE dedicated channels can be received on a beam associated with a TRP associated with a PCI different from the PCI of the serving cell. With reference to FIG. 7, in Rel-17 when a beam changes from the TRP of serving cell to a TRP of a cell with PCI different from that of the serving cell, the serving cell is not changed. Common channels, continue to be received and transmitted on beam associated with a serving cell.

In Rel-17 a unified or master or main or indicated TCI state is signaled to the UE to indicate a beam for the UE to use. RRC signaling configures Rel-17 TCI states wherein TCI state can be configured as DL or Joint TCI state using information element (DLorJoint-TCIState), or UL TCI state using information element (UL-TCIState). MAC signaling can activate one or more TCI codepoints. When one TCI state codepoint is activated by MAC CE, the UE applies the TCI state(s) associated with the activated codepoint after a beam application time. When more than one TCI codepoints are activated by MAC CE, further DCI signaling is used to indicate a TCI state codepoint to the UE. The unified TCI state can be signaled by a DCI Format (e.g., DL related DCI Format (e.g., DCI Format 1_1 or DCI Format 1_2) with a DL assignment or a DL related DCI Format (e.g., DCI Format 1_1 or DCI Format 1_2) without a DL assignment.

To further enhance mobility, when a beam is changed from a first TRP associated with a source serving cell to a second TRP associated with a PCI different from the PCI of the source serving cell, the second TRP can be become the target serving cell. In this disclosure, various embodiments look at mechanisms for activating and indicating and deactivating TCI states of the serving cell and the candidate cells before, during, and after cell switch.

The present disclosure relates to a 5G/NR communication system.

This disclosure provides design aspects related to dynamic switching of serving cells from a source serving cell to a candidate cell. TCI states for candidate cells are activated before cell switch or during cell switch and are indicated in the cell switch command. TCI states for the serving cell, continue to be used until the cell switch command has occurred. After the cell switch command, TCI states activated for the candidate set can continue to be used until new TCI states are activated for the new serving cell.

In this disclosure, various embodiments look at aspects related to signaling for using NZP CSI-RS associated with a candidate cell as a source RS for candidate cell TCI states before cell switch. In this disclosure, a candidate cell TCI state is also referred to as L1/L2 Triggered mobility (LTM) TCI state.

Aspects, features, and advantages of the present disclosure are readily apparent from the following detailed description, simply by illustrating a number of particular embodiments and implementations, including the best mode contemplated for carrying out the present disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

In the following, both frequency division duplexing (FDD) and time division duplexing (TDD) are regarded as a duplex method for DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

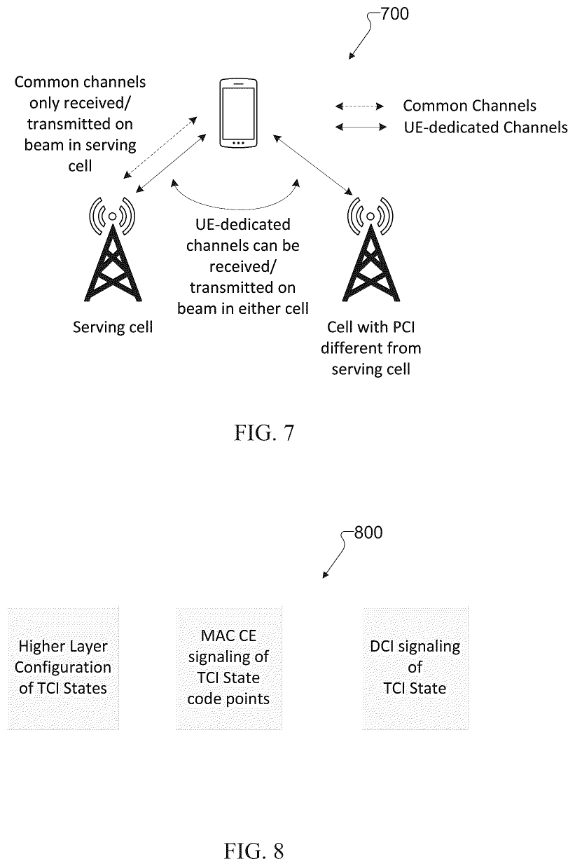

FIG. 8 illustrates a diagram of example higher level signaling 800 according to embodiments of the present disclosure. For example, higher level signaling 800 can be received by the UE 111 of FIG. 1. This example is for illustration only and other embodiments can be used without departing from the scope of the present disclosure.

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

A “reference RS” corresponds to a set of characteristics of a DL beam or an UL TX beam, such as a direction, a precoding/beamforming, a number of ports, and so on.

In the following components, a TCI state is used for beam indication. It can refer to a DL TCI state for downlink channels (e.g. PDCCH and PDSCH), an uplink TCI state for uplink channels (e.g. PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

In the following examples, with reference to FIG. 7, a UE (e.g., the UE 116) is configured/updated a set of TCI States with N elements through higher layer RRC signaling. In one example, DL and joint TCI states are configured by higher layer parameter DLorJoint-TCIState, wherein the number of DL and Joint TCI state is N_{DJ}. UL TCI state are configured by higher layer parameter UL-TCIState, wherein the number of UL TCI state is N_{U}. N=N_{DJ}+N_{U}.

MAC CE signaling includes a subset of M (M≤N) TCI states or TCI state code points from the set of N TCI states, wherein a code point is signaled in the “transmission configuration indication” field a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e. Downlink Control Information (DCI)) updates the UE's TCI state, wherein the DCI includes a “transmission configuration indication” (beam indication) field e.g. with m bits (such that M≤2^{m}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

The TCI states can be associated, through a QCL relation, with an SSB of serving cell, or an SSB associated with a PCI different from the PCI of the serving cell. The QCL relation with a SSB can be a direct QCL relation, wherein the source RS (e.g., for a QCL Type D relation or a spatial relation) of the QCL state is the SSB. The QCL relation with a SSB can be an indirect QCL relation, wherein the source RS (e.g., for a QCL Type D relation or a spatial relation) can be a reference signal, and the reference signal has the SSB as its source (e.g., for a QCL Type D relation or a spatial relation). The indirect QCL relation to an SSB can involve a QCL or spatial relation chain of more than one reference signal.

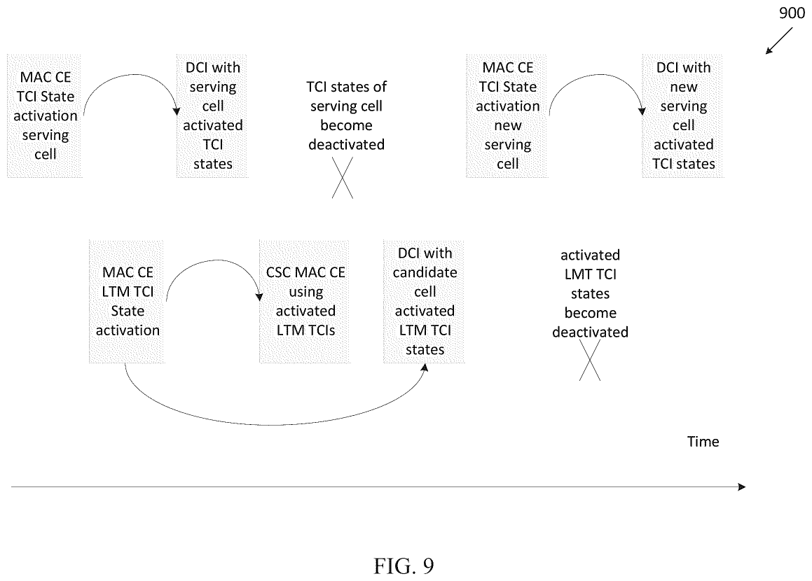

FIG. 9 illustrates an example of a timeline 900 for inter-cell switching according to embodiments of the present disclosure. For example, timeline 900 for inter-cell switching can be followed by the UE 113 of FIG. 1. This example is for illustration only and can be used without departing form the scope of the present disclosure.

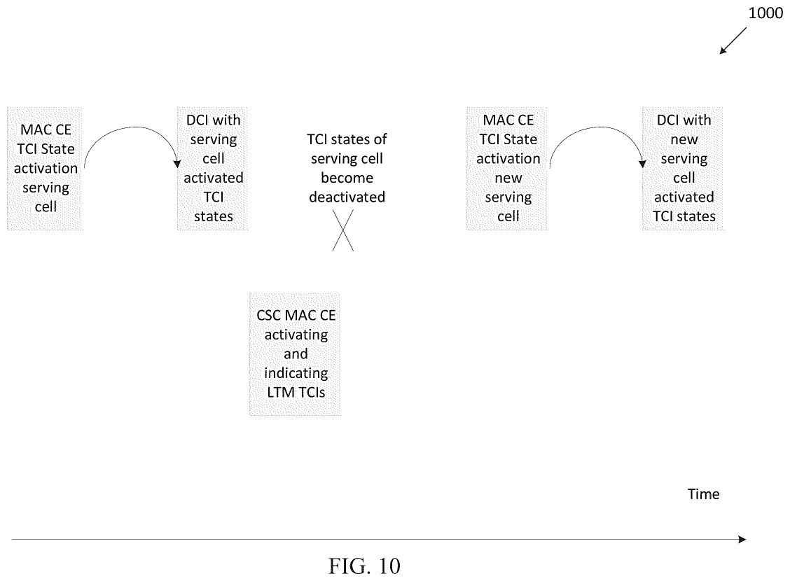

FIG. 10 illustrates an example of a timeline 1000 for inter-cell switching according to embodiments of the present disclosure. For example, timeline 1000 for inter-cell switching can be followed by the UE 114 of FIG. 1. This example is for illustration only and can be used without departing form the scope of the present disclosure.

FIG. 9 and FIG. 10 illustrate examples of dynamic cell switch. A UE has established communication with a first cell. The cell is referred to as a serving cell. As part of establishing communication with the first cell, a first set of TCI states are configured by higher layer (e.g., RRC) signaling. The first set of TCI states can include one or more of (as described herein):
A list of DL or joint TCI states
A list of UL TCI states

The TCI states can have a source RS for QCL or for spatial relation, wherein the source RS can be associated with:
The first cell (i.e., the serving cell)
A cell having a PCI different from the PCI of the first cell (i.e., the serving cell)

The source RS can be a synchronization symbol/physical broadcast channel (SS/PBCH) Block or a NZP CSI-RS resource.

A subset of the TCI states from the first set of TCI states can be activated by MAC CE signaling as illustrated in FIG. 9 and FIG. 10. The subset of TCI states activated are codepoints that can be indicated to the UE by DCI format. The number of activated TCI state codepoints is M1. A codepoint can include:
1. A Joint TCI states for joint (DL and UL) beam indication;
2. A DL TCI state for separate beam indication;
3. An UL TCI state for separate beam indication; and/or
4. A pair of DL TCI state and UL TCI state for separate beam indication.

The UE can be indicated by a DCI Format (e.g., DCI Format 1_1 or DCI Format 1_2, with a DL assignment or without a DL assignment) a codepoint from the activated TCI state code points.

Layer 1/Layer 2-triggered mobility (LTM) TCI states are configured for the candidate cells. A second set of TCI states is activated or configured for one or more candidate cells. The maximum number of candidate cells for which TCI states are activated or configured depends on a UE capability. In one example, the maximum number of candidate cells is one. The second set of TCI states can include one or more of:
A list of DL or joint TCI states for the candidate cells, referred to two as LTM (L1/L2-Triggered Mobility) DL or Joint TCI states
A list of UL TCI states for the candidate cells referred to as LTM UL TCI states.

The LTM TCI states can have a source RS for QCL or for spatial relation, wherein the source RS can be associated with one of the candidate cells. In one example, the source RS can be a SS/PBCH Block associated with the candidate cell. For example, the source RS is defined or determined by SS/PBCH Block index and PCI (or PCI index) associated with the candidate cell. In another example, the source RS can be CSI-RS resource, for example the CSI-RS resource can be:
A tracking reference signal (TRS) (e.g., CSI-RS configured with trs-info), or
A CSI-RS resource configured for beam management (e.g., CSI-RS configured with repetition), or
A CSI-RS resource configured for CSI acquisition (e.g., CSI-RS configured without trs-info and without repetition).

The CSI-RS resource can be associated with a candidate cell as described later in this disclosure.

With reference to FIG. 9, a MAC CE activates a subset of LTM TCI states. In case of joint beam indication on the candidate cell for which LTM TCI states being activated, the activated LTM TCI states include LTM joint TCI states. In case of separate beam indication on the candidate cell for which LTM TCI states being activated, the activated LTM TCI states include LTM DL TCI states and LTM UL TCI states. In one example, the MAC CE activated LTM TCI states are for J candidate cells, wherein J≥1. In one example, the maximum value of J is based on a UE capability. In one example, J=1. In one example, the number activated LTM TCI states is M2. In one example, the activated LTM TCI states are codepoints, and the number of codepoints is M2. In one example, an LTM TCI state code point can be:
1. A LTM Joint TCI states for joint (DL and UL) beam indication on the candidate cell;
2. A LTM DL TCI state for separate beam indication on the candidate cell;
3. A LTM UL TCI state for separate beam indication on the candidate cell; and/or
4. A pair of DL TCI state and UL TCI state for separate beam indication on the candidate cell.

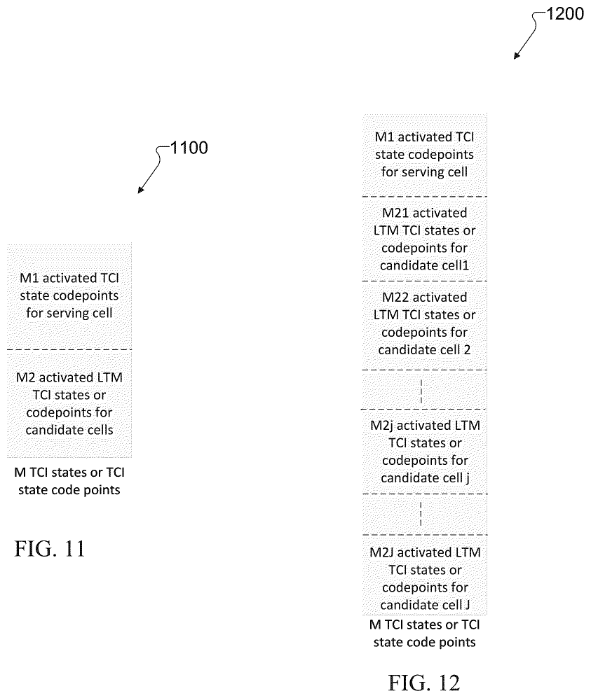

FIG. 11 illustrates a diagram of example TCI states/TCI state codepoints 1100 for serving/candidate cell(s) according to embodiments of the present disclosure. For example, TCI states and TCI state codepoints 1100 can be utilized by any of the UEs 111-116 of FIG. 1, such as the UE 115. This example is for illustration only and can be used without departing form the scope of the present disclosure.

FIG. 12 illustrates a diagram of example TCI states/TCI state codepoints 1200 for serving/candidate cell(s) according to embodiments of the present disclosure. For example, TCI states and TCI state codepoints 1200 can be utilized by any of the UEs 111-116 of FIG. 1, such as the UE 116 of FIG. 3. This example is for illustration only and can be used without departing form the scope of the present disclosure.

In one example, M1 (activated TCI state codepoints for the serving cell (first cell)) and M2 (activated LTM TCI states or LTM TCI state codepoints for candidate cells) are in a same pool or list or set as illustrated in FIG. 11 and FIG. 12, with a size of M (e.g., M=M1+M2). In one example, the maximum value of M depends on a UE capability for example maximum value is given by, M=8 or M=16 or M=4. In one example, the maximum value of M1 depends on a UE capability for example maximum value is given by, M1-8 or M1=4. In one example, the maximum value of M2 depends on a UE capability for example maximum value is given by, M2=8 or M2=4. In FIG. 12, the M2 activated LTM TCI states or LTM TCI state codepoints are further divided into separate subsets or sub-lists for each of the J candidate cells, wherein M2=M21+M22+ . . . M2j+ . . . +M2J, and M2j is the number of activated LTM TCI states or LTM TCI state codepoints for cell j, and j=1, . . . J. Alternatively, j can be adjusted to be in the range j=0, . . . , J−1. In one example, the maximum number of activated TCI states or TCI state codepoints per cell (e.g., M2j) can depend on a UE capability, for example maximum value is given by, M2j=4, or M2j=8, M2j=1, or M2j=2. In one example, M2j=n for joint beam indication and M2j=2n for separate beam indication, wherein for example, n=1 or n=2. The activated TCI states or TCI state codepoints can be index sequentially according to FIG. 11 or FIG. 12.

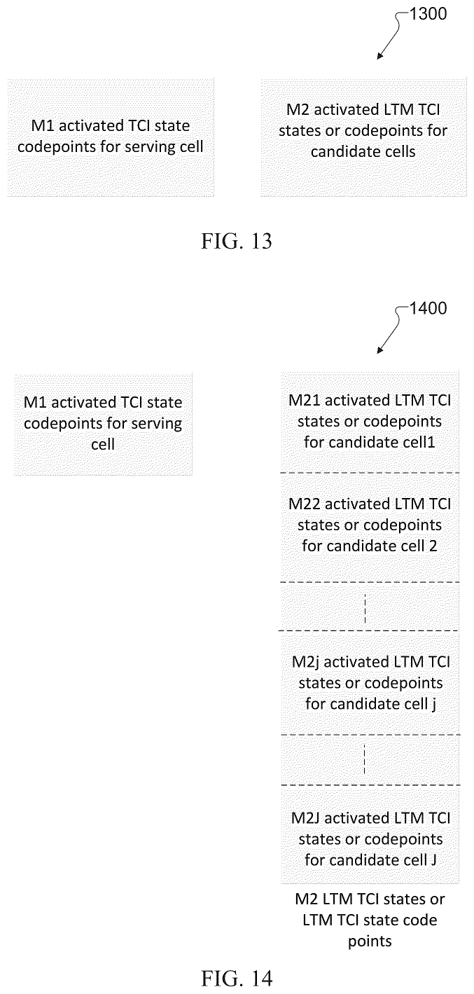

FIG. 13 illustrates a diagram of example TCI states and TCI state codepoints 1300 for serving/candidate cell(s) according to embodiments of the present disclosure. For example, TCI states and TCI state codepoints 1300 can be utilized by any of the UEs 111-116 of FIG. 1, such as the UE 111. This example is for illustration only and can be used without departing form the scope of the present disclosure.

In one example, M1 (activated TCI state codepoints for the serving cell (first cell)) and M2 (activated TCI states or TCI state codepoints for candidate cells) are in separate pools or lists or sets as illustrated in FIG. 13. In one example, the maximum value of M1 depends on a UE capability for example maximum value is given by, M1=8 or M1=4. In one example, the maximum value of M2 depends on a UE capability for example maximum value is given by, M2=8 or M2=4. In one example, there is a maximum size of M=M1+M2 that depends on a UE capability, for example maximum value is given by, M=8 or M=16 or M=4.

FIG. 14 illustrates a diagram of example TCI states and TCI state codepoints 1400 for serving/candidate cell(s) according to embodiments of the present disclosure. For example, TCI states and TCI state codepoints 1400 can be utilized by any of the UEs 111-116 of FIG. 1, such as the UE 112. This example is for illustration only and can be used without departing form the scope of the present disclosure.

In a variant of FIG. 13, with reference to FIG. 14, the M2 activated LTM TCI states or LTM TCI state codepoints are further divided into separate subsets or sub-lists for each of the J candidate cells, wherein M2=M21+M22+ . . . . M2j+ . . . +M2J, and M2j is the number of activated LTM TCI states or LTM TCI state codepoints for cell j, and j=1, . . . J. Alternatively, j can be adjusted to be in the range j=0, . . . , J−1. In one example, the maximum number of activated LTM TCI states or LTM TCI state codepoints per cell (e.g., M2j) can depend on a UE capability, for example maximum value is given by, M2j=4, or M2j=8, M2j=1, or M2j=2. In one example, M2j=n for joint beam indication and M2j=2n for separate beam indication, wherein for example, n=1 or n=2. With reference to FIG. 14, the activated LTM TCI states or LTM TCI state codepoints for candidate cells can be index sequentially.

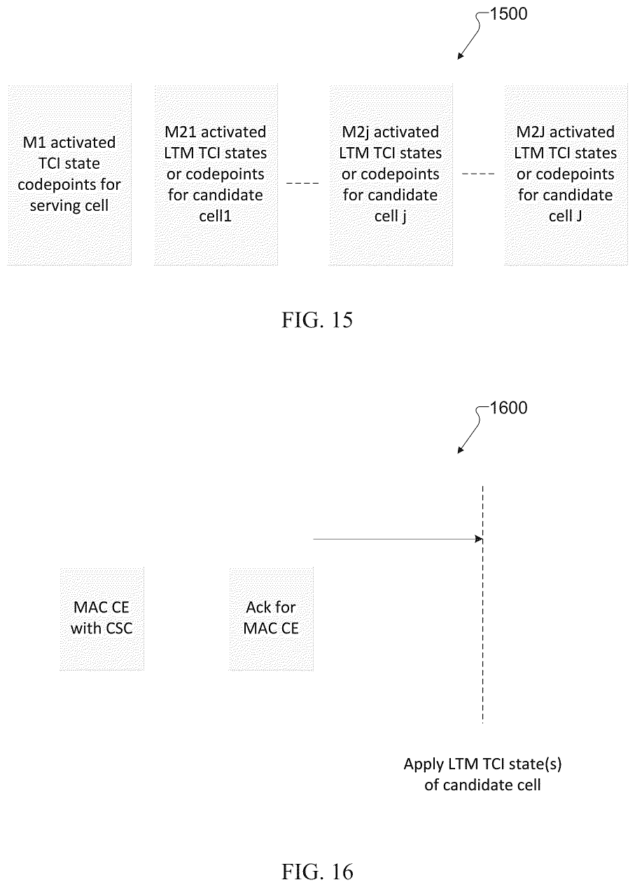

FIG. 15 illustrates a diagram of example TCI states/TCI state codepoints 1500 for serving/candidate cell(s) according to embodiments of the present disclosure. For example, TCI states and TCI state codepoints 1500 can be utilized by any of the UEs 111-116 of FIG. 1, such as the UE 113. This example is for illustration only and can be used without departing form the scope of the present disclosure.

In a variant of FIG. 13 and FIG. 14 as illustrated in FIG. 15, the M2 activated LTM TCI states or LTM TCI state codepoints are further divided into separate subsets or sub-lists for each of the J candidate cells, and each has its own pool or list or set, wherein M2=M21+M22+ . . . M2j+ . . . +M2J, and M2j is the number of activated LTM TCI states or LTM TCI state codepoints for cell j, and j=1, . . . J. Alternatively, j can be adjusted to be in the range j=0, . . . , J−1. In one example, the maximum number of activated LTM TCI states or LTM TCI state codepoints per cell (e.g., M2j) can depend on a UE capability, for example maximum value is given by, M2j=4, or M2j=8, M2j=1, or M2j=2. In one example, M2j=n for joint beam indication and M2j=2n for separate beam indication, wherein for example, n=1 or n=2.

In one example, with reference to FIG. 9, after the activation of the LTM TCI states, the activated TCI state codepoints of the serving cell (e.g., first cell) are maintained and can be indicated to the UE e.g., using a DCI Format, e.g., DCI Format 1_1 or DCI Format 1_2 with or without a DL assignment.

In a variant example, (not shown in FIG. 9), after the LTM TCI states are activated, the activated TCI state codepoints of the serving cell (e.g., first cell) become deactivated. In one example, the deactivation is implicit, i.e., there is no deactivation command, for example the deactivation happens at the same time the LTM TCI states are or become activated. In another example, the deactivation happens after a time T for the channel (e.g., start or end of that channel) conveying the MAC CE activating LTM TCI states, wherein T can be configured and/or updated by RRC signaling and/or MAC CE signaling and/or L1 control signaling. In another example, the deactivation happens after a time T for the channel (e.g., start or end of that channel) conveying the acknowledgement (e.g. positive acknowledgement) to the MAC CE activating LTM TCI states, wherein T can be configured and/or updated by RRC signaling and/or MAC CE signaling and/or L1 control signaling. In one example, the deactivation happens after a time T from the time at which the LTM TCI states are or become activated, wherein T can be configured and/or updated by RRC signaling and/or MAC CE signaling and/or L1 control signaling.

In another example, the deactivation is explicit, i.e., there is a signal (e.g., MAC CE or DCI Format) that deactivates the activated TCI state codepoints of the serving cell (e.g., first cell). In one example, the deactivation signal is sent to the UE after the LTM TCI states are activated.

In one example, with reference to FIG. 9, a cell switch command (e.g., in a MAC CE) is sent to the UE, the cell switch command includes a LTM joint TCI state for a candidate cell in case of joint beam indication for the candidate cell, or a pair of LTM DL TCI state and LTM UL TCI state for the candidate cell in case of separate beam indication for the candidate cell. The LTM joint TCI state or LTM DL TCI state and LTM UL TCI state are from the activated LTM TCI states. In one example, the indication of the LTM joint TCI state or LTM DL TCI state or LTM UL TCI state can be based on the index of the respective TCI state in the RRC configured list of LTM DL or Joint TCI states or UL TCI states. In one example, the indication of the LTM joint TCI state or LTM DL TCI state or LTM UL TCI state can be based on an index in the activated set of LTM TCI states. For example, the index is based on the order of the LTM TCI state in the activated set or list of LTM TCI states. For example, a first activated LTM TCI state in the set or list has index 0, a second activated LTM TCI state in the set or list has an index of 1, and so on.

In one example, the indication of the LTM joint TCI state or LTM DL TCI state or LTM UL TCI state can be based on an index in the activated set of LTM TCI state codepoints. For example, the index or codepoint is based on the order of the LTM TCI state codepoint in the activated set or list of LTM TCI state codepoints. For example, a first activated LTM TCI state codepoint in the set or list has index 0, a second activated LTM TCI state codepoint in the set or list has an index of 1, and so on.

For brevity, an LTM TCI state or LTM TCI state codepoint in a cell switch command can refer to a LTM joint TCI state for a candidate cell in case of joint beam indication for the candidate cell, or a pair of LTM DL TCI state and LTM UL TCI state for the candidate cell in case of separate beam indication for the candidate cell.

In one example, the activated LTM TCI states or LTM TCI state codepoints are indexed globally across candidate cells with activated LTM TCI states. In another example, the activated LTM TCI states or LTM TCI state codepoints are indexed separately across each candidate cell with activated TCI states. For example, the cell switch command can include a candidate cell ID and an index or ID for the LTM TCI state or TCI state codepoint within that cell.

In one example, the configured (e.g., RRC configured) LTM TCI states are indexed globally across candidate cells with configured (e.g., RRC configured) LTM TCI states. In another example, the activated LTM TCI states are indexed separately across each candidate cell with configured (e.g., RRC configured) TCI states. For example, the cell switch command or MAC CE LTM TCI state activation command can include a candidate cell ID and an index or ID for the LTM TCI state within that cell.

In one example, with reference to FIG. 10, a cell switch command (e.g., in a MAC CE) is sent to the UE. The cell switch command includes a LTM joint TCI state for a candidate cell in case of joint beam indication for the candidate cell, or a pair of LTM DL TCI state and LTM UL TCI state for the candidate cell in case of separate beam indication for the candidate cell. The LTM joint TCI state or LTM DL TCI state and LTM UL TCI state are not activated prior to the cell switch command. The cell switch command both activates and indicates the LTM TCI state(s). The indication of LTM TCI states, refers to the use of the TCI state(s) for transmission and reception by the UE, e.g., to determine QCL properties and/or spatial filter. In one example, the activation and indication of the LTM joint TCI state or LTM DL TCI state or LTM UL TCI state can be based on the index of the respective TCI state in the RRC configured list of LTM DL or Joint TCI states or UL TCI states. In one example, the configured (e.g., RRC configured) LTM TCI states are indexed globally across candidate cells with configured (e.g., RRC configured) LTM TCI states. In another example, the activated LTM TCI states are indexed separately across each candidate cell with configured (e.g., RRC configured) TCI states. For example, the cell switch command or MAC CE LTM TCI state activation command can include a candidate cell ID and an index or ID for the LTM TCI state within that cell.

FIG. 16 illustrates a diagram of an example MAC CE configuration 1600 for TCI state(s) of candidate cell according to embodiments of the present disclosure. For example, MAC CE configuration 1600 for TCI state(s) can be implemented by the UE 111 of FIG. 1. This example is for illustration only and other embodiments can be used without departing from the scope of the present disclosure.

In one example, when an LTM TCI state or TCI state codepoint is indicated (e.g., FIG. 9) or activated and indicated (e.g., FIG. 10) in a cell switch command, the UE applies the LTM TCI state after a time T. In one example, T is measured from the channel (e.g., start or end of channel) carrying the MAC CE with the cell switch command. In one example, T is measured from the channel (e.g., start or end of channel) carrying the acknowledgement (e.g., positive Ack) to the MAC CE with the cell switch command. For the example, with reference to FIG. 16, the time T is from the end of the channel carrying the acknowledgment to the MAC CE with the cell switch command. In the example, the value of T can depend on whether the TCI state is indicated (e.g., FIG. 9) or is activated and indicated (e.g., FIG. 10), e.g., two values can be configured and/or updated by RRC signaling and/or MAC CE signaling and/or L1 control signaling for T, depending on the scenario. In the example, the value of T is independent of whether the TCI state is indicated (e.g., FIG. 9) or is activated and indicated (e.g., FIG. 10) e.g., one value can be configured and/or updated by RRC signaling and/or MAC CE signaling and/or L1 control signaling for T.

In one example, if the TCI state has been activated before the cell switch command, the beam application time T is 3Nₛₗₒₜ^{subframe,μ} slots.

In one example, if the TCI state has not been activated before the cell switch command, value of T is decided by RAN4. Based on the current RAN4 specifications, when the source RS of the TCI state is SSB, the beam application time T can be given by (see clause 8.10.3 of TS 38.133):

$$3 {N}_{slot}^{subframe , μ} + {TO}_{k} * \frac{( {T}_{first - SSB} + {T}_{SSB - proc} )}{NR slot length} ,$$

where:
TOₖ=1, as the target TCI state is not in the active list.
T_{first-SSB} is time to the first SSB transmission after the MAC CE with the cell switch command is decoded.
T_{SSB-proc}=2 ms.

In one example, a UE determines if a candidate cell applies a joint or separate beam indication based on:
A flag or indication by RRC configuration for each candidate cell indicating if candidate cell uses joint beam indication or separate beam indication.
A flag or indication by RRC configuration common for candidate cells indicating if candidate cells use joint beam indication or separate beam indication.
A flag in cell switch command indicating if candidate cell uses joint beam indication or separate beam indication.
If a UE is configured with DL or Joint TCI states for a candidate cell, it uses joint beam indication. If a UE is configured with DL or Joint TCI states and UL TCI states for a candidate cell, it uses separate beam indication.
If a UE is activated DL or Joint TCI states for a candidate cell, it uses joint beam indication. If a UE is activated DL or Joint TCI states and UL TCI states for a candidate cell, it uses separate beam indication.
If in the cell switch command (for example as illustrated in FIG. 9), a UE is indicated one TCI state (e.g., LTM joint TCI state), it uses joint beam indication. If a UE is indicated in the cell switch command a pair of TCI states (e.g., LTM DL TCI state and LTM UL TCI state), the UE uses separate beam indication.
If in the cell switch command (for example as illustrated in FIG. 10), a UE is activated and indicated one TCI state (e.g., LTM joint TCI state), it uses joint beam indication. If a UE is activated and indicated in the cell switch command a pair of TCI states (e.g., LTM DL TCI state and LTM UL TCI state), the UE uses separate beam indication.

In one example, with reference to FIG. 9 and in FIG. 10, after the cell switch command, the activated TCI states codepoints of the serving cell (e.g., first cell) become deactivated. In one example, the deactivation is implicit, i.e., there is no deactivation command. For example, the deactivation happens at the same time the LTM TCI state(s) indicated in the cell switch command are applied. In another example, the deactivation happens after a time T for the channel (e.g., start or end of that channel) conveying the MAC CE with the cell switch command, wherein T can be configured and/or updated by RRC signaling and/or MAC CE signaling and/or L1 control signaling. In another example, the deactivation happens after a time T for the channel (e.g., start or end of that channel) conveying the acknowledgment (e.g. positive acknowledgment) to the MAC CE with the cell switch command, wherein T can be configured and/or updated by RRC signaling and/or MAC CE signaling and/or L1 control signaling. In one example, the deactivation happens after a time T from the time at which the LTM TCI state(s) are applied, wherein T can be configured and/or updated by RRC signaling and/or MAC CE signaling and/or L1 control signaling.

In another example, the deactivation is explicit, i.e., there is a signal (e.g., MAC CE or DCI Format) that deactivates the activated TCI state codepoints of the serving cell (e.g., first cell). In one example, the deactivation signal is sent to the UE after the LTM TCI state(s) in the cell switch command are applied. In one example, the deactivation signal is sent to the UE after the cell switch command is acknowledged (e.g., positive ack).

In one example, with reference to FIG. 9, the activated LTM TCI states or TCI state codepoint for the candidate cell continue to be used after the cell switch command. In one example, a DCI Format (e.g., DCI Format 1_1 or DCI Format 1_2 with or without DL assignment) can indicate one of the activated LTM TCI states or LTM TCI state codepoints.

In one example, (not shown in FIG. 9), after the cell switch command, the activated LTM TCI states or LTM TCI state codepoints become deactivated (in one example, with the exception of the LTM TCI state(s) being indicated in the cell switch command, in another example with the exception of the activated LTM TCI states or LTM TCI state codepoints of the candidate cell of the TCI indicated in the cell switch command). In one example, the deactivation is implicit, i.e., there is no deactivation command. For example, the deactivation happens at the same time the LTM TCI state(s) indicated in the cell switch command are applied. In another example, the deactivation happens after a time T for the channel (e.g., start or end of that channel) conveying the MAC CE with the cell switch command, wherein T can be configured and/or updated by RRC signaling and/or MAC CE signaling and/or L1 control signaling. In another example, the deactivation happens after a time T for the channel (e.g., start or end of that channel) conveying the acknowledgment (e.g. positive acknowledgment) to the MAC CE with the cell switch command, wherein T can be configured and/or updated by RRC signaling and/or MAC CE signaling and/or L1 control signaling. In one example, the deactivation happens after a time T from the time at which the LTM TCI state(s) are applied, wherein T can be configured and/or updated by RRC signaling and/or MAC CE signaling and/or L1 control signaling.

In another example, the deactivation is explicit, i.e., there is a signal (e.g., MAC CE or DCI Format) that deactivates the activated LTM TCI states or LTM TCI state codepoints (in one example, with the exception of the LTM TCI state(s) being indicated in the cell switch command). In one example, the deactivation signal is sent to the UE (e.g., the UE 116) after the LTM TCI state(s) in the cell switch command are applied. In one example, the deactivation signal is sent to the UE after the cell switch command is acknowledged (e.g., positive ack).

In one example, after cell switch to a candidate cell, (e.g., referred to as a second cell or a new serving cell), the network (e.g., the network 130) can send to the UE a MAC CE to activate TCI states for the second cell. A third set of TCI states are configured by higher layer (e.g., RRC) signaling for the second cell. The third set of TCI states can include one or more of (as described herein):
A list of DL or joint TCI states
A list of UL TCI states

In one example, the third set of TCI states for a second cell is a superset of LTM TCI states (the second set of TCI states) configured for the second cell (e.g., as a candidate cell). The LTM TCI states (the second set of TCI states) configured for a candidate cell (the second cell) is a subset of the third set of TCI states configured for the second cell (e.g., to be used after cell switch as described in this disclosure). This can allow the LTM TCI states to continue to be used after cell switch, which can reduce the UE's complexity. In one example, a same TCI state in the second set and in the third set (e.g., having same source RS and QCL/spatial relation types) has a same TCI state ID. In one example, a same TCI state in the second set and in the third set (e.g., having same source RS and QCL/spatial relation types) can have different TCI state IDs.

In one example, the third set of TCI states for a second cell is equivalent to the set of LTM TCI states (the second set of TCI states) configured for the second cell (e.g., as a candidate cell). In one example, a same TCI state in the second set and in the third set (e.g., having same source RS and QCL/spatial relation types) has a same TCI state ID. In one example, a same TCI state in the second set and in the third set (e.g., having same source RS and QCL/spatial relation types) can have different TCI state IDs.

In one example, the third set of TCI states for a second cell is a subset of LTM TCI states (the second set of TCI states) configured for the second cell (e.g., as a candidate cell). In one example, a same TCI state in the second set and in the third set (e.g., having same source RS and QCL/spatial relation types) has a same TCI state ID. In one example, a same TCI state in the second set and in the third set (e.g., having same source RS and QCL/spatial relation types) can have different TCI state IDs.

Set A is a superset of set B when elements of set B are also elements of set A. Set A is equivalent to set B, when elements of set A are also elements of set B and elements of set B are also elements of set A. Set A is a subset of set B, when elements of set A are also elements of set B.

In one example, the third set of TCI states can be configured for the second cell prior to the cell switch command being sent to the UE.

The TCI states can have a source RS for QCL or for spatial relation, wherein the source RS can be associated with:
The second cell (i.e., the new serving cell)
A cell having a PCI different from the PCI of the second cell (i.e., the new serving cell)

The source RS can be a SS/PBCH Block or a NZP CSI-RS resource.

With reference to FIG. 9 and FIG. 10, a subset of the TCI states from the third set of TCI states can be activated by MAC CE signaling. The subset of TCI states activated are codepoints that can be indicated to the UE by DCI format. The number of activated TCI state codepoints is M1. A codepoint can include:
1. A Joint TCI states for joint (DL and UL) beam indication;
2. A DL TCI state for separate beam indication;
3. An UL TCI state for separate beam indication; and/or
4. A pair of DL TCI state and UL TCI state for separate beam indication;

The UE can be indicated by a DCI Format (e.g., DCI Format 1_1 or DCI Format 1_2, with a DL assignment or without a DL assignment) a codepoint from the activated TCI state code points of the second cell.

In one example (not shown in FIG. 9), after a MAC CE activates TCI state code points for the second cell, the activated TCI states codepoints of the serving cell (e.g., first cell) become deactivated. In one example, the deactivation is implicit, i.e., there is no deactivation command. For example, the deactivation happens at the same time the TCI state code points of the second cell are activated. In another example, the deactivation happens after a time T for the channel (e.g., start or end of that channel) conveying the MAC CE activating TCI state code points for the second cell, wherein T can be configured and/or updated by RRC signaling and/or MAC CE signaling and/or L1 control signaling. In another example, the deactivation happens after a time T for the channel (e.g., start or end of that channel) conveying the acknowledgment (e.g. positive acknowledgment) to the MAC CE activating TCI state code points for the second cell, wherein T can be configured and/or updated by RRC signaling and/or MAC CE signaling and/or L1 control signaling. In one example, the deactivation happens after a time T from the time at which the activation of the TCI states of the second cell occurs, wherein T can be configured and/or updated by RRC signaling and/or MAC CE signaling and/or L1 control signaling.

In another example, the deactivation is explicit, i.e., there is a signal (e.g., MAC CE or DCI Format) that deactivates the activated TCI state codepoints of the serving cell (e.g., first cell). In one example, the deactivation signal is sent to the UE after the activation of the TCI states of the second cell. In one example, the deactivation signal is sent to the UE after the MAC CE activating TCI state code points for the second cell is acknowledged (e.g., positive ack).

In one example, with reference to FIG. 9, after a MAC CE activates TCI state code points for the second cell, the activated LTM TCI states or LTM TCI state codepoints become deactivated (in one example, with the exception of the TCI state(s) being indicated in the cell switch command). In one example, the deactivation is implicit, i.e., there is no deactivation command. For example, the deactivation happens at the same time the TCI state code points of the second cell are activated. In another example, the deactivation happens after a time T for the channel (e.g., start or end of that channel) conveying the MAC CE activating TCI state code points for the second cell, wherein T can be configured and/or updated by RRC signaling and/or MAC CE signaling and/or L1 control signaling. In another example, the deactivation happens after a time T for the channel (e.g., start or end of that channel) conveying the acknowledgment (e.g. positive acknowledgment) to the MAC CE activating TCI state code points for the second cell, wherein T can be configured and/or updated by RRC signaling and/or MAC CE signaling and/or L1 control signaling. In one example, the deactivation happens after a time T from the time at which the activation of the TCI states of the second cell occurs, wherein T can be configured and/or updated by RRC signaling and/or MAC CE signaling and/or L1 control signaling.

In another example, the deactivation is explicit, i.e., there is a signal (e.g., MAC CE or DCI Format) that deactivates the activated LTM TCI states or LTM TCI state codepoints (in one example, with the exception of the TCI state(s) being indicated in the cell switch command). In one example, the deactivation signal is sent to the UE after the activation of the TCI states of the second cell. In one example, the deactivation signal is sent to the UE after the MAC CE activating TCI state code points for the second cell is acknowledged (e.g., positive ack).

In one example (not shown in FIG. 9), after a first in time DCI format indicates a TCI state code point for the second cell, the activated TCI states codepoints of the serving cell (e.g., first cell) become deactivated. In one example, the deactivation is implicit, i.e., there is no deactivation command. For example, the deactivation happens at the same time the indicated TCI state code point of the second cell is applied. In another example, the deactivation happens after a time T for the channel (e.g., start or end of that channel) conveying the DCI Format with the indicated TCI state code point for the second cell, wherein T can be configured and/or updated by RRC signaling and/or MAC CE signaling and/or L1 control signaling. In another example, the deactivation happens after a time T for the channel (e.g., start or end of that channel) conveying the acknowledgment (e.g. positive acknowledgment) to the DCI Format with the indicated TCI state code point for the second cell, wherein T can be configured and/or updated by RRC signaling and/or MAC CE signaling and/or L1 control signaling. In one example, the deactivation happens after a time T from the time at which the TCI state(s) of the second cell are applied, wherein T can be configured and/or updated by RRC signaling and/or MAC CE signaling and/or L1 control signaling.

In another example, the deactivation is explicit, i.e., there is a signal (e.g., MAC CE or DCI Format) that deactivates the activated TCI state codepoints of the serving cell (e.g., first cell). In one example, the deactivation signal is sent to the UE after the application of the TCI state(s) of the second cell. In one example, the deactivation signal is sent to the UE after the DCI Format indicating TCI state code point for the second cell is acknowledged (e.g., positive ack).

In one example, (not shown in FIG. 9), after a first in time DCI format indicates a TCI state code points for the second cell, the activated LTM TCI states or LTM TCI state codepoints become deactivated. In one example, the deactivation is implicit, i.e., there is no deactivation command, for example the deactivation happens at the same time the indicated TCI state code point of the second cell is applied. In another example, the deactivation happens after a time T for the channel (e.g., start or end of that channel) conveying the DCI Format with the indicated TCI state code point for the second cell, wherein T can be configured and/or updated by RRC signaling and/or MAC CE signaling and/or L1 control signaling. In another example, the deactivation happens after a time T for the channel (e.g., start or end of that channel) conveying the acknowledgment (e.g. positive acknowledgment) to the DCI Format with the indicated TCI state code point for the second cell, wherein T can be configured and/or updated by RRC signaling and/or MAC CE signaling and/or L1 control signaling. In one example, the deactivation happens after a time T from the time at which the TCI state(s) of the second cell are applied, wherein T can be configured and/or updated by RRC signaling and/or MAC CE signaling and/or L1 control signaling.

In another example, the deactivation is explicit, i.e., there is a signal (e.g., MAC CE or DCI Format) that deactivates the activated LTM TCI states or LTM TCI state codepoints. In one example, the deactivation signal is sent to the UE after the application of the TCI states of the second cell. In one example, the deactivation signal is sent to the UE after the DCI Format indicating TCI state code point for the second cell is acknowledged (e.g., positive ack).

In a variant of the examples of FIG. 9 and FIG. 10, the third set of TCI states for the second cell includes:
A list of DL or joint TCI states that includes one TCI state; and/or
list of UL TCI states that includes one TCI state.

After a cell switch command by a time T, e.g., a time T from end of the acknowledgement (e.g., positive Ack), of the MAC CE carrying the cell switch command, the UE applies the one joint TCI state or the one DL TCI state and/or the one UL TCI state.

In a variant of the examples of FIG. 9 and FIG. 10, a UE is activated a set of code points for the second cell from the third set of TCI states.
In one example, the set of activated TCI state code points includes one code point (e.g., for joint TCI state, or for a pair of DL and UL TCI states).
In one example, the set of activated TCI state code points includes one code point for DL TCI state and one code point for UL TCI state.

After MAC CE activation the TCI state code point(s), the TCI states are applied, and
In one example, the activated TCI states codepoints of the serving cell (e.g., first cell) become deactivated following the examples described herein.
In one example, activated LTM TCI states or LTM TCI state codepoints become deactivated following the examples described herein.

In one example, when the UE supports NZP CSI-RS resource (e.g., tracking reference signal) as a source RS of an LTM TCI state for a candidate cell, NZP CSI-RS resources are configured with a LTM TCI state for quasi-co-location information.

In TS 38.331 [REF6], the NZP-CSI-RS resource IE

| | | |
|---|---|---|
| NZP-CSI-RS-Resource ::= | SEQUENCE { | |
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED{db-3, db0, db3, db6} | OPTIONAL, - |
| - Need R | | |
| scramblingID | ScramblingId, | |
| periodicityAndOffset | CSI-ResourcePeriodicityAndOffset | OPTIONAL, -- |
| Cond PeriodicOrSemiPersistent | | |
| qcl-InfoPeriodicCSI-RS | TCI-StateId | OPTIONAL, -- Cond |
| Periodic | | |
| ... | | |
| } | | |

In one example, a TCI state ID can a TCI-StateId of a serving cell as described herein. In one example, a TCI state ID can be LTM-tci-StateId for a LTM candidate cell as described herein.

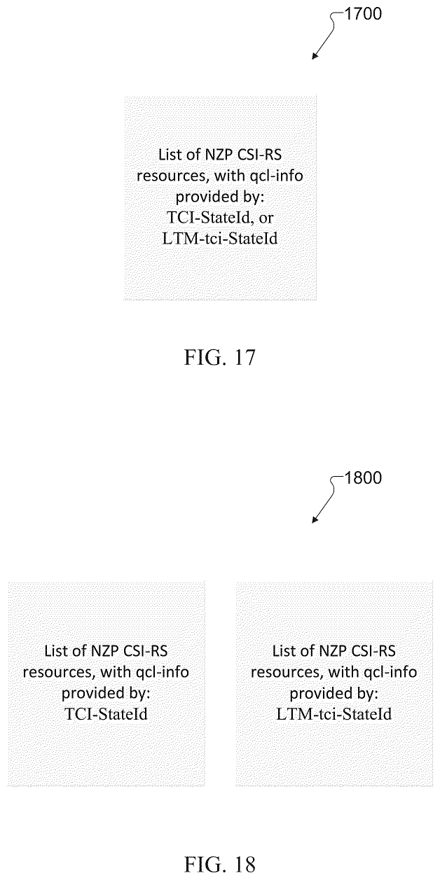

FIG. 17 illustrates a diagram of an example list of NZP CSI-RS resources 1700 according to embodiments of the present disclosure. For example, list of NZP CSI-RS resources 1700 can be referenced by any of the UEs 111-116 of FIG. 1, such as the UE 112. This example is for illustration only and other embodiments can be used without departing from the scope of the present disclosure.

In one example, with reference to FIG. 17, there is one pool or list of NZP CSI-RS resources, wherein the qcl-info for some CSI-RS resources are provided by TCI-StateId and the qcl-info for other CSI-RS resources are provided by LTM-tci-StateId. For example, qcl-InfoPeriodicCSI-RS can be given by:

| | |
|---|---|
| qcl-InfoPeriodicCSI-RS | CHOICE { |
| | TCI-StateId, |
| | LTM-tci-StateId |
| }, | |

FIG. 18 illustrates a diagram of example lists of NZP CSI-RS resources 1800 according to embodiments of the present disclosure. For example, lists of NZP CSI-RS resources 1800 can be referenced by any of the UEs 111-116 of FIG. 1, such as the UE 113. This example is for illustration only and other embodiments can be used without departing from the scope of the present disclosure.

In one example, with reference to FIG. 18, there are two pools or lists of NZP CSI-RS resources, wherein the qcl-info for the NZP CSI-RS resources of the first pool or list is provided by TCI-StateId, and the qcl-info for the NZP CSI-RS resources of the second pool or list is provided by LTM-tci-StateId.

In a variant of the example of FIG. 17, there are multiple pools or lists for NZP CSI-RS resources with qcl-info provided by LTM-tci-StateId, wherein each candidate cell has a pool or list of NZP CSI-RS resources.

In one example, LTM TCI state has a source RS for quasi co-location or spatial relation and the source RS can be:
SS/PBCH bock (SSB) of a candidate cell, which is determined by PCI index of a candidate cell and SSB index within the SSBs of the candidate cell; and/or
NZP CSI-RS resource with qcl-info provided by LTM-tci-StateId.

In one example, a UE is configured with a list(s) of cells that apply the same TCI state. The list(s) of cells applies to first serving cell before the cell switch command.

In one example, a UE receives configuration for candidate cells, wherein for each candidate cell, a UE is configured with a list(s) of cells that apply the same TCI state.

In another example, for the candidate cells, the UE uses the same list(s) of cells configured for the serving cell.

A UE receives a cell switch command to switch to one of the candidate cells. In one example, after cell switch, the UE applies the LTM TCI state(s) to cells that are in the same list as the candidate cell.

In one example, the cell switch command can include a flag indicating whether to apply the indicated (and activated if applicable) TCI state(s) in the cell switch command to the candidate only or to additional cells as determined by the configured list(s) of cells applying the indicated TCI state.

In one embodiment, a UE determines the transmit power for an uplink transmission on a candidate cell after cell switch.

In one example, the PUSCH transmit power is given by (TS 38.213 [REF3] clause 7.1.1):

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} dBm .$$

In one example, the PUCCH transmit power is given by (TS 38.213 [REF3] clause 7.2.1):

$${P}_{PUCCH , b , f , c} ( i , {q}_{u} , {q}_{d} , l ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix} \} dBm .$$

In one example, the SRS transmit power is given by (TS 38.213 [REF3] clause 7.3.1):

$${P}_{SRS , b , f , c} ( i , {q}_{s} , l ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + \\ {α}_{b , f , c} ( {q}_{s} ) \cdot {PL}_{b , f , c} ( {q}_{d} ) + {h}_{b , f , c} ( i , l )\end{matrix} \} dBm .$$

In one example, to determine the transmit power according to the equations described herein, the following parameters can be used:
Pathloss reference signal e.g., for q_{d}; and/or
Power control parameter P_{O}, α and closed loop index for each of PUSCH, PUCCH and SRS

In one example, a pathloss reference signal ID is included (e.g., configured) in the LTM TCI state, e.g., the LTM TCI state can be a for a joint TCI state, or an UL TCI state. In one example, a pathloss reference signal ID can be the ID of the reference Signal (e.g. a CSI-RS or a SS block) used for PUSCH, PUCCH and SRS path loss estimation. In one example, this field refers to an element in a list configured for candidate cells where the joint or UL TCI State is applied by the UE. In one example, the pathloss reference signal can be a SS/PBCH block of the candidate cell (e.g., determined by the candidate cell index and SSB index for that candidate cell). In one example, the pathloss reference signal can be a NZP CSI-RS associated with a candidate cell as described herein. In one example, the NZP CSI-RS is a periodic RS.

In one example, a pathloss reference signal ID is not included (e.g., not configured) in the LTM TCI state, a UE can use the source reference signal for QCL or spatial relation in the LTM TCI state (e.g., joint or UL TCI state) as the pathloss reference signal. In one example, the pathloss reference signal can be a SS/PBCH block of the candidate cell (e.g., determined by the candidate cell index and SSB index for that candidate cell). In one example, the pathloss reference signal can be a NZP CSI-RS associated with a candidate cell as described herein. In one example, the NZP CSI-RS is a periodic RS.

In one example, the L1/L2-triggered mobility (LTM) TCI state (e.g., joint or UL TCI state) includes an Uplink-powerControlId.

In one example Uplink-powerControlId, refers to p0AlphaSetforPUSCH and p0AlphaSetforPUCCH and p0AlphaSetforSRS for PUSCH, PUCCH and SRS, where each of p0AlphaSetforPUSCH and p0AlphaSetforPUCCH and p0AlphaSetforSRS includes:

| | | |
|---|---|---|
| p0 | INTEGER (−16..15) | OPTIONAL, -- Need R |
| alpha | Alpha | OPTIONAL, -- Need S |
| closedLoopIndex | ENUMERATED { i0, i1 } | |

In a variant example, alpha is not included, and alpha is equal to 1.

In a variant example, closedLoopIndex is not included and the closedLoop index is i0.

In a variant example, closedLoopIndex is not included and closed loop power control is not used.

In one example Uplink-powerControlId, refers to a common p0AlphaSet for PUSCH, PUCCH and SRS, where p0AlphaSet includes:

| | | |
|---|---|---|
| p0 | INTEGER (−16..15) | OPTIONAL, -- Need R |
| alpha | Alpha | OPTIONAL, -- Need S |
| closedLoopIndex | ENUMERATED { i0, i1 } | |

In a variant example, alpha is not included, and alpha is equal to 1.

In a variant example, alpha is not included, and alpha is equal to 0.

In a variant example, closedLoopIndex is not included and the closedLoop index is i0.

In a variant example, closedLoopIndex is not included and closed loop power control is not used.

In one example, the LMT TCI state (e.g., joint or UL TCI state) doesn't include an Uplink-powerControlId. Uplink power control parameters can be configured by RRC and/or MAC CE.
In one example, the UL power control parameters can be configured separately for each of PUSCH, PUCCH and/or SRS.
In one example, the UL power control parameters are common for PUSCH, PUCCH and SRS.
In one example, the power control parameters, include p0, alpha and closedLoopIndex.
In one example, alpha is not configured, and alpha is equal to 1.
In one example, alpha is not configured, and alpha is equal to 0.
In one example, closedLoopIndex is not configured and closedLoopIndex is i0.
In one example, closedLoopIndex is not configured and closed loop power control is not used.

In one example, the LMT TCI state (e.g., joint or UL TCI state) doesn't include an Uplink-powerControlId. Uplink power control parameters are not configured by higher layers.
In one example, p0 is 0.
In one example, alpha is 1.
In one example, alpha is 0.
In one example, closedLoopIndex is i0.
In one example, closed loop power control is not used.

In one example, the transmit power is determined based on latest physical random access channel (PRACH) transmission power (e.g., using a PDCCH order) on the candidate cell of the uplink transmission. In one example, for the transmission power for PUSCH: P_{O_PUSCH,b,f,c}(j)=P_{O_PRE}+A, where P_{O_PRE} is the latest PRACH transmission power, and A is an offset that can be configured by higher layers (e.g., RRC signaling and/or MAC CE signaling). P_{O_PUSCH,b,f,c}(j) is as shown in the equation described herein. In one example a similar equation can be used for PUCCH and SRS. In one example, a separate A is configured for each of PUSCH, PUCCH and SRS. In one example, a same 4 is configured for PUSCH, PUCCH and/or SRS. In one example alpha is 1. In one example alpha is 0. In one example, closedLoopIndex is i0. In one example, closed loop power control is not used. In one example, the pathloss RS can be the reference signal used by corresponding PRACH transmissions for pathloss estimation.

A time unit for DL signaling, for UL signaling, on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1).

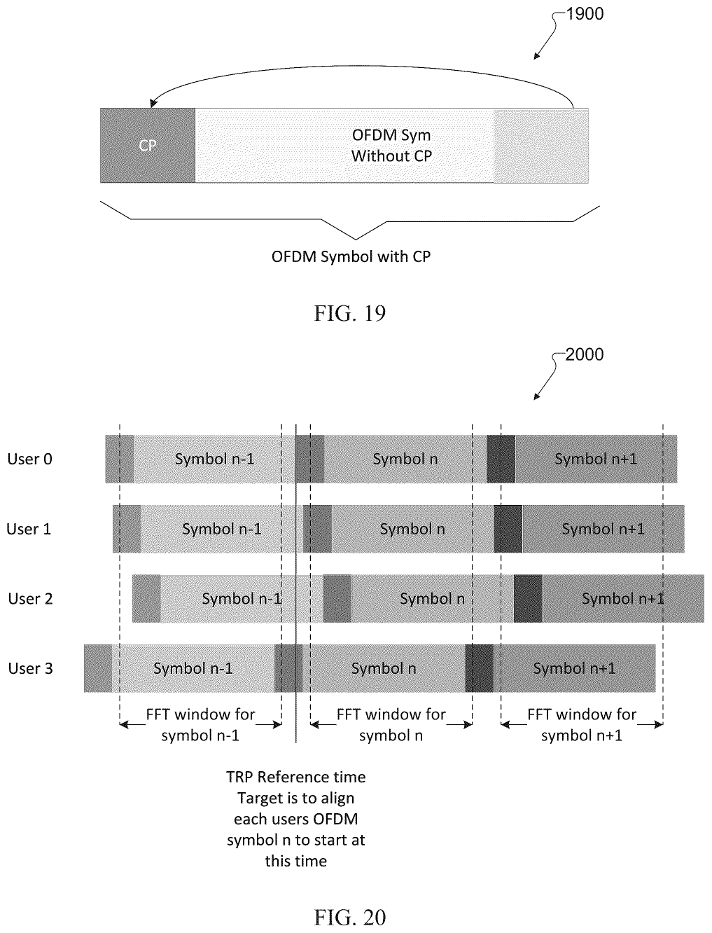

FIG. 19 illustrates a diagram of an example OFDM waveform 1900 according to embodiments of the present disclosure. For example, OFDM waveform 1900 can be utilized by any of the UEs 111-116 of FIG. 1. This example is for illustration only and other embodiments can be used without departing from the scope of the present disclosure.

FIG. 20 illustrates a diagram of example FFT windows 2000 according to embodiments of the present disclosure. For example, FFT windows 2000 can be utilized by the UE 116 of FIG. 3 or by gNB 102 of FIG. 2. This example is for illustration only and other embodiments can be used without departing from the scope of the present disclosure.

With reference to FIG. 19, NR uses Cyclic Prefix (CP)-OFDM and discrete fourier transform-spread-orthogonal frequency division multiplexing (DTF-s-OFDM) waveforms for uplink transmissions [1], i.e. for Physical Uplink Shared Channel (PUSCH) and Physical Uplink Control Channel (PUCCH). Both waveforms include a (Cyclic Prefix) CP appended to the front of each symbol. The CP is the last few samples of the OFDM symbol appended to the front of the symbol. The base station estimates the round-trip-time between the UE and the base station. For example, this can be initially estimated using the PRACH channel during random access. The base station signals a time advance (TA) command to advance the UE's uplink transmission time by a duration equivalent e.g., to the round-trip-delay such that an uplink transmission from the UE and n-TimingAdvanceOffset, e.g. PUSCH or PUCCH arrives aligned to the base station reference timing as shown in FIG. 20. Each of the users are synchronized to the same reference time; this retains orthogonality between users. With reference to FIG. 20, user 0 start time for symbol n, for example symbol n can correspond to symbol zero of a radio frame, is exactly aligned to the reference time of the base station. For user 1, the start time of symbol n is slightly delayed from the base station's reference time. For user 2, the start time of symbol n is delayed even more from the base station's reference time this can be for example due to a time alignment error. For user 3, the start time of symbol n is advanced by a large duration from the base station's reference time, this can for example due to a time alignment error.

The first stage of a NR baseband receiver is the removal of the CP followed by a Fast Fourier Transform (FFT) operator that converts the OFDM symbol from time domain to frequency domain. With reference to FIG. 20, an example of the FFT window is shown. In this example the FFT window of symbol n starts CP/2 after the base station's reference time, where CP is the duration of the cyclic prefix, the duration of the FFT window is large enough to include the samples required for FFT operation. Note that in this example, as the FFT window is starting halfway through the CP rather than at the end of the CP, a time adjustment of CP/2 can be done in frequency domain (after the FFT) to compensate the CP/2 offset. If the user's misalignment is within the CP range, i.e. in the range of [−CP/2, CP/2] for the example illustrated in FIG. 20, the signal of user i is cyclically delayed by τᵢ, as long as τᵢ is within the CP range. For example, user 1 is delayed by τ₁<CP/2, hence within the FFT window of symbol n, the samples belong to symbol n. There is no inter-symbol interference in this case. The delay τᵢ when within the CP range is converted into a phasor after the FFT and can be easily estimated and compensated. With reference to FIG. 20, if τᵢ is greater than the CP range, inter symbol interference can occur for users 2 and 3. For user 2, τ₂ exceeds CP/2, hence in the FFT window of symbol n, there are samples from symbol n−1 leading to inter-symbol interference and thus degrading performance. For user 3, τ₃ is less than-CP/2, hence in the FFT window of symbol n, there are samples from symbol n+1 leading to inter-symbol interference and thus degrading performance.

When a UE (e.g., the UE 116) is communicating with multiple TRPs, the distances between the UE and each TRP can be different. If the UE were to use a common UL transmission time for transmitting to the TRPs, the UE reception could be aligned to the receive reference time of one TRP, but misaligned (by more than a CP) to receive reference time of the other TRPs leading to inter-symbol interference and loss of orthogonality at the other TRPs. One way to avoid this issue is to allow for multiple UL transmit times from the UE wherein each transmit time corresponds to a TRP.

The TA of a second TRP can be determined based on measurement of differential DL propagation delay measurements at the UE of reference signals from a first TRP and the second TRP. The TA of the second TRP can be determined based through a random access procedure towards the second TRP. Additional details can be as described in U.S. patent application Ser. No. 18/177,744 filed on Mar. 2, 2023 (the '744 application), which is incorporated by reference in its entirety.

The UE can be signaled one or two TA values. The UE determines the UL transmission time towards each TA based on the one or two signaled TA values. The UE can determine the UL transmission timing to use based on the TCI state (e.g., a beam) of the UL transmission and an association with TAG ID or a TA position within the TAG. Additional details can be as described in U.S. patent application Ser. No. 18/177,753 filed on Mar. 2, 2023 (the '753 application), which is incorporated by reference in its entirety.

The unified (master or main or indicated) TCI state is TCI state of UE-dedicated reception on PDSCH/PDCCH and CSI-RS, wherein the TCI state provides a reference signal for the quasi co-location for DMRS of PDSCH and DMRS of PDCCH in a CC and CSI-RS when following the unified TCI state. The unified (master or main or indicated) TCI state is TCI state of UE-dedicated reception on dynamic-grant/configured-grant based PUSCH and PUCCH resources and SRS, wherein the TCI state provides UL TX spatial filter for dynamic-grant and configured-grant based PUSCH and PUCCH resource in a CC, and SRS when following the unified TCI state.

The unified TCI framework applies to intra-cell beam management, wherein the TCI states have a source RS that is directly or indirectly associated, through a quasi-co-location relation, e.g., spatial relation, with an SSB of a serving cell. The unified TCI state framework also applies to inter-cell beam management, wherein a TCI state can have a source RS that is directly or indirectly associated, through a quasi-co-location relation, e.g., spatial relation, with an SSB of cell that has a PCI different from the PCI of the serving cell.

Quasi-co-location (QCL) relation, can be quasi-location with respect to one or more of the following relations [38.214 [REF4]—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

A UL or joint TCI state can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main) TCI can also apply to other DL and/or UL channels and/or signals e.g. non-UE dedicated channel, CSI_RS and sounding reference signal (SRS).

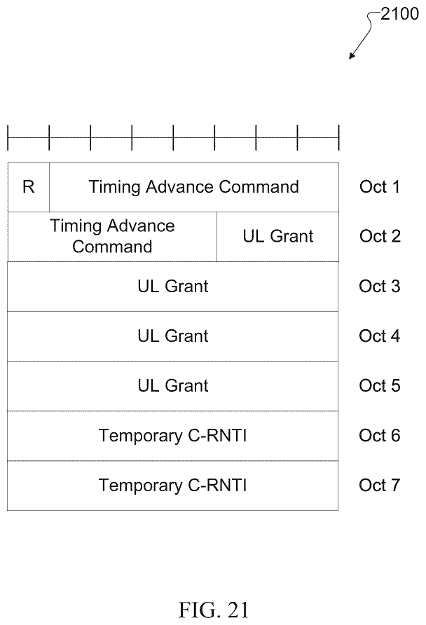

FIG. 21 illustrates a diagram of an example MAC RAR 2100 for Type 1 random access procedure according to embodiments of the present disclosure. For example, MAC RAR 2100 for Type 1 random access procedure can be received by any of the UEs 111-116 of FIG. 1, such as the UE 114. This example is for illustration only and other embodiments can be used without departing from the scope of the present disclosure.

In NR, the round trip time can be indicated by:
A random access response (RAR) of a Type 1 random access procedure or MSGB response of a Type 2 random access procedure, the value signaled is a 12-bit “Timing Advance Command” value in range 0 . . . 3846. The TA offset N_{TA} in units of T_{c} (wherein T_{c}=1/(Δfₘₐₓ·N_{f}), where Δfₘₐₓ=480 kHz and N_{f}=4096) is calculated as

$${N}_{TA} = \frac{{T}_{A} \cdot 16 \cdot 64}{{2}^{μ}}$$

wherein, μ is the sub-carrier spacing configuration.

With reference to FIG. 21, the MAC RAR (for Type 1 random access procedure) includes the 12-bit Timing Advance command (38.321 [REF5] FIG. 6.2.3-1).

With reference to FIG. 21, the fallback RAR (for Type 2 random access procedure), which is used when MSGA PRACH is successfully received but MSGA PUSCH is not decoded correctly, includes the 12-bit Timing Advance command (38.321 [REF5] FIG. 6.2.3a-1).

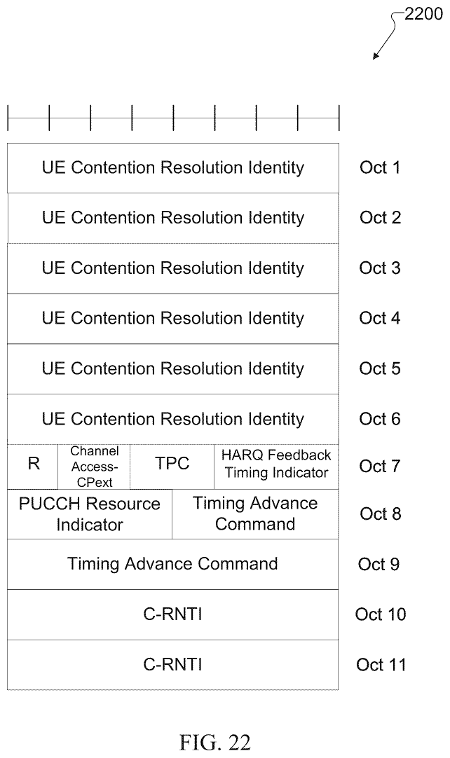

FIG. 22 illustrates a diagram of an example MAC RAR 2200 for Type 2 random access procedure according to embodiments of the present disclosure. For example, MAC RAR 2200 for Type 2 random access procedure can be received by any of the UEs 111-116 of FIG. 1, such as the UE 115. This example is for illustration only and other embodiments can be used without departing from the scope of the present disclosure.

With reference to FIG. 22, the success RAR (for Type 2 random access procedure), which is used when MSGA PRACH is successfully received and MSGA PUSCH is decoded correctly, includes the 12-bit Timing Advance command. (38.321 [REF5] FIG. 6.2.3a-2).

The timing advance command can also be indicated by a timing advance MAC (clause 6.1.3.4 of TS 38.321 [REF5]), wherein the change in value of N_{TA} can be indicated by a “Timing Advance Command” in the MAC CE. For example, the Timing Advance MAC CE indicates a TA “Timing Advance Command” value in the range of 0, 1, . . . , 63 (e.g., a 6-bit value). The updated (new) N_{TA} value relative to the previous (old) N_{TA} value in units of T_{c} (wherein T_{c}=1/(Δfₘₐₓ. N_{f}), where Δfₘₐₓ=480 kHz and N_{f}=4096) is given by:

$${N}_{TA , new} = {N}_{TA , old} + \frac{( {T}_{A} - 31 ) \cdot 16 \cdot 64}{{2}^{μ}}$$

wherein, μ is the sub-carrier spacing configuration.

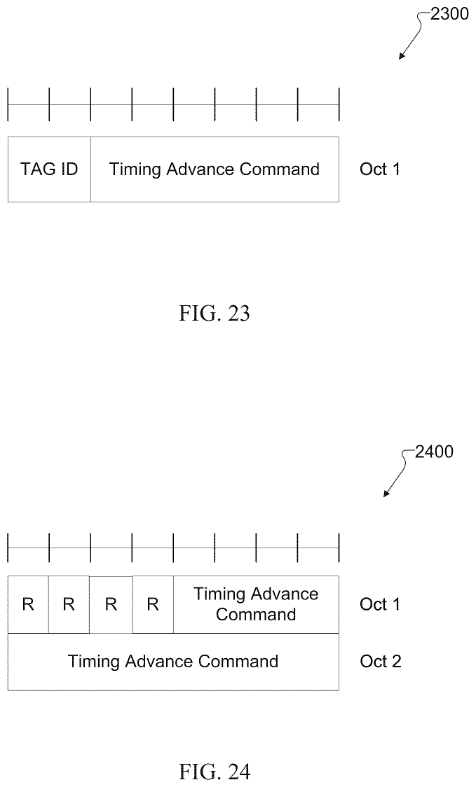

FIG. 23 illustrates a diagram of an example timing advance command MAC CE 2300 according to embodiments of the present disclosure. For example, timing advance command MAC CE 2300 can be adhered to by any of the UEs 111-116 of FIG. 1, such as the UE 116 of FIG. 3. This example is for illustration only and other embodiments can be used without departing from the scope of the present disclosure.

With reference to FIG. 23, the Timing Advance Command MAC CE includes the 6-bit Timing Advance Command (38.321 [REF5] FIG. 6.1.3.4-1). Also included is the associated TAG-ID. The absolute timing advance can also be indicated by an absolute timing advance MAC (clause 6.1.3.4a of TS 38.321 [REF5]), wherein the value signaled is a 12-bit “Timing Advance Command” (TA). The TA offset N_{TA} in units of T_{c} (wherein T_{c}=1/(Δfₘₐₓ. N_{f}), where Δfₘₐₓ=480 kHz and N_{f}=4096) is calculated as

$${N}_{TA} = \frac{{T}_{A} \cdot 16 \cdot 64}{{2}^{μ}}$$

wherein, μ is the sub-carrier spacing configuration.

FIG. 24 illustrates a diagram of example absolute timing advance command MAC CE 2400 according to embodiments of the present disclosure. For example, absolute timing advance command MAC CE 2400 can be adhered to by any of the UEs 111-116 of FIG. 1, such as the UE 116 of FIG. 3. This example is for illustration only and other embodiments can be used without departing from the scope of the present disclosure.

With reference to FIG. 24, the Absolute Timing Advance Command MAC CE includes the 12-bit Timing Advance Command (38.321 [REF5] FIG. 6.1.3.4a-1). Also included is the associated TAG-ID.

NR supports four different sequence length for random access preamble sequence:
Sequence length 839 used with sub-carrier spacings 1.25 kHz and 5 kHz with unrestricted or restricted sets.
Sequence length 139 used with sub-carrier spacings 15 kHz, 30 kHz, 60 kHz, and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in PRACH Occasions (ROs). Each RO determines the time and frequency resources in which a preamble is transmitted, the resources allocated to an RO in the frequency domain (e.g., number of PRBs) and the resource allocated to an RO in the time domain (e.g., number of OFDMA symbols or number of slots), depending on the preamble sequence length, sub-carrier spacing of the preamble, sub-carrier spacing of the PUSCH in the UL bandwidth part (BWP), and the preamble format. Multiple PRACH Occasions can be FDMed in one time instance. This is provided by higher layer parameter msg1-FDM. The time instances of the PRACH Occasions is determined by the higher layer parameter prach-ConfigurationIndex, and Tables 6.3.3.2-2, 6.3.3.2-3, and 6.3.3.2-4 of TS 38.211 [REF1].

SSBs are associated with ROs. The number of SSBs associated with one RO can be provided by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB. SS/PBCH block indexes provided by ssb-PositionsInBurst in SIB1 or in ServingCellConfigCommon are mapped to valid PRACH occasions in the following order [38.213] [REF3]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

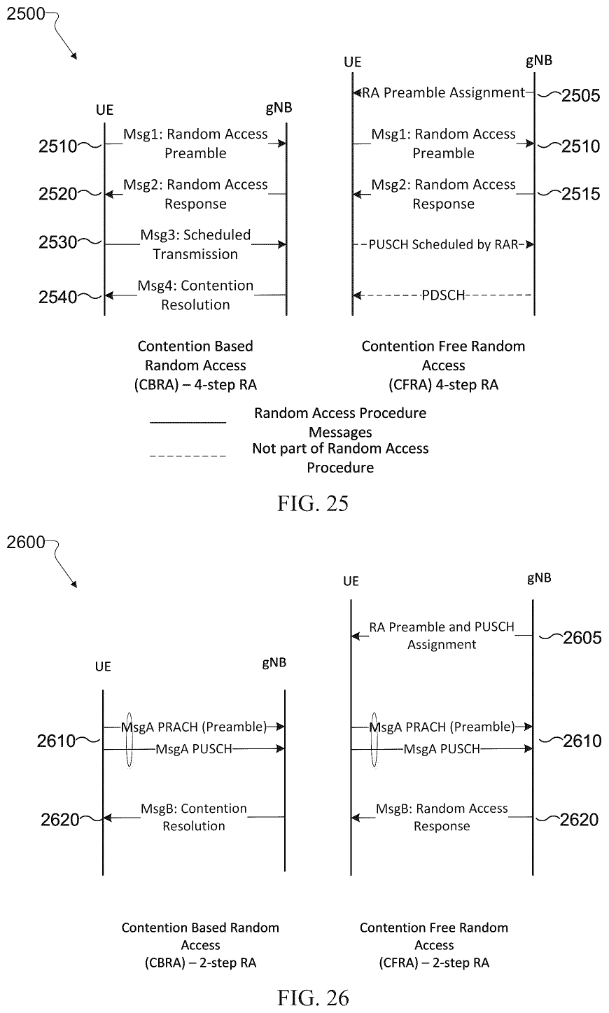

FIG. 25 illustrates flow diagrams 2500 of example 2-step random access procedures according to embodiments of the present disclosure. For example, flow diagrams 2500 of example 2-step random access procedures can be followed by any of the UEs 111-116 of FIG. 1, such as the UE 116 of FIG. 3 and a BS, such as BS 103. This example is for illustration only and other embodiments can be used without departing from the scope of the present disclosure.

A random access procedure can be initiated by a PDCCH order, by the MAC entity, or by RRC.

There are two types of random access procedures, type-1 random access procedure and type-2 random access procedure.

Type-1 random access procedure, also known as four-step random access procedure (4-step RACH), is as illustrated in FIG. 25:
In 2510, the UE transmits a random access preamble, also known as Msg1, to the gNB. The gNB (e.g., the gNB 102) attempts to receive and detect the preamble.
In 2520, the gNB upon receiving the preamble transmits a random access response (RAR), also known as Msg2, to the UE including, among other fields, a time adjustment (TA) command and an uplink grant for a subsequent PUSCH transmission.
In 2530, the UE after receiving the RAR, transmits a PUSCH transmission scheduled by the grant of the RAR, and time adjusted according to the TA received in the RAR. Msg3 or the PUSCH scheduled by the RAR UL grant can include the RRC reconfiguration complete message.
In 2540, the gNB upon receiving the RRC reconfiguration complete message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in 2505, the gNB indicates to the UE the preamble to use.

FIG. 26 illustrates flow diagrams 2600 of example 2-step random access procedures according to embodiments of the present disclosure. For example, flow diagrams 2600 of example 2-step random access procedures can be followed by any of the UEs 111-116 of FIG. 1, such as the UE 113 and a BS, such as BS 102. This example is for illustration only and other embodiments can be used without departing from the scope of the present disclosure.

With reference to FIG. 26, Release 16 introduced a new random access procedure, Type-2 random access procedure, also known as 2-step random access procedure (2-step RACH) that, in 2610, combines the preamble and PUSCH transmission into a single transmission from the UE to the gNB, which is known as MsgA. Similarly, in 2620, the RAR and the PDSCH transmission (e.g. Msg4) are combined into a single downlink transmission from the gNB to the UE, which is known as MsgB.

Type-2 random access procedure can be contention based random access (CBRA) or contention free random access (CFRA). For CFRA, in 2605, the gNB indicates to the UE the preamble and PUSCH to use.

A random access procedure can be triggered by a PDCCH order. The PDCCH order is triggered by DCI Format 1_0 with CRC scrambled by C-RNTI and the “Frequency domain resource assignment” field is set to ones. The fields of DCI format 1_0 carrying the PDCCH order are interrupted as follows in TABLE 1:

TABLE 1

| Field | Size | Description |
|---|---|---|
| Identifier for DCI formats | 1 | The value of this bit field is set to 1, |
| | | indicating a DL DCI format |
| Frequency domain resource | ┌log₂ (N_{RB}^{DL, BWP} | Set to ones |
| assignment | (N_{RB}^{DL, BWP} + 1)/2)┐ | |
| Random Access Preamble | 6 bits | |
| index | | |
| UL/ supplementary uplink | 1 bit | |
| (SUL) indicator | | |
| SS/PBCH index | 6 bits | If“Random Access Preamble index” |
| | | is not zero indicates SSB index of |
| | | RO used, else this field is reserved |
| PRACH Mask index | 4 bits | If“Random Access Preamble index” |
| | | is not zero indicates RO used, else |
| | | this field is reserved |
| Reserved bits | 12 bits or 10 bits | |

If “Random Access Preamble index” is not zero, the PDCCH order triggers a contention free random access preamble, wherein the PRACH Occasion is determined based on the “SS/PBCH index” indicated in the PDCCH order and the “PRACH Mask index” indicated in the PRACH Occasion associated with the SS/PBCH indicated by “SS/PBCH index”. The “Random Access Preamble index” indicates the preamble index to use in the PRACH Occasion.

If a PRACH transmission from a UE is in response to a detection of a PDCCH order by the UE that triggers a contention-free random access procedure, the preamble can be transmitted based on the SSB that the DL RS that the DMRS of the PDCCH order is quasi-collocated with.

If the UE attempts to detect the DCI format 1_0 with CRC scrambled by the corresponding RA-RNTI in response to a PRACH transmission initiated by a PDCCH order that triggers a contention-free random access procedure for the SpCell [TS 38.321] [REF5], the UE may expect that the PDCCH that includes the DCI format 1_0 and the PDCCH order have same DMRS antenna port quasi co-location properties. When receiving a PDSCH scheduled with RA-RNTI in response to a random access procedure triggered by a PDCCH order which triggers contention-free random access procedure for the SpCell [TS 38.321] [REF5], the UE may expect that the DMRS port of the received PDCCH order and the DMRS ports of the corresponding PDSCH scheduled with RA-RNTI are quasi co-located with the same SS/PBCH block or CSI-RS with respect to Doppler shift, Doppler spread, average delay, delay spread, spatial RX parameters when applicable.

If the UE attempts to detect the DCI format 1_0 with CRC scrambled by the corresponding RA-RNTI in response to a PRACH transmission initiated by a PDCCH order that triggers a contention-free random access procedure for a secondary cell, the UE may expect the DMRS antenna port quasi co-location properties of the CORESET associated with the Type1-PDCCH CSS set for receiving the PDCCH that includes the DCI format 1_0.

If “Random Access Preamble index” is zero, the PDCCH order triggers a contention based random access procedure. If a PRACH transmission from a UE is in response to a detection of a PDCCH order by the UE that triggers a contention-based random access procedure, the UE can determine a SSB for the preamble transmission and select a preamble in a PRACH occasion corresponding to the SSB. If the UE attempts to detect the DCI format 1_0 with CRC scrambled by the corresponding RA-RNTI in response to a PRACH transmission initiated by a PDCCH order that triggers a contention-free random access procedure, the UE may expect same DMRS antenna port quasi co-location properties for PDCCH and PDSCH, as for a SS/PBCH block or a CSI-RS resource the UE used for PRACH association.

Embodiments of the present disclosure provide schemes to determine multiple TAs (e.g., 2 TAs) using a random access procedure for inter-cell and intra-cell multi-TRP scenario. The random access procedure can be a contention-free random access (CFRA) procedure triggered by a PDCCH order.

Embodiments of the present disclosure provide aspects related to determination of the power of the PRACH when the PDCCH order triggers a transmission of a preamble to a TRP different from the TRP that transmitted the PDCCH order.

A UE may be communicating with the network (e.g., the network 130) through two or more spatial relation filters for transmission and receptions, which in this disclosure are referred to as beams. The beams are determined by a TCI state, e.g., a joint TCI state for UL and DL beams, or a DL TCI state for DL beams or a UL TCI state UL beams. The beams can be associated with a single TRP. Alternatively, the beams can be associated with multiple (two or more) TRPs, wherein the TRPs can have a same physical cell identity (PCI) (i.e., transmitting SSBs associated with the same PCI), or can have different PCIs (i.e., transmitting SSBs associated with different PCIs). The round trip propagation delay, or round trip propagation time (RTT) on each beam can be different. For example, this can be due to different propagation paths due to different reflections and/or due to different distances between the UE and the TRPs. As described herein, the UL signal from the UE should arrive at each TRP as its reference time, as a result the transmission on each beam (e.g., to a corresponding TRP) would have a different transmission time and, hence, a different TA value to arrive at the corresponding TRP at that TRP's reference time. In this disclosure various embodiments provide schemes to determine multiple TAs (e.g. 2 TAs) using a random access procedure for inter-cell and intra multi-TRP scenario. The random access procedure can be a contention-free random access (CFRA) procedure triggered by a PDCCH order.

Various embodiments provide aspects related to determination of the power of the PRACH when the PDCCH order triggers a transmission of a preamble to a TRP different from the TRP that transmitted the PDCCH order. The power is determined based a pathloss reference signal (PL-RS) used to measure the PL between the TRP and the UE. In this disclosure, various embodiments look into how the PL-RS is determined. Various embodiments also look into aspects related determining the cell of a TAG-ID.

The present disclosure relates to a 5G/NR communication system.

This disclosure provides design aspects related to using random access procedure to determine multiple TAs (e.g., 2 TAs), wherein the random access procedure can be triggered by a PDCCH order or by higher layers (e.g., triggered by UE), the random access procedure can be contention-free random access (CFRA) procedure, The following aspects are provided:
Quasi-co-location information (e.g., TCI state) for the PDCCH demodulation reference signal (DMRS) of the PDCCH order.
Resource used for preamble transmission.
Spatial relation and/or power of preamble transmission
Quasi-co-location information (e.g., TCI state) for the PDCCH DMRS of RAR
Search space set for RAR.

Various embodiments also provide for aspects related determining the cell of a TAG-ID.

In this disclosure, RRC signaling (e.g., configuration by RRC signaling) includes the following: common RRC signaling, e.g., this can be system information block (SIB)-based RRC signaling (e.g., SIB1 or other SIB) or RRC dedicated signaling that is sent to a specific UE.

In the examples of this disclosure, a UE can communicate with the network using different beams for example associated with TRPs. The different beams can be used at different times (e.g., switching from one beam to another beam) or can be used simultaneously (e.g., simultaneously receiving from network on multiple beams or simultaneously transmitting to the network on multiple beams). In the former example, two or more TA can be active in the UE, but only one TA is used at a time depending on the beam used for UL transmission. In the latter, two or more TAs can be active in the UE. More than one TA are simultaneously used when the UE transmits on multiple UL beams simultaneously.

In one example, the UE communicates to the same TRP on two or more different beams. The different beams have different round trip delays. For example, the different round trip delays can be due to different reflections.

In another example, the UE communicates with two or more different TRPs with same physical cell identity (PCI). The UE uses at least one beam to communicate with each TRP. The round delay to each TRP can be different. The TRPs can be synchronized or unsynchronized. This is an example of intra-cell multi-TA (e.g., 2 TA in case of 2 TRPs).

In another example, the UE communicates with two or more different TRPs with same or different physical cell identity (PCI). The UE uses at least one beam to communicate with each TRP. The round delay to each TRP can be different. The TRPs can be synchronized or unsynchronized. When at least one of the TRPs has a different PCI from the other TRP(s), this is an example of inter-cell multi-TA (e.g., 2 TA in case of 2 TRPs).

In one example, a first TRP is associated with a first coresetpoolIndex (e.g., coresetpoolIndex 0). A second TRP is associated with a second coresetpoolIndex (e.g., coresetpoolIndex 1).

In one example, a first TRP is associated with a first groups of SSBs. A second TRP is associated with a second group of SSBs.

In one example, a first TRP is associated a PCI of serving cell (or associated with a serving cell). A second TRP is associated with a PCI different from the PCI of the serving cell (or associated with a cell different from the serving cell). This is for example, inter-cell multi-TRP operation.

In one example, a first TRP is associated a PCI of a first cell (or associated with a first cell). A second TRP is associated with a PCI of a second cell (or associated with a second cell). This is for example, inter-cell multi-TRP operation.

In one example, a first TRP and the second TRP are associated with a serving cell. This is for example, intra-cell multi-TRP operation.

In one example, a first TRP and the second TRP are associated with a cell. This is for example, intra-cell multi-TRP operation.

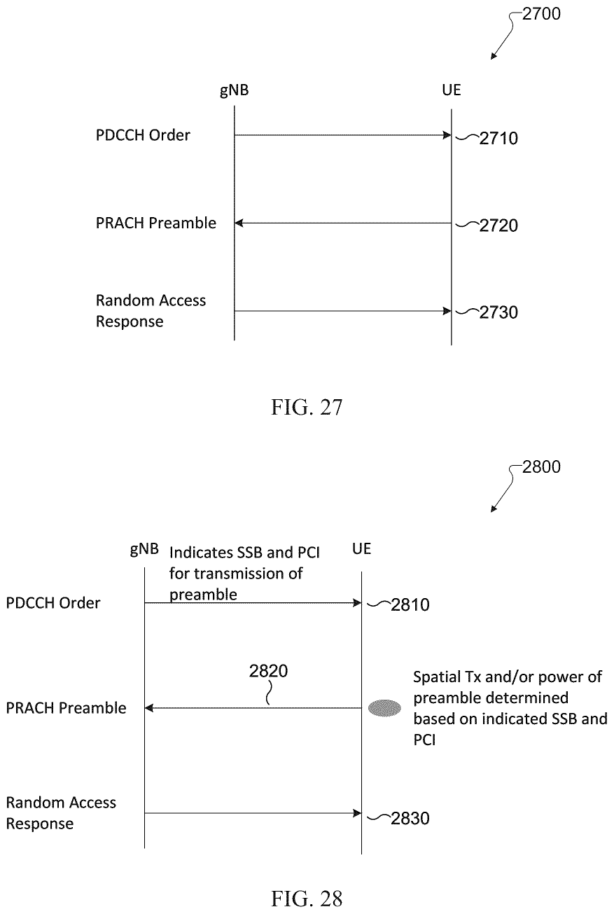

FIG. 27 illustrates a procedure 2700 for an example RAR according to embodiments of the present disclosure. For example, procedure 2700 can be followed by any of the UEs 111-116 of FIG. 1, such as the UE 116 of FIG. 3, and a BS, such as BS 103. This example is for illustration only and other embodiments can be used without departing from the scope of the present disclosure.

The procedure begins in 2710, a gNB transmits a PDCCH order to a UE. In 2720, the UE transmits a PRACH preamble to the gNB. In 2730, the gNB transmits a RAR to the UE.

In one example, a PDCCH order triggers a contention-free random access procedure for an inter-cell or intra-cell multi-TRP scenario to determine a TA.

With reference to FIG. 27, an example of a PDCCH order triggered CFRA procedure is shown. The following aspects are provided:
The TRP, beam and/or quasi-co-location properties used to transmit the PDCCH order.
The resource for the preamble transmission, wherein the resource includes the PRACH Occasion and the preamble index.
The spatial filter and/or transmit power used to transmit the preamble.
The quasi-co-location for the random access response.

In one example, the PDCCH order is transmitted from a TRP associated with the serving cell, e.g., the TCI state of the PDCCH order includes one or more source RS (e.g., of QCL TypeD and/or QCL TypeA) and the one or more source RS are associated (e.g., through QCL relation) with an SSB of the serving cell. In this example, the PDCCH order (transmitted from a TRP of the serving cell) triggers a preamble that is transmitted to a TRP of the serving cell or a TRP of a non-serving cell). The PDCCH order can trigger a preamble transmitted to a different TRP than that of the PDCCH order, e.g., the spatial filter and/or transmit power of the preamble can be based on an SSB of cell (or TRP) different from the cell (or TRP) of the PDCCH order. In one example, the PDCCH order includes a PCI of a cell on which the triggered RACH procedure is associated with, i.e., to which the preamble is transmitted to, the spatial transmit filter and/or power of the transmitted preamble is based on an SSB associated with the cell. The PCI of the cell can be (1) that of the serving cell (for example when the PCI index in the PDCCH order is 0), or (2) an additionalPCIIndex of another cell (e.g., based on the value of additionalPCIIndex-r17 of an SSB-MTC-AdditionalPCI-r17). In one example, the PCI field has a size of N-bits, wherein N=┌log₂ (maxNrofAdditionalPCI+1)┐. In one example, maxNrofAdditionalPCI=7, and N=3 bits. In one example, if the PCI field is 0, this indicates a serving cell, else the PCI indicates the additional PCI index of a non-serving cell. In another example, the PDCCH order includes a flag, that indicates whether the preamble is triggered for the serving cell, or another cell (e.g., one of the cells corresponding to additionalPCIIndex). In one example, a flag can indicate whether the PRACH is the same TRP as the PDCCH or to a different TRP as described in this disclosure.

In one example, the SSB used to determine the transmit power of the preamble is configured or activated or indicated as a PL-RS before the transmission of the PDCCH order. In one example, the SSB is known to UE (e.g., the UE 116) at the time of triggering of the PDCCH order. In one example, the time between the configuration or activation or indication of the SSB as PL-RS and the time of the PDCCH is T. In one example, T is measured from the channel (start or end) conveying the configuration or activation or indication of the SSB as PL-RS. In a further example, the channel is positively acknowledged. In one example, T is measured from the channel (start or end) conveying a hybrid automatic repeat request acknowledgement (HARQ-ACK) to the channel conveying the configuration or activation or indication of the SSB as PL-RS. In a further example, the HARQ-ACK is a positive acknowledgement (ACK). In a further example, the HARQ-ACK is a positive acknowledgement (ACK) or a negative acknowledgement (NACK).

In one example, e.g., T is measured from channel conveying HARQ-ACK:

$$T = 3 {N}_{slot}^{subframe , μ} + NM * ⌈ \frac{5 * {T}_{target \_ PL - RS} + 2 ms}{NR slot length} ⌉$$

In one example, e.g., T is measured from channel conveying configuration, activation, or indication of SSB as PL-RS:

$$T = {T}_{HARQ} + 3 {N}_{slot}^{subframe , μ} + NM * ⌈ \frac{5 * {T}_{target \_ PL - RS} + 2 ms}{NR slot length} ⌉$$

wherein, Nₛₗₒₜ^{subframe,μ} is the number of slots per subframe for sub-carrier spacing u. If SSB configured as PL-RS is not maintained by UE, NM=1, else NM=0.

In one example, a SSB configured as PL-RS is regarded as not being maintained. In one example, a SSB configured as PL-RS is regarded as being maintained.

T_{target_PL-RS} is the periodicity of the SSB configured as PL-RS.

T_{HARQ} is HARQ latency between sending a channel and getting the HARQ-ACK feedback.

In one example, the SSB being configured or activated or indicated as PL-RS is known at the time of configuration or activation or indication.

In one example, the SSB being configured or activated or indicated as PL-RS is not known at the time of configuration or activation or indication. An additional delay, T₁, is added to T for the SSB to be known. Where, T₁ includes additional Rx time for beam refinement as describe in TS 38.133.

As described in TS 38.133: The pathloss reference signal (e.g., SSB) is known if the following conditions are met during the period between the last transmission of the RS resource used for layer1 reference signal received power (L1-RSRP) measurement reporting and the completion of pathloss reference signal switch, where the RS resource is the target pathloss reference signal or QCLed (with Type D) to the target pathloss reference signal.
Pathloss reference signal switch command is received within 1280 ms upon the last transmission of the RS resource for beam reporting or measurement.
The UE has sent at least 1 L1-RSRP report for the target pathloss reference signal before the pathloss reference signal switch command.
The target pathloss reference signal remains detectable during the pathloss reference signal switching period.
   Signal-to-noise ratio (SNR) of the target pathloss reference signal≥−3 dB.
The associated SSBs with the target pathloss reference signal remain detectable during the pathloss reference signal switching period.
   SNR of the associated SSB≥−3 dB.
Otherwise, the pathloss reference signal is unknown.

In one example, when the UE measures an SSB (e.g., of a serving cell, or of a cell having a PCI different from the PCI of the serving), the UE can determine a pathloss associated with the SSB. The UE can transmit a PRACH preamble associated with the SSB using a transmit power determined based on the pathloss associated with the SSB.

In one example, when the UE measures an SSB (e.g., of a serving cell, or of a cell having a PCI different from the PCI of the serving), the UE can determine a pathloss associated with the SSB. The UE can transmit a PRACH preamble associated with the SSB using a transmit power determined based on the pathloss associated with the SSB. The cell with the PCI associated with the SSB can have no activated TCI states (e.g., inactive PCI or additional PCI).

In one example, when the UE measures an SSB (e.g., of a serving cell, or of a cell having a PCI different from the PCI of the serving), the UE can determine a pathloss associated with the SSB. The UE can transmit a PRACH preamble associated with the SSB using a transmit power determined based on the pathloss associated with the SSB. The cell with the PCI associated with the SSB has activated TCI states (e.g., active PCI or additional PCI).

In one example, when the UE measures an SSB (e.g., of a serving cell, or of a cell having a PCI different from the PCI of the serving), the UE can determine a pathloss associated with the SSB. The UE can transmit a PRACH preamble associated with the SSB using a transmit power determined based on the pathloss associated with the SSB. The SSB is associated with activated TCI states (e.g., the TCI state has a source RS that is directly or indirectly associated (e.g., QCLed) with the SSB).

In one example, a UE capability can determine whether the SSB used for the pathloss measurement is associated with a cell that is one of:
The cell has active TCI states (e.g., active PCI or additional PCI).
The cell can have no active TCI states.

In one example, if a UE can determine the pathloss from an SSB associated with a cell having a PCI, e.g., provided by additionalPCIIndex, and the cell has no active TCI state or TCI state codepoints, e.g., the additionalPCIIndex is inactive, then PRACH can be triggered to a cell with an inactive additionalPCIIndex. Else, if the UE can't determine the pathloss from an SSB associated with a cell having a PCI, e.g., provided by additionalPCIIndex, and the cell has no active TCI state or TCI state codepoints, e.g., the additionalPCIIndex is in inactive, then PRACH is triggered to a cell with an active additionalPCIIndex (e.g., with active TCI states or TCI state codepoints). In one example, this can be based on a UE capability.

In the following examples, an SSB is associated with a TCI state if one or more of the following occurs:
SSB is a source RS for QCL relation or spatial relation of the TCI state.
SSB is a PL-RS (pathloss RS) of the TCI state.
SSB is a QCL source or spatial relation source of a source RS for QCL relation or spatial relation of the TCI state.
SSB is a QCL source or spatial relation source of a PL-RS of the TCI state.
SSB is a PL-RS of a source RS for QCL relation or spatial relation of the TCI state.
SSB is a PL-RS of a PL-RS of the TCI state.

The SSB can a QCL source or spatial relation source through multiple (e.g., chain) of TCI states or quasi-co-location relations. For example, a TCI state has a PL-RS. In one example, CSI-RS1 is the PL-RS, CSI-RS1 has SSB as its source RS. In another example, CSI-RS1 is the PL-RS, CSI-RS1 has CSI-RS2 has its source RS, and CSI-RS2 has SSB as its source RS. In another example, CSI-RS1 is the PL-RS, CSI-RS1 has CSI-RS2 has its source RS, CSI-RS2 has CSI-RS3 has its source RS and CSI-RS3 has SSB as its source RS, and so on. These are examples of a TCI state (or PL-RS) associated with the SSB.

In the following example, the TCI state can be an uplink TCI state in case of separate beam indication or a joint TCI state in case of joint beam indication.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with activated TCI states (e.g., TCI states activated by MAC CE). The association can be as described herein. In one example, PL-RS is the indicated SSB in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with activated TCI states (e.g., TCI states activated by MAC CE). The association can be as described herein. In one example, PL-RS is an SSB associated with an activated TCI state that has the same TAG ID as an activated TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with activated TCI states (e.g., TCI states activated by MAC CE). The association can be as described herein. In one example, PL-RS is an SSB associated with an indicated TCI state that has the same TAG ID as an activated TCI state that is associated with the SSB indicated in the PDCCH order. An indicated TCI state can be a TCI state that is being applied by the UE for transmission of uplink channels and/or reception of DL channels. An indicated TCI state can be a TCI state that has been signaled to the UE by a DCI format using a codepoint in the ‘transmission configuration indicator’ field of the DCI.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with activated TCI states (e.g., TCI states activated by MAC CE). The association can be as described herein. In one example, PL-RS is an SSB associated with the first activated TCI state in the list of activated TCI states by MAC CE that has the same TAG ID as an activated TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with a configured TCI states (e.g., TCI states configured by RRC). The association can be as described herein. In one example, PL-RS is the indicated SSB in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with a configured TCI states (e.g., TCI states configured by RRC). The association can be as described herein. In one example, PL-RS is an SSB associated with an activated TCI state that has the same TAG ID as a configured TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with a configured TCI states (e.g., TCI states configured by RRC). The association can be as described herein. In one example, PL-RS is an SSB associated with a configured TCI state that has the same TAG ID as a configured TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with a configured TCI states (e.g., TCI states configured by RRC). The association can be as described herein. In one example, PL-RS is an SSB associated with an indicated TCI state that has the same TAG ID as a configured TCI state that is associated with the SSB indicated in the PDCCH order. An indicated TCI state can be a TCI state that is being applied by the UE for transmission of uplink channels and/or reception of DL channels. An indicated TCI state can be a TCI state that has been signaled to the UE by a DCI format using a codepoint in the ‘transmission configuration indicator’ field of the DCI.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with a configured TCI states (e.g., TCI states configured by RRC). The association can be as described herein. In one example, PL-RS is an SSB associated with the first activated TCI state in the list of activated TCI states by MAC CE that has the same TAG ID as a configured TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with a configured TCI states (e.g., TCI states configured by RRC). The association can be as described herein. In one example, PL-RS is an SSB associated with the first configured TCI state in the list of configured TCI states by RRC that has the same TAG ID as a configured TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, PL-RS is the indicated SSB in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, PL-RS is an SSB associated with an activated TCI state that has the same TAG ID as a TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, PL-RS is an SSB associated with a configured TCI state that has the same TAG ID as a TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, PL-RS is an SSB associated with an indicated TCI state that has the same TAG ID as a TCI state that is associated with the SSB indicated in the PDCCH order. An indicated TCI state can be a TCI state that is being applied by the UE for transmission of uplink channels and/or reception of DL channels. An indicated TCI state can be a TCI state that has been signaled to the UE by a DCI format using a codepoint in the ‘transmission configuration indicator’ field of the DCI.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, PL-RS is an SSB associated with the first activated TCI state in the list of activated TCI states by MAC CE that has the same TAG ID as a TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, PL-RS is an SSB associated with the first configured TCI state in the list of configured TCI states by RRC that has the same TAG ID as a TCI state that is associated with the SSB indicated in the PDCCH order.

In one example, a PDCCH order is transmitted from a first TRP, and PRACH preamble is transmitted towards a second TRP. In one example, the first TRP and the second TRP are in a same cell (e.g., intra-cell). In one example, the first TRP is in first cell, and the second TRP is in a second cell (e.g., inter-cell). The PDCCH order includes an SSB index. In one example, the SSB index is associated with indicated TCI states. The association can be as described herein. In one example, PL-RS is the indicated SSB in the PDCCH order. An indicated TCI state can be a TCI state that is being applied by the UE for transmission of uplink channels and/or reception of DL channels. An indicated TCI state can be a TCI state that has been signaled to the UE by a DCI format using a codepoint in the ‘transmission configuration indicator’ field of the DCI.

In one example, a PDCCH order is transmitted from a first TRP, and PRACH preamble is transmitted towards a second TRP. The network (e.g., the network 130) can configure the UE whether to use the indicated SSB as a PL-RS for determining the PRACH power or to use an SSB following one of the examples described herein to determine the PRACH.

In one example, a PDCCH order is transmitted from a first TRP, and PRACH preamble is transmitted towards a second TRP. The network can configure the UE whether to use the indicated SSB as a PL-RS for determining the PRACH power or to use an SSB associated with an indicated TCI state that has the same TAG ID as a TCI state (e.g., activated TCI state or configured TCI state) that is associated with the SSB indicated in the PDCCH order.

In one example, a PDCCH order is transmitted from a first TRP, and PRACH preamble is transmitted towards a second TRP. The UE can indicate to the network (e.g., through a capability signaling) whether it has the capability to use the SSB indicated in the PDCCH order as a PL-RS or not (e.g., follow one of the examples described herein).

In one example, a PDCCH order is transmitted from a first TRP, and PRACH preamble is transmitted towards a second TRP. The UE can indicate to the network (e.g., through a capability signaling) whether it has the capability to use the SSB indicated in the PDCCH order as a PL-RS or to use an SSB associated with an indicated TCI state that has the same TAG ID as a TCI state (e.g., activated TCI state or configured TCI state) that is associated with the SSB indicated in the PDCCH order.

In one example, the PDCCH order is transmitted from a TRP associated with the serving cell or with a cell of a configured additionalPCIIndex, e.g., the TCI state of the PDCCH order includes one or more source RS (e.g., of QCL TypeD and/or QCL TypeA) and the one or more source RS are associated with (e.g., through QCL relation) an SSB of the serving cell or an SSB of a cell of a configured additionalPCIIndex. In this example, the following sub-examples are provided.

In one sub-example, the PDCCH order is transmitted from a TRP of one cell, and it triggers a preamble that can be transmitted to a TRP of another cell, e.g., the spatial filter and/or transmit power of the preamble can be based on an SSB of cell (or TRP) different from the cell (or TRP) of the PDCCH order. In one example, the PDCCH order includes a PCI of a cell on which the triggered RACH procedure is associated with, i.e., to which the preamble is transmitted to, the spatial transmit filter and/or power of the transmitted preamble is based on an SSB associated with the cell. The PCI of the cell can be (1) that of the serving cell (for example when the PCI index in the PDCCH order is 0), or (2) an additionalPCIIndex of another cell (e.g., based on the value of additionalPCIIndex-r17 of an SSB-MTC-AdditionalPCI-r17). In one example, the PCI field has a size of N-bits, wherein N= [log 2 (maxNrofAdditionalPCI+1)]. In one example, maxNrofAdditionalPCI=7, and N=3 bits. In one example, if the PCI field is 0, this indicates a serving cell. Else, the PCI indicates the additional PCI index of a non-serving cell. In another example, the PDCCH order includes a flag (or indicator) that indicates whether the preamble is triggered for the serving cell or another cell (e.g., one of the cells corresponding to additionalPCIIndex). For example, the other cell can be a cell with activated TCI states other than the serving cell.

In one sub-example, the PDCCH order is transmitted from a TRP of a cell, and it triggers a preamble transmitted to a TRP (for example the same TRP used for the PDCCH order) of the same cell, e.g., the spatial filter and/or transmit power of the preamble can be based on an SSB of the cell (or TRP) of the PDCCH order.

In one sub-example, if the PDCCH order is triggered from a TRP associated with the serving cell (e.g., the TCI state of the PDCCH order is QCLed with a source RS of the serving cell directly or indirectly), the PRACH preamble can be sent to the serving cell, or a non-serving cell as described herein. If the PDCCH order is triggered from a TRP associated with a cell having a PCI different from the PCI of the serving cell (e.g., the TCI state of the PDCCH order is QCLed with a source RS of the cell that has a PCI different from the PCI of the serving cell directly or indirectly), the PRACH preamble can be sent to the cell having a PCI different from the PCI of the serving cell.

In one sub-example, if the PDCCH order is triggered from a TRP associated with the serving cell (e.g., the TCI state of the PDCCH order is QCLed with a source RS of the serving cell directly or indirectly), the PRACH preamble can be sent to the serving cell, or a non-serving cell as described herein. If the PDCCH order is triggered from a TRP associated with a cell having a PCI different from the PCI of the serving cell (e.g., the TCI state of the PDCCH order is QCLed with a source RS of the cell that has a PCI different from the PCI of the serving cell directly or indirectly), the PRACH preamble can be sent to a cell having a PCI different from the PCI of the serving cell (e.g., to a non-serving cell).

In one example, the SSB used to determine the transmit power of the preamble is configured or activated or indicated as a PL-RS before the transmission of the PDCCH order, as described herein.

The resource used for the preamble is determined by a PRACH Occasion and a preamble index within the PRACH Occasion. The preamble index can be indicated by the PDCCH order. The PRACH Occasion is determined based on an SSB or a CSI-RS resource to which the preamble is associated with, through an association pattern as described. In Rel-15 the association pattern is defined for the SSBs of the serving cell only. However, in case of inter-cell multi-TRP, there are SSBs associated with the serving cell as well as SSBs associated with cells corresponding to the additionalPCIIndex. Hence, one example is to define a new PRACH configuration to cover serving cell SSBs as well as SSBs on cells corresponding to the additionalPCIIndex. In case of intra-cell multi-TRP, there are SSBs associated with a first TRP as well as SSBs associated with a second TRP.

In one example, the new PRACH configuration can be used for transmission of preambles associated with the serving cell and cells corresponding to the additionalPCIIndex.

In one example, the new PRACH configuration can be used for transmission of preambles associated with cells corresponding to the additionalPCIIndex. The PRACH configuration of NR release 15 can be used for transmission of preambles associated with the serving cell.

In one example, the new PRACH configuration can be used for transmission of preambles associated with cells corresponding to the additionalPCIIndex. A higher layer parameter (e.g., by RRC configuration and/or MAC CE configuration) can indicate whether the preambles associated with the serving cell are transmitted using (1) the new PRACH configuration or (2) the PRACH configuration of NR release 15.

In one example, the new PRACH configuration can be used for transmission of preambles associated with cells corresponding to the additionalPCIIndex. An indicator (e.g., a flag) in the PDCCH order can indicate whether the preambles associated with the serving cell are transmitted using (1) the new PRACH configuration or (2) the PRACH configuration of NR release 15.

In one example, a separate PRACH configuration is provided for each additionalPCIIndex. The PRACH configuration association with an additionalPCIIndex can be used for transmission of preambles associated with cells corresponding to the additionalPCIIndex. The PRACH configuration of NR release 15 can be used for transmission of preambles associated with the serving cell.

The following examples can be evaluated for the new PRACH configuration.
The association is based on PCI-SSB pairs, i.e., each PCI-SSB pair is associated with an RO.
The association is based on SSBs, where the SSBs is a super set of SSB-indices configured across cells as provided by ssb-PositionsInBurst. In one example, “all cells” includes serving cell and cells corresponding to additionalPCIIndex. In another example, “all cells” includes cells corresponding to additionalPCIIndex.

In one example, the SSBs for cells corresponding to the additionalPCIIndex are the configured additionalPCIIndex. There can be a maximum of 7 configured additionalPCIIndex determined by maxNrofAdditionalPCI-r17=7. In another example, the SSBs for cells corresponding to the additionalPCIIndex are cell(s) of additionalPCIIndex with active TCI states, wherein a cell is regarded to have an active TCI state if the source RS of the active TCI state is associated through a quasi-co-location with an SSB of the cell. Active TCI states are the TCI states activated by MAC CE as described in TS 38.321 [REF5] clause 5.18.23 and 6.1.3.47. In one example, active TCI states (or TCI state codepoints or active spatial relations) can be associated with serving cell and one other cell corresponding to additionalPCIIndex. In one example, active TCI states (or TCI state codepoints or active spatial relations) can be associated with serving cell and one or more other cell corresponding to additionalPCIIndex. Therefore, the following examples are provided for associated between PRACH Occasions and SSBs for the new RACH configuration.
The association is based on SSBs of serving cell and SSBs of cells corresponding to the configured additionalPCIIndex.
The association is based on SSBs of serving cell and SSBs of cells with MAC CE activated TCI states corresponding to the configured additionalPCIIndex(s).
The association is based on SSBs of cells corresponding to the configured additionalPCIIndex.
The association is based on SSBs of cells with MAC CE activated TCI states corresponding to the configured additionalPCIIndex(s).

In one example, a UE (e.g., the UE 116) is configured with a new PRACH configuration. For example, a new RACH-ConfigGeneric and/or RACH-ConfigDedicated e.g., to be used for inter-cell multi-TRP.

The UE is configured additional PCIs and SSBs associated with the additional PCIs. For example, the UE can be configured with CSI-SSB-ResourceSet that includes a list of additional PCI indices given by servingAdditionalPCIList.

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |
| ResourcePerSet)) OF SSB-Index, | |
| ..., | |
| [[ | |
| servingAdditionalPCIList-r17 | SEQUENCE (SIZE(1..maxNrofCSI-SSB- |

ResourcePerSet)) OF ServingAdditionalPCIIndex-r17 OPTIONAL -- Need R

]]
}

wherein, maxNrofCSI-SSB-ResourcePerSet is 64 and servingAdditionalPCIList indicates the physical cell IDs (PCI) of the SSBs in the csi-SSB-ResourceList. If present, the list has the same number of entries as csi-SSB-ResourceList. The first entry of the list indicates the value of the PCI for the first entry of csi-SSB-ResourceList, the second entry of this list indicates the value of the PCI for the second entry of csi-SSB-ResourceList, and so on. For each entry, the following applies:
If the value is zero, the PCI is the PCI of the serving cell in which this CSI-SSB-ResourceSet is defined.
otherwise, the value is additionalPCIIndex-r17 of an SSB-MTC-AdditionalPCI-r17 in the additionalPCIList-r17 in ServingCellConfig, and the PCI is the additionalPCI-r17 in this SSB-MTC-AdditionalPCI-r17.

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, ms80, ms160, |
| spare2, spare1 }, | |
| ssb-PositionsInBurst-r17 | CHOICE { |
| | shortBitmap BIT STRING (SIZE (4)), |
| | mediumBitmap BIT STRING (SIZE (8)), |
| | longBitmap BIT STRING (SIZE (64)) |
| }, | |
| ss-PBCH-BlockPower-r17 | INTEGER (−60..50) |
| } | |

wherein, AdditionalPCIIndex-r17::=INTEGER (1 . . . maxNrofAdditionalPCI-r17), maxNrofAdditionalPCI is 7, and ssb-PositionsInBurst indicates the time domain positions of the transmitted SS-blocks in a half frame with SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted.

For association of SSBs with ROs for the new PRACH configuration, the number of SSBs to be associated with ROs is given by the following examples.

In one example, the number of SSBs to be associated with ROs is obtained from CSI-SSB-ResourceSet, based on SSB indices in the list csi-SSB-ResourceList that are associated with an additional PCI as given by servingAdditionalPCIList, (i.e., SSBs associated with the serving cell (having a value of zero in the corresponding entry in servingAdditionalPCIList) are excluded). The association order of SSBs to ROs can be based on the order of SSBs in csi-SSB-ResourceList associated with an additional PCI. In a variant of this example, only SSBs of cells with MAC CE activated TCI states are evaluated.

In one example, the number of SSBs to be associated with ROs is the sum of the number of SSBs configured for each AdditionalPCIIndex obtained from the corresponding ssb-PositionsInBurst. Let, N_{Tx-Total}^{SSB} be the total number of SSBs to be associated with PRACH Occasions,

$${N}_{Tx - Total}^{SSB} = {\sum }_{Configured AdditionalPCIIndex} {N}_{Tx}^{SSB} ( AdditionalPCIIndex )$$

where, N_{Tx}^{SSB} (AdditionalPCIIndex) can be obtained from ssb-PositionsInBurst corresponding to SSB-MTC-AdditionalPCI. For example, the number bits in the bitmap with value equal to 1. The association order of SSBs to ROs can be based on:
First, the order of the SSBs in the corresponding ssb-PositionsInBurst bit map; and/or
The order of the configured AdditionalPCIIndex, for example, as provided in ServingCellConfig.

ServingCellConfig->mimoParam-r17->additionalPCI-ToAddModList-r17 SEQUENCE (SIZE(1 . . . maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with AdditionalPCIIndex 1 if configured, then the SSBs associated with AdditionalPCIIndex 2 if configured, etc. In a variant of this example, only SSBs of cells with MAC CE activated TCI states are evaluated.

In one example, the number of SSBs to be associated with ROs is obtained from CSI-SSB-ResourceSet, based on SSB indices in the list csi-SSB-ResourceList that are associated with the serving cell PCI, or an additional PCI as given by servingAdditionalPCIList. The association order of SSBs to ROs can be based on the order of SSBs in csi-SSB-ResourceList. In a variant of this example, only SSBs of cells with MAC CE activated TCI states are evaluated.

In one example, the number of SSBs to be associated with ROs is the sum of the number of SSBs configured for the serving cell, obtained from ssb-PositionsInBurst in SIB1 or in ServingCellConfigCommon, and for each AdditionalPCIIndex, obtained from the corresponding ssb-PositionsInBurst. Let, N_{Tx-Total}^{SSB} be the total number of SSBs to be associated with PRACH Occasions,

$${N}_{Tx - Total}^{SSB} = {\sum }_{Seving cell and Configured AdditionalPCIIndex} {N}_{Tx}^{SSB} ( Serving cell or AdditionalPCIIndex )$$

where, N_{Tx}^{SSB}(ServingCell) can be obtained from ssb-PositionsInBurst in SIB1 or in ServingCellConfigCommon. N_{Tx}^{SSB}(AdditionalPCIIndex) can be obtained from ssb-PositionsInBurst corresponding to SSB-MTC-AdditionalPCI. For example, the number bits in the bitmap with value equal to 1. The association order of SSBs to ROs can be based on:
First, the order of the SSBs in the corresponding ssb-PositionsInBurst bit map; and/or
Second, SSBs of serving cell followed by the order of the configured AdditionalPCIIndex, for example as provided in ServingCellConfig.

ServingCellConfig-> mimoParam-r17->additionalPCI-ToAddModList-r17 SEQUENCE
(SIZE(1..maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with the serving cell, then SSBs associated with AdditionalPCIIndex 1 if configured, then the SSBs associated with AdditionalPCIIndex 2 if configured, etc. In a variant of this example, only SSBs of cells with MAC CE activated TCI states are evaluated.

In one example, each AdditionalPCIIndex has an associated ssb-PositionsInBurst as provided by SSB-MTC-AdditionalPCI, the bit maps of ssb-PositionsInBurst for the cells corresponding to AdditionalPCIIndex are ORed together, i.e., creating a super set of the union of the SSBs used in the cells corresponding to AdditionalPCIIndex. N_{Tx-Total}^{SSB} can be obtained from the resulting super set (the result of the OR operation described herein). The association order of SSBs to ROs can be based on the order of the SSBs in the resulting super set of SSBs. In a variant of this example, only SSBs of cells with MAC CE activated TCI states are evaluated.

In one example, each AdditionalPCIIndex has an associated ssb-PositionsInBurst as provided by SSB-MTC-AdditionalPCI, the bit maps of (1) ssb-PositionsInBurst for the cells corresponding to AdditionalPCIIndex, as well the bit map of (2) ssb-PositionsInBurst of the serving cell included in SIB1 or in ServingCellConfigCommon are ORed together, i.e., creating a super set of the union of the SSBs used in the cells corresponding to AdditionalPCIIndex and the serving cell. N_{Tx-Total}^{SSB} can be obtained from the resulting super set (the result of the OR operation described herein). The association order of SSBs to ROs can be based on the order of the SSBs in the resulting super set of SSBs. In a variant of this example, only SSBs of cells with MAC CE activated TCI states are evaluated.

In one example, ssb-PositionsInBurst of the serving cell included in SIB1 or in ServingCellConfigCommon are provided for N_{Tx-Total}^{SSB}. The association order of SSBs to ROs can be based on the order of the SSBs in ssb-PositionsInBurst of the serving cell. For a RACH preamble triggered by a PDCCH order, the PDCCH provides the resource (i.e., preamble index and PRACH Occasion) to use for transmitting the preamble. The PRACH occasion can be based on the SSB of the serving cell. The SSB used to determine the spatial filter and/or power of the preamble can be determined based on additional indication in the PDCCH order or the SSB used for quasi-co-location properties of DMRS of the PDCCH order.

In one example, the SSB used to determine the transmit power of the preamble is configured or activated or indicated as a PL-RS before the transmission of the PDCCH order, as described herein.

In one example, there is no new PRACH configuration, the PRACH configuration of Rel-15 can be used for sending the PDCCH order trigger preamble transmitted to a serving cell or a cell associated with the additionalPCIIndex. For a RACH preamble triggered by a PDCCH order, the PDCCH provides the resource (i.e., preamble index and PRACH Occasion) to use for transmitting the preamble. The PRACH occasion can be based on the SSB of the serving cell. The SSB used to determine the spatial filter and/or power of the preamble can be determined based on additional indication in the PDCCH order or the SSB used for quasi-co-location properties of DMRS of the PDCCH order.

In one example, the SSB used to determine the transmit power of the preamble is configured or activated or indicated as a PL-RS before the transmission of the PDCCH order as described herein in this disclosure.

In one example, the PDCCH order includes at least (1) Random Access Preamble index, (2) SS/PBCH index, (3) PRACH Mask index, and (4) PCIIndex or PCI Flag, which can identify the PRACH preamble and the PRACH occasion to be used for the preamble transmission.

In one example, the PCIIndex can be:
With a value of zero, then the PCI is the PCI of the serving cell in which this CSI-SSB-ResourceSet is defined. In this example, a PCI determines the PRACH Occasion for the transmission of the preamble (e.g., as described in examples described herein).
With another value corresponding to the additionalPCIIndex-r17 of an SSB-MTC-AdditionalPCI-r17 in the additionalPCIList-r17 in ServingCellConfig, then the PCI is the additionalPCI-r17 in this SSB-MTC-AdditionalPCI-r17. In this example, a PCI determines the PRACH Occasion for the transmission of the preamble (e.g., as described in examples described herein).
The PCIIndex is not included in the PDCCH order, in which case the determined PRACH Occasion for the transmission of the preamble is agnostic of the PCIIndex (e.g., according to one or more examples described herein).

In another example, the PCIIndex can be:
With a value corresponding to the additionalPCIIndex-r17 of an SSB-MTC-AdditionalPCI-r17 in the additionalPCIList-r17 in ServingCellConfig, then the PCI is the additionalPCI-r17 in this SSB-MTC-AdditionalPCI-r17. In this example, a PCI determines the PRACH Occasion for the transmission of the preamble (e.g., as described in examples described herein). In one example, if the PCIIndex is 0, this corresponds to the cell that triggered by the PDCCH order. In one example, if the PCIIndex is 0, this corresponds to the serving cell.
The PCIIndex is not included in the PDCCH order, in which case the determined PRACH Occasion for the transmission of the preamble is agnostic of the PCIIndex (e.g., according to one or more examples described herein).

In one example, the PCI Flag can be:
With a value of zero, then the PCI is the PCI of the serving cell in which this CSI-SSB-ResourceSet is defined. This for example can correspond to a first TAG ID (e.g., TAG ID 0).
With a value of one, then the UE selects a PCI corresponding to the additionalPCIIndex-r17 of an SSB-MTC-AdditionalPCI-r17 in the additionalPCIList-r17 in ServingCellConfig. For example, the selection can be based on the cell with active TCI states (or TCI state codepoints or active spatial relations). In another example, the selection can be based RRC configuration and/or MAC CE signaling and/or L1 control signaling, e.g., the network can signal the UE the additionalPCIIndex corresponding to a PCI flag with value 1. This for example can correspond to a second TAG ID (e.g., TAG ID 1).

In one example, PCI Flag can be:
With a value of zero for a first RRC configured and/or MAC CE signaled and/or L1 control signaled additionalPCIIndex. This for example can correspond to a first TAG ID (e.g., TAG ID 0).
With a value of one for a second RRC configured and/or MAC CE signaled and/or L1 control signaled additionalPCIIndex. This for example can correspond to a second TAG ID (e.g., TAG ID 1).

In one example, if PCIflag is zero, or the PCIIndex is zero, the PDCCH order follows the common PDCCH order behavior as described in TABLE 1.

In one example, the PDCCH order has a PDCCH format as shown in TABLE 2.

TABLE 2

| Field | Size | Description |
|---|---|---|
| Identifier for | 1 | The value of this |
| DCI formats | | bit field is set to 1, |
| | | indicating a DL DCI format |
| Frequency domain | ┌log₂(N_{RB}^{DL, BWP} | Set to ones |
| resource assignment | (N_{RB}^{DL, BWP} + 1)/2)┐ | |
| Random Access | 6 bits | See description A |
| Preamble index | | |
| UL/SUL indicator | 1 bit | |
| SS/PBCH index | 6 bits | See description B |
| PRACH Mask index | 4 bits | See description C |
| PCI Flag | 1 bit | See description D |
| Reserved bits | 11 bits or 9 bits | |

In one example, the PDCCH order has a PDCCH format as shown in TABLE 3.

TABLE 3

| Field | Size | Description |
|---|---|---|
| Identifier for | 1 | The value of this |
| DCI formats | | bit field is set to 1, |
| | | indicating a DL DCI format |
| Frequency domain | ┌log₂(N_{RB}^{DL, BWP} | Set to ones |
| resource assignment | (N_{RB}^{DL, BWP} + 1)/2)┐ | |
| Random Access | 6 bits | See description A |
| Preamble index | | |
| UL/SUL indicator | 1 bit | |
| SS/PBCH index | 6 bits | See description B |
| PRACH Mask index | 4 bits | See description C |
| PCI Index | 3 bits | See description E |
| Reserved bits | 9 bits or 7 bits | |

For Description A, see the following examples.

In one example, if PCI Index or PCI Flag is zero:
If “Random Access Preamble index” is non-zero, this field indicates the preamble index to be transmitted for a CFRA-based PDCCH order.
If “Random Access Preamble index” is zero, this field indicates a CBRA-based PDCCH order.

In one example, if PCI Index or PCI Flag is non-zero:
If “Random Access Preamble index” is non-zero, this field indicates the preamble index to be transmitted for a CFRA-based PDCCH order.
If “Random Access Preamble index” is zero, this field indicates a CBRA-based PDCCH order.

In one example, if PCI Index or PCI Flag is non-zero:

Field “Random Access Preamble index” indicates the preamble index to be transmitted for a CFRA-based PDCCH order.

In one example, if PCI Index or PCI Flag is non-zero:
If “Random Access Preamble index” is non-zero, this field indicates the preamble index to be transmitted for a CFRA-based PDCCH order.
Field “Random Access Preamble index” having a value of zero is reserved or not supported.

For Description B, see the following examples.

In one example, if PCI Index or PCI Flag is zero:
If “Random Access Preamble index” is not zero, “SS/PBCH index” indicates SSB index used for RO association, else “SS/PBCH index” is reserved.

In one example, if PCI Index or PCI Flag is non-zero:
If “Random Access Preamble index” is not zero “SS/PBCH index” indicates SSB index used for RO association and to determine the preamble transmit power and preamble spatial filter, else “SS/PBCH index” is reserved.

In one example, if PCI Index or PCI Flag is non-zero:
“SS/PBCH index” indicates SSB index used for RO association and to determine the preamble transmit power and preamble spatial filter.

For Description C, see the following examples.

In one example, if PCI Index or PCI Flag is zero:
If “Random Access Preamble index” is not zero, “PRACH Mask index” indicates RO used, else “PRACH Mask index” is reserved.

In one example, if PCI Index or PCI Flag is non-zero:
If “Random Access Preamble index” is not zero “PRACH Mask index” indicates RO used, else “PRACH Mask index” is reserved.

In one example, if PCI Index or PCI Flag is non-zero:
“PRACH Mask index” indicates RO used.

For Description D, see the following examples.

In one example, if PCI flag is 0, the PRACH transmission is transmitted towards the same TRP that transmits the PDCCH order.

In one example, if PCI flag is 0, the PRACH transmission is transmitted towards the serving cell.

In one example, PDCCH order with a PCI flag with a value 0 is transmitted from the serving cell.

In one example, PDCCH order with a PCI flag with a value 0 can be transmitted from the serving cell or a non-serving cell (e.g., inter-cell PDCCH order).

In one example, the PCI flag can be a TAG ID flag.

In one example, the network (e.g., the network 130) can signal by RRC configuration and/or MAC CE signaling and/or L1 control signaling the additionalPCIIndex of a TRP corresponding to a PCI flag with value 1.

In one example, the network can signal by RRC configuration and/or MAC CE signaling and/or L1 control signaling a first additionalPCIIndex of a TRP corresponding to a PCI flag with value 0 and a second additionalPCIIndex of a TRP corresponding to a PCI flag with value 1.

In one example, a second TRP for a PCI flag with value 1, can be associated with a cell with active TCI states (or TCI state codepoints or active spatial relations).

In one example, if the PCI flag is 0, the typical behavior of TABLE 1 is followed.

For Description E, see the following examples.

In one example, if PCI index is 0, the PRACH transmission is transmitted towards the same TRP that transmits the PDCCH order.

In one example, if PCI Index is 0, the PRACH transmission is transmitted towards the serving cell.

In one example, PDCCH order with a PCI index with a value 0 is transmitted from the serving cell.

In one example, PDCCH order with a PCI index with a value 0 can be transmitted from the serving cell or a non-serving cell (e.g., inter-cell PDCCH order).

In one example, if the PDCCH order is from the serving cell:
If PCI index is 0, the PRACH transmission is transmitted towards the serving cell (e.g., following the typical behavior, where the SSB to determine the PRACH transmit power is that used for QCL of the PDCCH order, or the SSB to determine the PRACH transmit is that indicated in the PDCCH order).
If the PCI index is non-zero (e.g., indicating cell A), the PRACH transmission is transmitted towards cell A, (e.g., the SSB to determine the PRACH transmit power is that indicated in the PDCCH order for cell A).

In one example, if the PDCCH order is from a cell A having a PCI different from the PCI of the serving cell:
If PCI index is 0, the PRACH transmission is transmitted towards the serving cell (e.g., where the SSB to determine the PRACH transmit power is that used for QCL of the PDCCH order, or the SSB to determine the PRACH transmit is that indicated in the PDCCH order).
If the PCI index indicates cell A, then one of:
   The PRACH transmission is transmitted towards cell A, and the SSB to determine the PRACH transmit power is that indicated in the PDCCH order for cell A.
   The PRACH transmission is transmitted towards cell A, and the SSB to determine the PRACH transmit power is that used for QCL of the PDCCH order.
If the PCI index is non-zero and different from that of cell A, e.g., indicating cell B, The PRACH transmission is transmitted towards cell A, and the SSB to determine the PRACH transmit power is that indicated in the PDCCH order for cell B.

In one example, if the PDCCH order is from a cell A having a PCI different from the PCI of the serving cell:
PCI index is 0. The PRACH transmission is transmitted towards cell A. In one example, the SSB to determine the PRACH transmit power is that used for QCL of the PDCCH order (e.g., like typical PDCCH order). In one example, the SSB to determine the PRACH transmit power is that indicated in the PDCCH order for cell A.
In this example, a PDCCH order from a serving cell can trigger a PRACH transmission towards the serving cell, or a cell with a PCI different from the PCI of the serving cell. A PDCCH order from a cell A having a PCI different from the PCI of the serving cell can trigger a PRACH transmission towards cell A.

In one example, if the PDCCH order is from a cell A having a PCI different from the PCI of the serving cell:
PCI index is that of cell A. The PRACH transmission is transmitted towards cell A. In one example, the SSB to determine the PRACH transmit power is that used for QCL of the PDCCH order (e.g., like typical PDCCH order). In one example, the SSB to determine the PRACH transmit power is that indicated in the PDCCH order for cell A.
In this example, a PDCCH order from a serving cell can trigger a PRACH transmission towards the serving cell, or a cell with a PCI different from the PCI of the serving cell. A PDCCH order from a cell A having a PCI different from the PCI of the serving cell can trigger a PRACH transmission towards cell A.

In one example, the PCI index 0 can correspond to a first TAG ID (e.g., TAG ID 0) and a PCI index that is non-zero can correspond to a second TAG ID (e.g., TAG ID 1).

In one example, a first PCI index can correspond to a first TAG ID (e.g., TAG ID 0) and a second PCI index can correspond to a second TAG ID (e.g., TAG ID 1). In one example, the network can configure by RRC configuration and/or MAC CE signaling and/or L1 control signaling the first PCI index and/or the second PCI index.

In one example, the PCI field has a size of N-bits, wherein N=┌log₂(maxNrofAdditionalPCI+1)┐. In one example, maxNrofAdditionalPCI=7, and N=3 bits. In one example, if the PCI field is 0, this indicates a serving cell, else the PCI indicates the additional PCI index of a non-serving cell.

In one example, if the PCI Index is 0, the typical behavior of TABLE 1 is followed.

In one example, a new flag can be added to the PDCCH order.
If the flag is “0”, follow typical PDCCH order behavior as described in TABLE 1.
If the flag is “1”, follow new behavior. For example:
   A PCI Index or PCI Flag is included in the PDCCH order.
   If “Random Access Preamble index” is not zero “SS/PBCH index” indicates SSB index used for RO association and to determine the preamble transmit power and preamble spatial filter, else “SS/PBCH index” is reserved. Alternatively, “SS/PBCH index” indicates SSB index used for RO association and to determine the preamble transmit power and preamble spatial filter.
   If “Random Access Preamble index” is not zero “PRACH Mask index” indicates RO used, else “PRACH Mask index” is reserved. Alternatively, “PRACH Mask index” indicates RO used.

In one example, the SSB used to determine the transmit power of the preamble is configured or activated or indicated as a PL-RS before the transmission of the PDCCH order as described herein in this disclosure.

FIG. 28 illustrates a procedure 2800 for an example RAR according to embodiments of the present disclosure. For example, procedure 2800 can be followed by any of the UEs 111-116 of FIG. 1, such as the UE 111, and a BS, such as BS 102. This example is for illustration only and other embodiments can be used without departing from the scope of the present disclosure.

The procedure begins in 2810, a gNB (e.g., the gNB 102) transmits a PDCCH order to a UE which indicates SSB and PCI for transmission of a preamble. In 2820, the UE transmits a PRACH preamble to the gNB where the spatial transmission and/or power of the preamble is determined based on the indicated SSB and PCI. In 2830, the gNB transmits a RAR to the UE.

In one example, with reference to FIG. 28, the preamble is transmitted using a spatial filter and/or a power determined based on (1) SS/PBCH index, and (2) PCIIndex included in (or indicated by) the PDCCH order. The following variants can be evaluated for this example:
Variant 1: the same SS/PBCH index is used to (1) determine the PRACH Occasion used to transmit the preamble and (2) determine the spatial filter and/or a power of the preamble. For example, as in TABLE 3.
Variant 2: the PDCCH order includes 2 SS/PBCH indices; (1) One is used to determine the PRACH Occasion used to transmit the preamble and (2) the other is used to determine the spatial filter and/or a power of the preamble. For example, as in TABLE 4.

TABLE 4

| Field | Size | Description |
|---|---|---|
| Identifier for | 1 | The value of this |
| DCI formats | | bit field is set to 1, |
| | | indicating a DL DCI format |
| Frequency domain | ┌log₂(N_{RB}^{DL, BWP} | Set to ones |
| resource assignment | (N_{RB}^{DL, BWP} + 1)/2)┐ | |
| Random Access | 6 bits | See description A |
| Preamble index | | |
| UL/SUL indicator | 1 bit | |
| SS/PBCH index | 6 bits | See description F |
| PRACH Mask index | 4 bits | See description C |
| PCI Index | 3 bits | See description E |
| SS/PBCH index2 | 6 bits | See description G |
| Reserved bits | 3 bits or 1 bit | |

For Description F, see the following examples.

In one example, if PCI Index or PCI Flag is zero:
If “Random Access Preamble index” is not zero, “SS/PBCH index” indicates SSB index used for RO association, else “SS/PBCH index” is reserved.

In one example, if PCI Index or PCI Flag is non-zero:
If “Random Access Preamble index” is not zero “SS/PBCH index” indicates SSB index used for RO association, else “SS/PBCH index” is reserved.

In one example, if PCI Index or PCI Flag is non-zero:
“SS/PBCH index” indicates SSB index used for RO association.

For Description G, see the following examples.

In one example, if PCI Index or PCI Flag is zero:
Field “SS/PBCH index2” is reserved.

In one example, if PCI Index or PCI Flag is non-zero:
If “Random Access Preamble index” is not zero “SS/PBCH index2” indicates SSB index used to determine the preamble transmit power and preamble spatial filter, else “SS/PBCH index” is reserved.

In one example, if PCI Index or PCI Flag is non-zero:
“SS/PBCH index” indicates SSB index used for to determine the preamble transmit power and preamble spatial filter.

In one example, a new flag can be added to the PDCCH order.
If the flag is “0”, follow typical PDCCH order behavior as described in TABLE 1.
If the flag is “1”, follow new behavior. For example:
   A PCI Index or PCI Flag is included in the PDCCH order.
   If “Random Access Preamble index” is not zero “SS/PBCH index” indicates SSB index used for RO association, else “SS/PBCH index” is reserved. Alternatively, “SS/PBCH index” indicates SSB index used for RO association.
   A new field “SS/PBCH index2” is added to the PDCCH order. If “Random Access Preamble index” is not zero “SS/PBCH index2” indicates SSB index used to determine the preamble transmit power and preamble spatial filter, else “SS/PBCH index” is reserved. Alternatively, “SS/PBCH index” indicates SSB index used for to determine the preamble transmit power and preamble spatial filter.
   If “Random Access Preamble index” is not zero “PRACH Mask index” indicates RO used, else “PRACH Mask index” is reserved. Alternatively, “PRACH Mask index” indicates RO used.

In one example, the SSB used to determine the transmit power of the preamble is configured or activated or indicated as a PL-RS before the transmission of the PDCCH order as described herein in this disclosure.

In one example, with reference to FIG. 28, the preamble is transmitted using a spatial filter and/or a power determined based on (1) SS/PBCH index, and (2) PCI Flag included in (or indicated by) the PDCCH order. The following variants can be evaluated for this example:
Variant 1: the same SS/PBCH index is used to (1) determine the PRACH Occasion used to transmit the preamble and (2) determine the spatial filter and/or a power of the preamble. For example, as in TABLE 2.
Variant 2: the PDCCH order includes 2 SS/PBCH indices; (1) One is used to determine the PRACH Occasion used to transmit the preamble and (2) the other is used to determine the spatial filter and/or a power of the preamble. For example, as in TABLE 5.

In one example, the SSB used to determine the transmit power of the preamble is configured or activated or indicated as a PL-RS before the transmission of the PDCCH order as described herein in this disclosure.

TABLE 5

| Field | Size | Description |
|---|---|---|
| Identifier for | 1 | The value of this |
| DCI formats | | bit field is set to 1, |
| | | indicating a DL DCI format |
| Frequency domain | ┌log₂(N_{RB}^{DL, BWP} | Set to ones |
| resource assignment | (N_{RB}^{DL, BWP} + 1)/2)┐ | |
| Random Access | 6 bits | See description A |
| Preamble index | | |
| UL/SUL indicator | 1 bit | |
| SS/PBCH index | 6 bits | See description F |
| PRACH Mask index | 4 bits | See description C |
| PCI Flag | 1 bits | See description D |
| SS/PBCH index2 | 6 bits | See description G |
| Reserved bits | 5 bits or 3 bit | |

In one example, the PCI Flag can be:
With a value of zero, then the PCI is the PCI of the serving cell in which this CSI-SSB-ResourceSet is defined.
With a value of one, then the UE (e.g., the UE 116) selects a PCI corresponding to the additionalPCIIndex-r17 of an SSB-MTC-AdditionalPCI-r17 in the additionalPCIList-r17 in ServingCellConfig. For example, the selection can be based on the cell with active TCI states (or TCI state codepoints or active spatial relations).

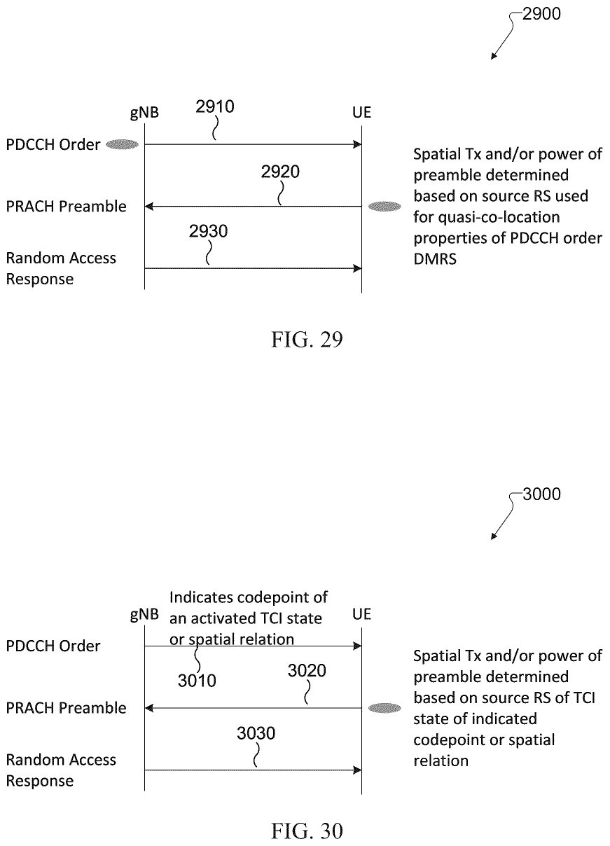

In one example, with reference to FIG. 29, the preamble is transmitted using a spatial filter and/or a power determined based on an SSB or a CSI-RS resource that is the source RS or that is quasi-co-located with the source RS of the PDCCH DMRS of the PDCCH order. The SSB or the CSI-RS can be associated with the serving cell or associated with a cell corresponding to an additionalPCIIndex.

In one example, the SSB or CSI-RS used to determine the transmit power of the preamble is configured or activated or indicated as a PL-RS before the transmission of the PDCCH order as described herein in this disclosure.

FIG. 29 illustrates a procedure 2900 for an example RAR according to embodiments of the present disclosure. For example, procedure 2900 can be followed by any of the UEs 111-116 of FIG. 1, such as the UE 112, and a BS, such as BS 103. This example is for illustration only and other embodiments can be used without departing from the scope of the present disclosure.

The procedure begins in 2910, a gNB transmits a PDCCH order to a UE. In 2920, the UE transmits a PRACH preamble to the gNB where the spatial transmission and/or power of the preamble is determined based on a source RS used for quasi-co-location properties of PDCCH order DMRS. In 2930, the gNB transmits a RAR to the UE.

In one example, with reference to FIG. 29, the preamble is transmitted using a spatial filter and/or a power determined based on an SSB or a CSI-RS resource that is the source RS or that is quasi-co-located with the source RS of the PDCCH DMRS of the PDCCH order. The SSB or the CSI-RS can be associated with a cell corresponding to an additionalPCIIndex.

In one example, the SSB or CSI-RS used to determine the transmit power of the preamble is configured or activated or indicated as a PL-RS before the transmission of the PDCCH order as described herein in this disclosure.

FIG. 30 illustrates a procedure 3000 for an example RAR according to embodiments of the present disclosure. For example, procedure 3000 can be followed by any of the UEs 111-116 of FIG. 1, such as the UE 113, and a BS, such as BS 102. This example is for illustration only and other embodiments can be used without departing from the scope of the present disclosure.

The procedure begins in 3010, a gNB transmits a PDCCH order to a UE that indicates a codepoint of an activated TCI state or spatial relation. In 3020, the UE transmits a PRACH preamble to the gNB where the spatial transmission and/or power of the preamble is determined based on the source RS of the TCI state of the indicated codepoint or spatial relation. In 3030, the gNB transmits a RAR to the UE.

In one example, with reference to FIG. 30, the preamble is transmitted using a spatial filter and/or a power determined based on an SS/PBCH index or CSI-RS resource, wherein the SS/PBCH index or CSI-RS resource is the source RS for quasi-co-location (e.g., TypeD QCL or TypeA QCL) of a MAC CE activated TCI state, wherein the activated MAC CE TCI state codepoint (or TCI state or TCI state ID) is included in (or indicated by) the PDCCH order. Active TCI state code points correspond to TCI states activated by MAC CE as described in TS 38.321 [REF5] clause 5.18.23 and 6.1.3.47. In a variant example, an SSB index is used to determine the spatial filter and/or a power of the transmitted preamble, wherein the SSB index is root source RS of a TCI state codepoint (or TCI state or TCI state ID) included in (or indicated by) the PDCCH order. The root source RS is a direct or indirect RS for QCL information or spatial relation information of the TCI state codepoint (or TCI state or TCI state ID). A direct RS is when the RS is the source RS of the TCI state codepoint (or TCI state or TCI state ID), an indirect RS, is when the RS provides QCL information or spatial relation information for the source RS of the TCI state codepoint (or TCI state or TCI state ID).

In one example, the SSB or CSI-RS used to determine the transmit power of the preamble is configured or activated or indicated as a PL-RS before the transmission of the PDCCH order as described herein in this disclosure.

In one example, with reference to FIG. 30, the preamble is transmitted using a spatial filter and/or a power determined based on an SS/PBCH index or CSI-RS resource, wherein the SS/PBCH index or CSI-RS resource is the source RS for spatial relation of a MAC CE activated spatial relation, wherein the activated MAC CE spatial relation (or spatial relation codepoint or spatial relation ID) is included in (or indicated by) the PDCCH order. In a variant example, an SSB index is used to determine the spatial filter and/or a power of the transmitted preamble, wherein the SSB index is root source RS of a spatial relation (or spatial relation codepoint or spatial relation ID) included in (or indicated by) the PDCCH order. The root source RS is a direct or indirect RS for QCL information or spatial relation information of the spatial relation (or spatial relation codepoint or spatial relation ID). A direct RS is when the RS is the source RS of the spatial relation (or spatial relation codepoint or spatial relation ID). An indirect RS is when the RS provides QCL information or spatial relation information for the source RS of the spatial relation (or spatial relation codepoint or spatial relation ID).

In one example, the SSB or CSI-RS used to determine the transmit power of the preamble is configured or activated or indicated as a PL-RS before the transmission of the PDCCH order as described herein in this disclosure.

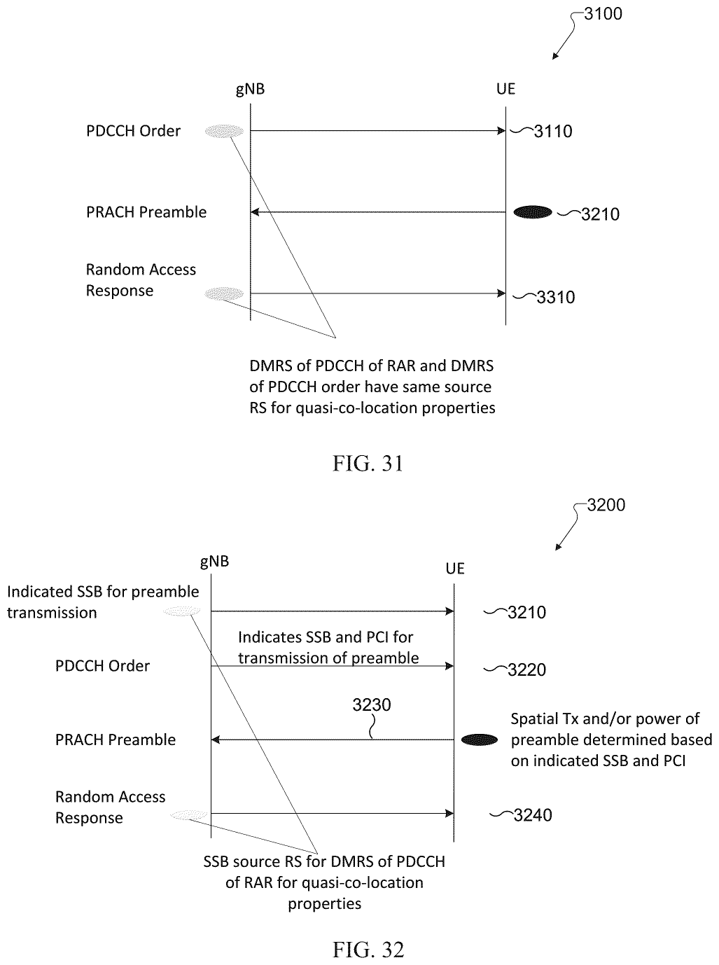

FIG. 31 illustrates a procedure 3100 for an example RAR according to embodiments of the present disclosure. For example, procedure 3100 can be followed by any of the UEs 111-116 of FIG. 1, such as the UE 114, and a BS, such as BS 103. This example is for illustration only and other embodiments can be used without departing from the scope of the present disclosure.

The procedure begins in 3110, a gNB transmits a PDCCH order to a UE. In 3120, the UE transmits a PRACH preamble to the gNB. In 3130, the gNB transmits a RAR to the UE wherein the DMRS of the PDCCH of the RAR and the DMRS of the PDCCH order have the same source RS for quasi-co-location properties.

FIG. 32 illustrates a procedure 3200 for an example RAR according to embodiments of the present disclosure. For example, procedure 3200 for an example RAR can be followed by any of the UEs 111-116 of FIG. 1, such as the UE 115, and a BS, such as BS 102. This example is for illustration only and other embodiments can be used without departing from the scope of the present disclosure.

The procedure begins in 3210, a gNB (e.g., the gNB 102) transmits to a UE the indicated SSB for preamble transmission. In 3220, the gNB transmits to the UE a PDCCH order that indicates SSB and PCI for transmission of the preamble. In 3230, the UE transmits to the gNB a RACH preamble where the spatial transmission and/or power of the preamble is determined based on the indicated SSB and PCI. In 3240, the gNB transmits to the UE a RAR where the SSB source RS for DMRS of PDCCH of RAR is for quasi-co-location properties.

In one example, the random access response for the preamble is transmitted in a PDCCH with a CRC that is scrambled by RA-RNTI.
In one example, with reference to FIG. 31, the DMRS antenna port of the PDCCH of the RAR has the same antenna port quasi co-location properties as the DMRS antenna port of the PDCCH of the PDCCH order.
In one example, with reference to FIG. 32, the DMRS antenna port of the PDCCH of the RAR is quasi-co-located with the SSB and CSI-RS resource used to determine the spatial filter and/or power of the preamble transmission.
In one example, the DMRS antenna port of the PDCCH of the RAR is quasi-co-located with the SSB and CSI-RS resource used to determine the association of the preamble transmission to ROs.
In one example, the DMRS antenna port of the PDCCH of the RAR is quasi-co-located with the SSB indicated in the PDCCH order by “SS/PBCH index”.
In one example, the DMRS antenna port of the PDCCH of the RAR is quasi-co-located with the SSB indicated in the PDCCH order by “SS/PBCH index” and PCI Flag or PCI Index.
In one example, the DMRS antenna port of the PDCCH of the RAR is quasi-co-located with the SSB indicated in the PDCCH order by “SS/PBCH index2”.
In one example, the DMRS antenna port of the PDCCH of the RAR is quasi-co-located with the SSB indicated in the PDCCH order by “SS/PBCH index2” and PCI Flag or PCI Index.
In one example, the DMRS antenna port of the PDCCH of the RAR is quasi-co-located with a CORESET (e.g., based on source RS of TCI state of the CORESET) associated with Type1-PDCCH Common Search Space (CSS) set.
In one example, if the PDCCH order is associated with a cell that has PCI different from the PCI of the serving cell (e.g., the TCI state of the PDCCH order is associated with a cell or SSB that has PCI different from the PCI of the serving cell), the DMRS antenna port of the PDCCH of the RAR is quasi-co-located with a CORESET (e.g., based on source RS of TCI state of the CORESET) associated with Type1-PDCCH Common Search Space (CSS) set. If the PDCCH order is associated with the serving cell (e.g., the TCI state of the PDCCH order is associated with the serving cell or a SSB of the serving cell) the DMRS antenna port of the PDCCH of the RAR has the same antenna port quasi co-location properties as the DMRS antenna port of the PDCCH of the PDCCH order.
In one example, the DMRS antenna port of the PDCCH of the RAR is quasi-co-located with a CORESET (e.g., based on source RS of TCI state of the CORESET) associated with UE-specific Search Space (USS) set.
In one example, the PDCCH of the RAR is transmitted in a Type1-PDCCH CSS set associated with the serving cell.
In one example, the PDCCH of the RAR is transmitted in a Type1-PDCCH CSS set associated with a cell, wherein the cell is that associated with the preamble transmission. The cell can be the serving cell or the cell of an additionalPCIndex. In this example, the UE can be configured with multiple Type1-PDCCH CSS sets for the serving cell and the cells of the additionalPCIIndex.
In one example, the PDCCH is transmitted in a Type1-PDCCH CSS set associated with a cell, wherein the cell is that associated with the preamble transmission. The cell can be the serving cell or the cell of an additionalPCIndex. In this example, the UE can be configured with two Type1-PDCCH CSS sets a first Type1-PDCCH CSS for the serving cell and a second Type1-PDCCH CSS for any cell of the additionalPCIIndex.
In one example, the PDCCH of the RAR is transmitted in a USS set.
In one example, the PDCCH of the RAR is transmitted in the same search space set as that of the PDCCH order.
In one example, if a PCI Flag or PCI index or TAG ID/Index in a PDCCH order is 0 or flag is added in PDCCH order to indicated new behavior and flag is set to 0, the DMRS antenna port of the PDCCH of the RAR has the same antenna port quasi co-location properties as the DMRS antenna port of the PDCCH of the PDCCH order, else (a PCI Flag or PCI index or TAG ID/Index in a PDCCH order is non-zero), the DMRS antenna port of the PDCCH of the RAR is quasi-co-located with the SSB and CSI-RS resource used to determine the spatial filter and/or power of the preamble transmission.
In one example, if a PCI Flag or PCI index or TAG ID/Index in a PDCCH order is 0 or flag is added in PDCCH order to indicated new behavior and flag is set to 0, the DMRS antenna port of the PDCCH of the RAR has the same antenna port quasi co-location properties as the DMRS antenna port of the PDCCH of the PDCCH order, else (a PCI Flag or PCI index or TAG ID/Index in a PDCCH order is non-zero), the DMRS antenna port of the PDCCH of the RAR is quasi-co-located with the SSB indicated by one of:
   SS/PBCH index″.
   SS/PBCH index″ and PCI Flag or PCI Index.
   SS/PBCH index2″.
   SS/PBCH index2″ and PCI Flag or PCI Index.
In one example, the DMRS antenna port of the PDSCH of the RAR has the same antenna port quasi co-location properties as the DMRS antenna port of the PDCCH of the RAR. The antenna port quasi co-location properties as the DMRS antenna port of the PDCCH of the RAR can be according to one or more examples described herein.
In one example, the DCI Format of the PDCCH of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MgsB.
In one example, the MAC CE of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MgsB.
In one example, the Timing Advanced conveyed by the RAR or MgsB can be determined based on the PDCCH order (e.g., a PCI flag or index in the PDCCH order, or the cell the PDCCH order is transmitted in or the cell which the PDCCH order triggers the transmission of the preamble in) that triggered the PRACH preamble transmission associated with the RAR.
In one example, the Timing Advanced conveyed by the RAR or MgsB can be determined based on the SSB or CSI-RS used for the transmission of the PRACH preamble (e.g., one set of SSB or CSI-RS is associated with a first TAG ID and a second set of SSB or CSI-RS is associated with a second TAG ID).
In one example, the Timing Advanced conveyed by the RAR or MgsB can be determined based on the SSB or CSI-RS used for determining the RO of the PRACH preamble (e.g., one set of SSB or CSI-RS is associated with a first TAG ID and a second set of SSB or CSI-RS is associated with a second TAG ID).

In one example, the SSB or CSI-RS in the examples described herein used to determine the transmit power of the preamble is configured or activated or indicated as a PL-RS before the transmission of the PDCCH order as described herein in this disclosure.

In one example, in case of cross-TRP triggering, the preamble is sent towards a TRP of a cell other than the cell that sent the PDCCH order. In this case, additional signaling is needed to determine the TRP towards which the PRACH is sent. A new field can be included in the PDCCH order for that purpose. This new field can be:
A one-bit flag (e.g., PCI Flag) that indicates whether the PRACH of the PDCCH order is sent towards serving cell or another non-serving cell. The non-serving cell, for example, can be the cell with active TCI states; and/or
A 3-bit field that indicates the cell ID (e.g. PCI index), for example identifying, AdditionalPCIIndex-r17 (a value from 1 to 7) include in SSB-MTC-AdditionalPCI-r17. Value 0 can indicate the serving cell.

In one example, for multi-DCI based inter-cell Multi-TRP operation with two TA enhancement, for CFRA PDCCH order, include an additional flag or field in the PDCCH order to identify the cell towards which the PRACH of the PDCCH order is transmitted.

In one example, for multi-DCI based intra-cell Multi-TRP operation with two TA enhancement, for CFRA PDCCH order, include an additional flag or field in the PDCCH order to identify the TRP towards which the PRACH of the PDCCH order is transmitted. In one example, if the flag or field is set to zero, the PRACH is transmitted towards a TRP that is the same as the TRP that transmitted the PDCCH order. If the flag or field is one, the PRACH is transmitted towards a TRP that is the different from the TRP that transmitted the PDCCH order. In a variant example, the function associated with one or zero can be reversed. In another example, if the flag is set to zero, the PRACH is transmitted towards a first TRP (for example a TRP associated with a first coresetpoolIndex (e.g., coresetpoolIndex 0), or a TRP associated with a first group of SSBs). If the flag is set to one, the PRACH is transmitted towards a second TRP (for example a TRP associated with a second coresetpoolIndex (e.g., coresetpoolIndex 1) or a TRP associated with a second group of SSBs), in a variant example, the function associated with one or zero can be reversed.

In one example, if the value of the PCI flag or the field that indicates the PDCCH order is 0, the operation of the PDCCH order follows the typical behavior as described herein. If the value of the PCI flag in the PDCCH order is non-zero, this indicates a PDCCH order with a PRACH transmitted towards a cell other than the cell triggering the PDCCH order. In this case,
The “Random Access Preamble index” field indicates the preamble of the PRACH transmission towards the other cell.
The “UL/SUL indicator” field indicates whether the PRACH preamble is sent in the UL carrier or the SUL carrier of the other cell.
The “SS/PBCH index” field indicates the SSB index a cell determined based on the PCI Flag/PCI Index to determine the RO used for PRACH preamble transmission towards the cell. The indicated SSB index of the cell can also be used to determine the PRACH preamble transmission power. i.e., this field is used for PRACH RO association and transmission power.
The “PRACH Mask index” field determines the RO to use for PRACH preamble transmission towards the cell indicated by the PCI Flag/PCI Index.

In one example, for multi-DCI based inter-cell or intra-cell Multi-TRP operation with two TA enhancement, for CFRA PDCCH order:
if the PCI field PCI flag or field is zero, the PDCCH order follows the typical behavior.
if the PCI field PCI flag or field indicates a PRACH transmission towards a cell and/or TRP other than the cell and/or TRP triggering the PDCCH order, the remaining fields in the PDCCH order are used to determine the preamble index and the RO of the PRACH preamble transmitted towards other cell. The “SS/PBCH index” field is used to determine the transmission power of the PRACH preamble towards the other cell.

In one example, the QCL of the PDCCH DMRS of the RAR and the corresponding PDSCH can follow the QCL of the PDCCH DMRS of the PDCCH order. Type-1 PDCCH CSS (common search space) set configured for the serving cell can be used for PDCCH monitoring occasions of the RAR.

In one example, the QCL of the PDCCH DMRS of the RAR can be determined based on the SSB used for preamble transmission. The Type-1 PDCCH CSS set configured for the serving cell can be used for PDCCH monitoring occasions of the RAR in this case also.

The TAG ID can be determined based on the PCI flag or PCI index of the PDCCH order. For example, if the PCI flag or field is zero, this can correspond to one TAG-ID, if the PCI flag is non-zero this can correspond to the other TAG-ID.

In one example, for inter-cell multi-DCI based multi-TRP operation with two TA enhancement, for CFRA PDCCH order, Type-1 PDCCH CSS configured for the serving cell can be used for PDCCH monitoring occasions of the RAR.
If the PDCCH order is transmitted towards the serving cell, the UE may expect that the PDCCH that includes the DCI format 1_0 of the RAR as well as corresponding PDSCH and the PDCCH order have same DMRS antenna port quasi co-location properties.
If the PDCCH order is transmitted towards a non-serving cell, the UE may expect that the PDCCH that includes the DCI format 1_0 of the RAR as well as corresponding PDSCH have the same antenna port quasi co-location properties as the SSB used for the PRACH preamble transmission.

In one example, for inter-cell multi-DCI based multi-TRP operation with two TA enhancement, for a CFRA PDCCH order, TAG ID is determined based on the PCI flag or PCI index of the PDCCH order.

In one example, for intra-cell multi-DCI based multi-TRP operation with two TA enhancement, for a CFRA PDCCH order, TAG ID is determined based on the PCI flag or PCI index of the PDCCH order.

In one example, for intra-cell multi-DCI based multi-TRP operation with two TA enhancement, a CFRA PDCCH order sent by one TRP triggers RACH procedure towards the same TRP.
The preamble is transmitted using a spatial filter and power determined based on an SSB resource that is the source RS of the PDCCH DMRS of the PDCCH order.

In one example, for intra-cell multi-DCI based multi-TRP operation with two TA enhancement, for a CFRA PDCCH order, TAG ID is determined based on the TCI state of PDCCH order or TRP from which the PDCCH order is transmitted.

In one example, for intra-cell scenarios, the RAR is sent from the TRP sending the PDCCH order. The QCL of the PDCCH of the RAR and the corresponding PDSCH can follow the QCL of the PDCCH order. Type-1 PDCCH CSS configured for the serving cell can be used for PDCCH monitoring occasions of the RAR.

In one example, for inter-cell or intra-cell multi-DCI based multi-TRP operation with two TA enhancement, for CFRA PDCCH order, Type-1 PDCCH CSS configured for the serving cell can be used for PDCCH monitoring occasions of the RAR. The UE may expect that the PDCCH that includes the DCI format 1_0 of the RAR as well as corresponding PDSCH and the PDCCH order have same DMRS antenna port quasi co-location properties.

In one example, if the PDCCH order is associated with a cell that has PCI different from the PCI of the serving cell (e.g., the TCI state of the PDCCH order is associated with a cell or SSB that has PCI different from the PCI of the serving cell), the DMRS antenna port of the PDCCH and/or PDSCH of the RAR are quasi-co-located with a CORESET (e.g., based on source RS of TCI state of the CORESET) associated with Type1-PDCCH Common Search Space (CSS) set. If the PDCCH order is associated with the serving cell (e.g., the TCI state of the PDCCH order is associated with the serving cell or a SSB of the serving cell) the DMRS antenna port of the PDCCH and/or PDSCH of the RAR have the same antenna port quasi co-location properties as the DMRS antenna port of the PDCCH of the PDCCH order.

In one example, the SSB or CSI-RS used to determine the transmit power of the preamble, in the examples described herein, is configured or activated or indicated as a PL-RS before the transmission of the PDCCH order as described herein in this disclosure.

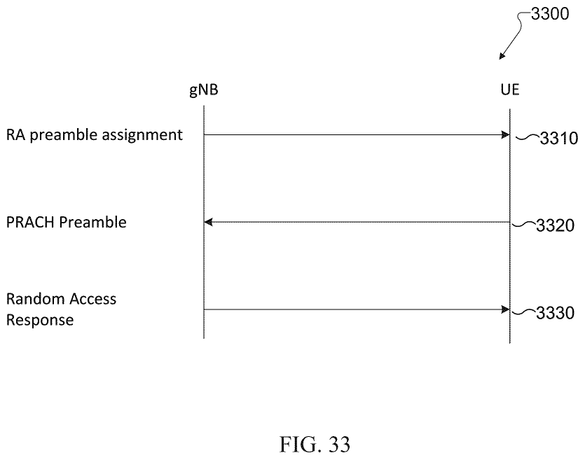

FIG. 33 illustrates a procedure 3300 for an example RAR according to embodiments of the present disclosure. For example, procedure 3300 for an example RAR can be followed by any of the UEs 111-116 of FIG. 1, such as the UE 111, and a BS, such as BS 103. This example is for illustration only and other embodiments can be used without departing from the scope of the present disclosure.

The procedure begins in 3310, a gNB sends a random access preamble assignment to a UE. In 3320, the UE sends a PRACH preamble to the gNB, In 3300, the gNB sends a RAR to the UE.

In one example, higher layers trigger a contention-free random (CFRA) access procedure for an inter-cell or intra-cell multi-TRP scenario to determine a TA.

With reference to FIG. 33, a higher-layer triggered CFRA procedure is shown. The following aspects are provided:
The resource for the preamble transmission, wherein the resource includes the PRACH Occasion and the preamble index.
The spatial filter and/or transmit power used to transmit the preamble.
The quasi-co-location for the random access response.

The resource used for the preamble is determined by a PRACH Occasion and a preamble index within the PRACH Occasion. The preamble index can be indicated by higher layers (e.g., RA preamble assignment in FIG. 33). The PRACH Occasion is determined based on an SSB or a CSI-RS resource to which the preamble is associated with, through an association pattern as described. In Rel-15 the association pattern is defined for the SSBs of the serving cell only. However, in case of inter-cell multi-TRP, there are SSBs associated with the serving cell as well as SSBs associated with cells corresponding to the additionalPCIIndex. Hence, one example is to define a new PRACH configuration to cover serving cell SSBs as well as SSBs on cells corresponding to the additionalPCIIndex. In case of intra-cell multi-TRP, there are SSBs associated with a first TRP as well as SSBs associated with a second TRP.

In one example, the new PRACH configuration can be used for transmission of preambles associated with the serving cell and cells corresponding to the additionalPCIIndex.

In one example, the new PRACH configuration can be used for transmission of preambles associated with cells corresponding to the additionalPCIIndex. The PRACH configuration of NR release 15 can be used for transmission of preambles associated with the serving cell.

In one example, the new PRACH configuration can be used for transmission of preambles associated with cells corresponding to the additionalPCIIndex. A higher layer parameter (e.g., by RRC configuration and/or MAC CE configuration) can indicate whether the preambles associated with the serving cell are transmitted using (1) the new PRACH configuration or (2) the PRACH configuration of NR release 15.

In one example, a separate PRACH configuration is provided for each additionalPCIIndex. The PRACH configuration association with an additionalPCIIndex can be used for transmission of preambles associated with cells corresponding to the additionalPCIIndex. The PRACH configuration of NR release 15 can be used for transmission of preambles associated with the serving cell.

The following examples can be evaluated for the new PRACH configuration.
The association is based on PCI-SSB pairs, i.e., each PCI-SSB pair is associated with an RO; and/or
The association is based on SSBs of the additionalPCIIndex, wherein the SSBs are provided by ssb-PositionsInBurst of SSB-MTC-AdditionalPCI-r17.

In one example, the UE (e.g., the UE 116) determines the PCI and/or the SSB to use for sending the contention-free random access preamble. For example, the PCI can be determined based on the activated TCI state codepoints (or TCI states or TCI state IDs) and/or the activated spatial relations. In one example, let X1 be the set of PCIs associated with the MAC CE activated TCI state codepoints e.g., as described in TS 38.321 [REF5] clause 5.18.23 and 6.1.3.47, the UE selects (or determines) a PCI Y1 from set X1, the UE further selects (or determines) an SSB index Z1 associated with PCI Y1, the UE uses SSB index Z1 to determine the spatial filter and/or power of the preamble transmission. In one example, let X2 be the set of PCIs associated with the MAC CE activated spatial relation information, the UE selects (or determines) a PCI Y2 from set X2, the UE further selects (or determines) an SSB index Z2 associated with PCI Y2, the UE uses SSB index Z2 to determine the spatial filter and/or power of the preamble transmission. The UE transmits the higher layer indicated preamble in a PRACH Occasion corresponding to Z1/Y1 or Z2/Y2.

In one example, active TCI states (or TCI state codepoints or active spatial relations) can be associated with serving cell and one other cell corresponding to additionalPCIIndex. In one example, active TCI states (or TCI state codepoints or active spatial relations) can be associated with serving cell and one or more other cell corresponding to additionalPCIIndex.

In one example, the SSB or CSI-RS used to determine the transmit power of the preamble is configured or activated or indicated as a PL-RS before the transmission of the PDCCH order as described herein in this disclosure.

In one example, a UE is configured with a new PRACH configuration. For example, a new RACH-ConfigGeneric and/or RACH-ConfigDedicated e.g., to be used for inter-cell multi-TRP.

The UE is configured additional PCIs and SSBs associated with the additional PCIs. For example, the UE can be configured with CSI-SSB-ResourceSet that includes a list of additional PCI indices given by servingAdditionalPCIList.

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |
| ResourcePerSet)) OF SSB-Index, | |
| ..., | |
| [[ | |
| servingAdditionalPCIList-r17 | SEQUENCE (SIZE(1..maxNrofCSI-SSB- |

```
    ResourcePerSet)) OF ServingAdditionalPCIIndex-r17 OPTIONAL -- Need R
  ]]
```

}

wherein, maxNrofCSI-SSB-ResourcePerSet is 64 and servingAdditionalPCIList indicates the physical cell IDs (PCI) of the SSBs in the csi-SSB-ResourceList. If present, the list has the same number of entries as csi-SSB-ResourceList. The first entry of the list indicates the value of the PCI for the first entry of csi-SSB-ResourceList, the second entry of this list indicates the value of the PCI for the second entry of csi-SSB-ResourceList, and so on. For each entry, the following applies:
If the value is zero, the PCI is the PCI of the serving cell in which this CSI-SSB-ResourceSet is defined.
Otherwise, the value is additionalPCIIndex-r17 of an SSB-MTC-AdditionalPCI-r17 in the additionalPCIList-r17 in ServingCellConfig, and the PCI is the additionalPCI-r17 in this SSB-MTC-AdditionalPCI-r17.

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, ms80, ms160, |
| spare2, spare1 }, | |
| ssb-PositionsInBurst-r17 | CHOICE { |
| | shortBitmap BIT STRING (SIZE (4)), |
| | mediumBitmap BIT STRING (SIZE (8)), |
| | longBitmap BIT STRING (SIZE (64)) |
| }, | |
| ss-PBCH-BlockPower-r17 | INTEGER (−60..50) |
| } | |

wherein, AdditionalPCIIndex-r17::=INTEGER (1 . . . maxNrofAdditionalPCI-r17), maxNrofAdditionalPCI is 7, and ssb-PositionsInBurst indicates the time domain positions of the transmitted SS-blocks in a half frame with SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted.

For association of SSBs with ROs for the new PRACH configuration, the number of SSBs to be associated with ROs is given by the following examples.

In one example, the number of SSBs to be associated with ROs is obtained from CSI-SSB-ResourceSet, based on SSB indices in the list csi-SSB-ResourceList that are associated with an additional PCI as given by servingAdditionalPCIList, (i.e., SSBs associated with the serving cell (having a value of zero in the corresponding entry in servingAdditionalPCIList) are excluded). The association order of SSBs to ROs can be based on the order of SSBs in csi-SSB-ResourceList associated with an additional PCI. In a variant of this example, only SSBs of cells with MAC CE activated TCI states are evaluated.

In one example, the number of SSBs to be associated with ROs is the sum of the number of SSBs configured for each AdditionalPCIIndex obtained from the corresponding ssb-PositionsInBurst. Let, N_{Tx-Total}^{SSB} be the total number of SSBs to be associated with PRACH Occasions,

$${N}_{Tx - Total}^{SSB} = {\sum }_{Configured AdditionalPCIIndex} {N}_{Tx}^{SSB} ( AdditionalPCIIndex )$$

where N_{Tx}^{SSB}(AdditionalPCIIndex) can be obtained from ssb-PositionsInBurst corresponding to SSB-MTC-AdditionalPCI. For example, the number bits in the bitmap with value equal to 1. The association order of SSBs to ROs can be based on:
First, the order of the SSBs in the corresponding ssb-PositionsInBurst bit map; and/or
The order of the configured AdditionalPCIIndex, for example as provided in ServingCellConfig.
   ServingCellConfig->mimoParam-r17->additionalPCI-ToAddModList-r17 SEQUENCE (SIZE (1 . . . maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with AdditionalPCIIndex 1 if configured, then the SSBs associated with AdditionalPCIIndex 2 if configured, etc. In a variant of this example, only SSBs of cells with MAC CE activated TCI states are evaluated.

In one example, the number of SSBs to be associated with ROs is obtained from CSI-SSB-ResourceSet, based on SSB indices in the list csi-SSB-ResourceList that are associated with the serving cell PCI, or an additional PCI as given by servingAdditionalPCIList. The association order of SSBs to ROs can be based on the order of SSBs in csi-SSB-ResourceList. In a variant of this example, only SSBs of cells with MAC CE activated TCI states are evaluated.

In one example, the number of SSBs to be associated with ROs is the sum of the number of SSBs configured for the serving cell, obtained from ssb-PositionsInBurst in SIB1 or in ServingCellConfigCommon, and for each AdditionalPCIIndex, obtained from the corresponding ssb-PositionsInBurst. Let, N_{Tx-Total}^{SSB} be the total number of SSBs to be associated with PRACH Occasions,

$${N}_{Tx - Total}^{SSB} = {\sum }_{Seving cell and Configured AdditionalPCIIndex} {N}_{Tx}^{SSB} ( Serving cell or AdditionalPCIIndex )$$

where N_{Tx}^{SSB}(ServingCell) can be obtained from ssb-PositionsInBurst in SIB1 or in ServingCellConfigCommon. N_{Tx}^{SSB}(AdditionalPCIIndex) can be obtained from ssb-PositionsInBurst corresponding to SSB-MTC-AdditionalPCI. For example, the number bits in the bitmap with value equal to 1. The association order of SSBs to ROs can be based on:
First, the order of the SSBs in the corresponding ssb-PositionsInBurst bit map; and/or
Second, SSBs of serving cell followed by the order of the configured AdditionalPCIIndex, for example as provided in ServingCellConfig

ServingCellConfig-> mimoParam-r17->additionalPCI-ToAddModList-r17 SEQUENCE
(SIZE(1..maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with the serving cell, then SSBs associated with AdditionalPCIIndex 1 if configured, then the SSBs associated with AdditionalPCIIndex 2 if configured, etc. In a variant of this example, only SSBs of cells with MAC CE activated TCI states are evaluated.

In one example, the preamble is transmitted using a spatial filter and/or a power determined based on a PCI and a SSB index (e.g., determined as described in one or more examples described herein). The RO for the CFRA preamble transmission can also be determined based on the PCI and the SSB index as described herein.

In one example, the SSB used to determine the transmit power of the preamble is configured or activated or indicated as a PL-RS before the transmission of the PDCCH order as described herein in this disclosure.

In one example, the random access response for the preamble is transmitted in a PDCCH with a CRC that is scrambled by RA-RNTI.
In one example, the PDCCH of the RAR is transmitted in a Type1-PDCCH Common Search Space (CSS) set associated with the serving cell.
In one example, the PDCCH of the RAR is transmitted in a Type1-PDCCH CSS set associated with a cell, wherein the cell is that associated with the preamble transmission. The cell can be the serving cell or the cell of an additionalPCIndex. In this example, the UE can be configured with multiple Type1-PDCCH CSS sets for the serving cell and the cells of the additionalPCIIndex.
In one example, the PDCCH is transmitted in a Type1-PDCCH CSS set associated with a cell, wherein the cell is that associated with the preamble transmission. The cell can be the serving cell or the cell of an additionalPCIndex. In this example, the UE can be configured with two Type1-PDCCH CSS sets a first Type1-PDCCH CSS for the serving cell and a second Type1-PDCCH CSS for any cell of the additionalPCIIndex.
In one example, the PDCCH of the RAR is transmitted in a USS set.
In one example, the DMRS antenna port of the PDCCH of the RAR is quasi-co-located with the SSB or CSI-RS resource used to determine the spatial filter and/or power of the preamble transmission.
In one example, the DMRS antenna port of the PDCCH of the RAR is quasi-co-located with the SSB or CSI-RS resource used to determine the association of the preamble transmission to ROs.
In one example, the DMRS antenna port of the PDCCH of the RAR is quasi-co-located with a CORESET (e.g., based on source RS of TCI state of the CORESET) associated with Type1-PDCCH CSS set.
In one example, if the PDCCH order is associated with a cell that has PCI different from the PCI of the serving cell (e.g., the TCI state of the PDCCH order is associated with a cell or SSB that has PCI different from the PCI of the serving cell), the DMRS antenna port of the PDCCH of the RAR is quasi-co-located with a CORESET (e.g., based on source RS of TCI state of the CORESET) associated with Type1-PDCCH Common Search Space (CSS) set. If the PDCCH order is associated with the serving cell (e.g., the TCI state of the PDCCH order is associated with the serving cell or a SSB of the serving cell), the DMRS antenna port of the PDCCH of the RAR has the same antenna port quasi co-location properties as the DMRS antenna port of the PDCCH of the PDCCH order.
In one example, the DMRS antenna port of the PDCCH of the RAR is quasi-co-located with a CORESET (e.g., based on source RS of TCI state of the CORESET) associated with USS set.
In one example, the DMRS antenna port of the PDSCH of the RAR has the same antenna port quasi co-location properties as the DMRS antenna port of the PDCCH of the RAR. The antenna port quasi co-location properties as the DMRS antenna port of the PDCCH of the RAR can be according to the previous examples.
In one example, the DCI Format of the PDCCH of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MgsB.
In one example, the MAC CE of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MgsB.
In one example, the Timing Advanced conveyed by the RAR or MgsB can be determined based on the SSB or CSI-RS used for the transmission of the PRACH preamble (e.g., one set of SSB or CSI-RS is associated with a first TAG ID and a second set of SSB or CSI-RS is associated with a second TAG ID).
In one example, the Timing Advanced conveyed by the RAR or MgsB can be determined based on the SSB or CSI-RS used for determining the RO of the PRACH preamble (e.g., one set of SSB or CSI-RS is associated with a first TAG ID and a second set of SSB or CSI-RS is associated with a second TAG ID).

In one example, the SSB or CSI-RS used to determine the transmit power of the preamble, in the examples described herein, is configured or activated or indicated as a PL-RS before the transmission of the PDCCH order as described herein in this disclosure.

In one example, a UE is configured with a list of DL or joint TCI states by parameter dl-OrJointTCI-StateList in PDSCH-Config. In one example, a UE is configured with unifiedTCI-StateRef in PDSCH-Configured, which provides the serving cell and BWP where the configuration of the DL or Joint TCI states are defined. In one example, a UE is configured a list of UL TCI states by parameter ul-TCI-StateList in BWP-UplinkDedicated. In one example, a UE is configured with unifiedTCI-StateRef in BWP-UplinkDedicated, which provides the serving cell and BWP where the configuration of the DL or Joint TCI states are defined.

In one example, DL or Joint TCI states include one or two QCL Info fields defined as:

| QCL-Info ::= | SEQUENCE { | |
|---|---|---|
| cell | ServCellIndex | OPTIONAL, -- Need R |
| bwp-Id | BWP-Id | OPTIONAL, -- Cond CSI-RS- |
| Indicated | | |
| referenceSignal | CHOICE { | |
| csi-rs | NZP-CSI-RS-ResourceId, | |
| ssb | SSB-Index | |
| }, | | |
| qcl-Type | ENUMERATED {typeA, typeB, typeC, typeD}, | |
| ... | | |
| } | | |

where the cell is defined as: The UE's serving cell in which the reference Signal is configured. If the field is absent, the reference Signal is configured in the serving cell in which the TCI-State is applied by the UE. The RS can be located on a serving cell other than the serving cell for which the TCI-State is applied by the UE only if the qcl-Type is configured as typeC or typeD. If the reference Signal is set to csi-rs and unifiedTCI-State Type is configured, either both cell and bwp-Id are present or both cell and bwp-Id are absent. See TS 38.214 [REF4] clause 5.1.5.

In one example, a TCI state (e.g., DL or Joint TCI state) includes a TAG ID.

In one example, the TAG_ID refers to a cell that is determined based on the “cell” IE in the QCL-Info. In one example, if the TCI state has two QCL-Info fields, the “cell” IE of the QCL-Info field with type-D is used to determine the cell to which the TAG-ID refers. In a variant example, if the TCI state has two QCL-Info fields, the “cell” IE of the QCL-Info field with type-A is used to determine the cell to which the TAG-ID refers. If the TCI state has two QCL-Info fields, the “cell” IE of the first QCL-Info field is used to determine the cell to which the TAG-ID refers. In one example, “cell” IE of a QCL-Info field, as described herein, is used to determine the cell of the TAG-ID, if configured, else the serving cell in which the TCI state is applied by the UE is used to determine the cell of the TAG-ID.

In one example, the TAG_ID refers to a cell that is determined based on the cell in which the DL or Joint TCI state list is configured as described herein.

In one example, the TAG_ID refers to a cell that is determined based on the cell in which the DL or Joint TCI state is applied.

In one example, the UL TCI state is defined by:

| | | |
|---|---|---|
| TCI-UL-State-r17 ::= | SEQUENCE { | |
| tci-UL-StateId-r17 | TCI-UL-StateId-r17, | |
| servingCellId-r17 | ServCellIndex | OPTIONAL, -- Need R |
| bwp-Id-r17 | BWP-Id | OPTIONAL, -- Cond CSI- |
| RSorSRS-Indicated | | |
| referenceSignal-r17 | CHOICE { | |
| ssb-Index-r17 | SSB-Index, | |
| csi-RS-Index-r17 | NZP-CSI-RS-ResourceId, | |
| srs-r17 | SRS-ResourceId | |
| }, | | |
| additionalPCI-r17 | AdditionalPCIIndex-r17 | OPTIONAL, -- Need R |
| ul-powerControl-r17 | Uplink-powerControlId-r17 | OPTIONAL, -- Need |
| R | | |
| pathlossReferenceRS-Id-r17 | PathlossReferenceRS-Id-r17 | OPTIONAL, -- |
| Cond Mandatory | | |

where the servingCellIndex is define as: The UE's serving cell in which the referenceSignal is configured. If the field is absent, the referenceSignal is configured in the serving cell in which the TCI-UL-State is applied by the UE.

In one example, a TCI state (e.g., UL TCI state) includes a TAG_ID.

In one example, the TAG_ID refers to a cell that is determined based on the “servingCellIndex” IE in the TCI-UL-State. In one example, the TAG ID is determined based on the servingCellId, if configured. Otherwise, the TAG ID is based on the serving cell in which the TCI-UL-State is applied by the UE.

In one example, the TAG_ID refers to a cell that is determined based on the cell in which the UL TCI state list is configured as described herein.

In one example, the TAG_ID refers to a cell that is determined based on the cell in which the UL TCI state is applied.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment. Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information for first sets of downlink (DL) or joint candidate cell transmission configuration indicator (TCI) states corresponding to one or more candidate cells,
receive second information for second sets of uplink (UL) candidate cell TCI states corresponding to the one or more candidate cells,
receive a first medium access control-channel element (MAC-CE) for activating a subset of candidate cell TCI states from the first sets or the second sets, and
receive a second MAC CE including a cell switch command, wherein:
the cell switch command indicates (1) a candidate cell and (2) at least one candidate cell TCI state, from the first sets or the second sets, corresponding to the candidate cell, and
the at least one candidate cell TCI state is indicated when the at least one candidate cell TCI state is activated by the first MAC-CE; and
a processor operably coupled to the transceiver, the processor configured to deactivate the subset of activated candidate cell TCI states excluding the at least one candidate cell TCI state.

2. The UE of claim 1, wherein the cell switch command activates and indicates the at least one candidate cell TCI state when the at least one candidate cell TCI state is not activated by the first MAC CE.

3. The UE of claim 1, wherein a source reference signal (RS) of the at least one candidate cell TCI state is:
a synchronization signal/physical broadcast channel (SS/PBCH) block of the candidate cell, or
a tracking reference signal (TRS) of the candidate cell.

4. The UE of claim 1, wherein third information includes a parameter to indicate joint or separate TCI states corresponding to the one or more candidate cells.

5. The UE of claim 1, wherein:
the transceiver is further configured to receive:
a set of DL or joint TCI states for the candidate cell, and
a set of UL TCI states for the candidate cell,
a DL or joint TCI state from the set of DL or joint TCI states and a DL or joint candidate cell TCI state corresponding to the candidate cell have a same TCI state identity and quasi-co-location type, and
a UL TCI state from the set of UL TCI states and a UL candidate cell TCI state corresponding to the candidate cell have a same TCI state identity and spatial relation reference signal (RS).

6. The UE of claim 1, wherein, the transceiver is further configured to receive:
a list of pathloss reference signals (PL-RSs) for a candidate cell from the one or more candidate cells, and
the at least one candidate cell TCI state includes a PL-RS from the list of PL-RSs.

7. The UE of claim 1, wherein:
the transceiver is further configured to receive a physical downlink control channel (PDCCH) order from a first cell,
the PDCCH order includes a synchronization signal/physical broadcast channel (SS/PBCH) block index,
the SS/PBCH block index is a pathloss reference signal (PL-RS) of an active TCI state,
the processor is further configured to use the SS/PBCH block index as the PL-RS for transmission of a physical random access channel (PRACH) to a second cell, and
the transceiver is further configured to transmit the PRACH to the second cell.

8. A base station (BS), comprising:
a transceiver configured to:
transmit first information for first sets of downlink (DL) or joint candidate cell transmission configuration indicator (TCI) states corresponding to one or more candidate cells,
transmit second information for second sets of uplink (UL) candidate cell TCI states corresponding to the one or more candidate cells,
transmit a first medium access control-channel element (MAC-CE) for activating a subset of candidate cell TCI states from the first sets or the second sets, and
transmit a second MAC CE including a cell switch command, wherein:
the cell switch command indicates (1) a candidate cell and (2) at least one candidate cell TCI state, from the first sets or the second sets, corresponding to the candidate cell, and
the at least one candidate cell TCI state is indicated when the at least one candidate cell TCI state is activated by the first MAC-CE; and
a processor operably coupled to the transceiver, the processor configured to deactivate the subset of activated candidate cell TCI states excluding the at least one candidate cell TCI state.

9. The BS of claim 8, wherein the cell switch command activates and indicates the at least one candidate cell TCI state when the at least one candidate cell TCI state is not activated by the first MAC CE.

10. The BS of claim 8, wherein, a source reference signal (RS) of the at least one candidate cell TCI state is:
synchronization signal/physical broadcast channel (SS/PBCH) block of the candidate cell, or
a tracking reference signal (TRS) of the candidate cell.

11. The BS of claim 8, wherein third information includes a parameter to indicate joint or separate TCI states corresponding to the one or more candidate cells.

12. The BS of claim 8, wherein, the transceiver is further configured to transmit:
a set of DL or joint TCI states for the candidate cell, and
a set of UL TCI states for the candidate cell,
a DL or joint TCI state from the set of DL or joint TCI states and a DL or joint candidate cell TCI state corresponding to the candidate cell have a same TCI state identity and quasi-co-location type, and
a UL TCI state from the set of UL TCI states and a UL candidate cell TCI state corresponding to the candidate cell have a same TCI state identity and spatial relation reference signal (RS).

13. The BS of claim 8, wherein, the transceiver is further configured to transmit:
a list of pathloss reference signals (PL-RSs) for a candidate cell from the one or more candidate cells, and
the at least one candidate cell TCI state includes a PL-RS from the list of PL-RSs.

14. The BS of claim 8, wherein:
the transceiver is further configured to transmit a physical downlink control channel (PDCCH) order from a first cell,
the PDCCH order includes a synchronization signal/physical broadcast channel (SS/PBCH) block index,
the SS/PBCH block index is a pathloss reference signal (PL-RS) of an active TCI state,
wherein the SS/PBCH block index is the PL-RS for a physical random access channel (PRACH) to a second cell, and
the transceiver is further configured to receive the PRACH on the second cell.

15. A method of operating a user equipment (UE), the method comprising:
receiving first information for first sets of downlink (DL) or joint candidate cell transmission configuration indicator (TCI) states corresponding to one or more candidate cells;
receiving second information for second sets of uplink (UL) candidate cell TCI states corresponding to the one or more candidate cells;
receiving a first medium access control-channel element (MAC-CE) for activating a subset of candidate cell TCI states from the first sets or the second sets;
receiving a second MAC CE including a cell switch command, wherein:
the cell switch command indicates (1) a candidate cell and (2) at least one candidate cell TCI state from the first sets or the second sets corresponding to the candidate cell, and
the at least one candidate cell TCI state is indicated when the at least one candidate cell TCI state is activated by the first MAC-CE, and
deactivating the subset of activated candidate cell TCI states excluding the at least one candidate cell TCI state.

16. The method of claim 15, wherein the cell switch command activates and indicates the at least one candidate cell TCI state when the at least one candidate cell TCI state is not activated by the first MAC CE.

17. The method of claim 15, wherein, a source reference signal (RS) of the at least one candidate cell TCI state is:
a synchronization signal/physical broadcast channel (SS/PBCH) block of the candidate cell, or
a tracking reference signal (TRS) of the candidate cell.

18. The method of claim 15, further comprising:
receiving:
a set of DL or joint TCI states for the candidate cell, and
a set of UL TCI states for the candidate cell,
wherein a DL or joint TCI state from the set of DL or joint TCI states and a DL or joint candidate cell TCI state corresponding to the candidate cell have a same TCI state identity and quasi-co-location type, and
wherein a UL TCI state from the set of UL TCI states and a UL candidate cell TCI state corresponding to the candidate cell have a same TCI state identity and spatial relation reference signal (RS).

19. The method of claim 15, further comprising receiving:
a list of pathloss reference signals (PL-RSs) for a candidate cell from the one or more candidate cells, and
the at least one candidate cell TCI state includes a PL-RS from the list of PL-RSs.

20. The method of claim 15, further comprising:
receiving a physical downlink control channel (PDCCH) order from a first cell, wherein:
the PDCCH order includes a synchronization signal/physical broadcast channel (SS/PBCH) block index, and
the SS/PBCH block index is a pathloss reference signal (PL-RS) of an active TCI state,
using the SS/PBCH block index as the PL-RS for transmission of a physical random access channel (PRACH) to a second cell, and
transmitting the PRACH to the second cell.
